(19) United States
(12) Patent Application Publication
(10) Pub. No.: US 2011/0277508 A1
(43) Pub. Date: Nov. 17, 2011

(54) MANUFACTURING METHOD OF GLASS BLANK FOR MAGNETIC RECORDING GLASS SUBSTRATE, MANUFACTURING METHOD OF MAGNETIC RECORDING GLASS SUBSTRATE AND MANUFACTURING METHOD OF MAGNETIC RECORDING MEDIUM

(75) Inventors: Makoto OSAWA, Tokyo (JP); Akira MURAKAMI, Tokyo (JP); Nobuhiro SUGIYAMA, Tokyo (JP); Takashi SATOU, Tokyo (JP); Naomi MATSUMOTO, Tokyo (JP); Youichi HACHITANI, Tokyo (JP); Kinobu OSAKABE, Tokyo (JP); Hideki ISONO, Tokyo (JP); Hidekazu TANINO, Tokyo (JP); Takao MOTOHASHI, Tokyo (JP)

(73) Assignee: HOYA CORPORATION, Tokyo (JP)

(21) Appl. No.: 13/070,509

(22) Filed: Mar. 24, 2011

(30) Foreign Application Priority Data
Mar. 31, 2010 (JP) 2010-083778
Oct. 5, 2010 (JP) 2010-225966

(51) Int. Cl. C03B 11/05; C03B 21/02; C03B 11/08

(52) U.S. Cl. 65/97; 65/90

(57) ABSTRACT

Provided is a method of manufacturing a glass blank for a magnetic recording medium glass substrate, including: manufacturing a glass blank by at least press molding a falling molten glass gob with a pair of press molds both so as to face each other in a direction perpendicular to a direction in which the molten glass gob falls, in which: the molten glass gob is formed of a glass material having a glass transition temperature of 600° C. or more; and when the press molding is carried out so that the molten glass gob is completely extended by pressure and molded into a flat glass between press-molding surfaces of the pair of press molds, at least a region in contact with the flat glass in each of the press-molding surfaces of the pair of press molds forms a substantially flat surface. Also provided are a method of manufacturing a magnetic recording medium glass substrate and a method of manufacturing a magnetic recording medium each using the method of manufacturing a glass blank for a magnetic recording medium glass substrate.

### CROSS-REFERENCE TO RELATED APPLICATIONS

The present application claims priority from Japanese Patent Application No. 2010-083778 filed on Mar. 31, 2010 and Japanese Patent Application No. 2010-225966 filed on Oct. 5, 2010, the entirety of which is hereby incorporated by reference.

### BACKGROUND

1. Technical Field

The present invention relates to a method of manufacturing a glass blank for a magnetic recording medium glass substrate, a method of manufacturing a magnetic recording medium glass substrate, and a method of manufacturing a magnetic recording medium.

2. Background Art

As a method of manufacturing a magnetic recording medium substrate (magnetic disk substrate), there are typically exemplified (1) a method of manufacturing a substrate through a press molding step of subjecting a molten glass gob to press molding with a pair of press molds (hereinafter, sometimes referred to as “press method.” See, for example, Patent Literature 1 and 2) and (2) a method of manufacturing a substrate through a processing step of cutting, into a disk shape, a sheet-shaped glass formed by a float method, a down-draw method, or the like (hereinafter, sometimes referred to as “sheet-shaped glass-cutting method.” See, for example, Patent Literature 3).

In conventional sheet-shaped glass-cutting methods exemplified in Patent Literature 3 and the like, a magnetic recording medium substrate was obtained by carrying out a disk processing step of processing a sheet-shaped glass into a disk shape and then carrying out, as polish steps, a lapping step (rough-polishing treatment) and a polishing step (precision-polishing treatment). However, it is disclosed that, in the sheet-shaped glass-cutting method disclosed in Patent Literature 3, the lapping step (rough-polishing treatment) is eliminated and only the polishing step (precision-polishing treatment) is carried out as a polish step.

On the other hand, in conventional press methods exemplified in Patent Literature 1, Patent Literature 2, and the like, a magnetic recording medium substrate is usually obtained by carrying out a press molding step with a method of press molding a molten glass gob, in which the molten glass gob is placed in a lower mold and a pressing force is then applied to the molten glass gob from the vertical direction by using an upper mold and the lower mold (hereinafter, sometimes referred to as “vertical direct press”), and then carrying out a lapping step, a polishing step, and the like.

Here, it is also proposed that, in the press method disclosed in Patent Literature 1, the lapping step is eliminated by, for example, using a highly rigid material as a material for the upper mold, the lower mold, and a parallel spacer arranged between the upper mold and the lower mold.

In addition, it is proposed that, in the press method disclosed in Patent Literature 2, the press molding step is carried out with a method in which a pressing force is applied to a molten glass gob from the horizontal direction by using a pair of press molds arranged so as to face each other in the horizontal direction (hereinafter, sometimes referred to as “horizontal direct press”). Further, Patent Literature 2 discloses the following four respects as advantages and disadvantages for the case of employing the horizontal direct press: (1) there is a difficult aspect that a pair of press molds must be moved at a high speed; (2) a molten glass gob can be subjected to press molding under a state in which its temperature is high; (3) a thinner glass substrate precursor (glass blank) can be obtained; and (4) a polish step can be diminished or eliminated.

[Patent Literature 1] JP 2003-54965 A (claims, paragraphs and [0043], FIG. 4 to FIG. 8, and the like)

[Patent Literature 2] JP 4380379 B (paragraph 0031, FIG. 1 to FIG. 9, and the like)

[Patent Literature 3] JP 2003-36528 A (FIG. 3 to FIG. 6, FIG. 8, and the like)

### SUMMARY

On the other hand, from the viewpoint of enhancing the productivity of a magnetic recording medium substrate, it is very effective to eliminate a lapping step or to carry out a lapping step in a shorter time, the lapping step being carried out mainly for the purposes of securing the flatness and uniformity in thickness of the magnetic recording medium substrate, adjusting its thickness, and the like. This is because a lapping apparatus is required for carrying out the lapping step, and hence man-hours for manufacturing a magnetic recording medium substrate become larger and the processing time thereof increases. Further, the lapping step may cause the occurrence of cracks in the surfaces of glass. Thus, the present situation is that examination is being made on how to eliminate the lapping step. Here, when the sheet-shaped glass-cutting method and the press method are compared from the viewpoint of eliminating the lapping step, more advantageous is the sheet-shaped glass-cutting method, in which processing is carried out by using a sheet-shaped glass having a higher flatness manufactured by a float method, a down-draw method, or the like. However, the press method has the advantage that glass is used more efficiently compared with the sheet-shaped glass-cutting method.

In order to eliminate a lapping step or to carry out a lapping step in a shorter time at the time of manufacturing a magnetic recording medium by applying post-processing to a glass blank manufactured by using vertical direct press, it is necessary to make the thickness deviation of the glass blank smaller and to improve the flatness thereof. Here, when a glass blank is produced by vertical direct press, the temperature of a lower mold is set to a temperature sufficiently lower than the temperature of a high-temperature molten glass gob in order to prevent the molten glass gob from melting and bonding to the lower mold. Thus, during the period from placing the molten glass gob in the lower mold until starting press molding, the molten glass gob loses heat through the surface in contact with the lower mold, and hence the viscosity of the lower surface of the molten glass gob placed in the lower mold locally increases. As a result, the press molding is carried out to the molten glass gob having a wide viscosity distribution (temperature distribution), producing portions that resist stretching by press. Besides, a cooling speed after the press molding is different for each site in a glass molded body produced by stretching glass by press molding so as to have a plate shape. Consequently, a glass blank that is manufactured by using vertical direct press is liable to have an increased thickness deviation or to have a deteriorated flatness. Further, in consideration of the above-mentioned mechanism, even in the case of adopting the vertical direct press using a parallel spacer as disclosed in Patent Literature 1, it is difficult to drastically suppress the increase of the thickness deviation of the glass blank and the reduction of the flatness thereof.

Further, it is described that a polish step can be diminished or eliminated by adopting the horizontal direct press disclosed in Patent Literature 2. Moreover, when this technology is adopted, two projected streaks are concentrically provided in the press-molding surface of each press mold, and hence there are formed, in the surface of a glass blank manufactured, two concentrically-shaped and V-shaped grooves which have a depth equal to one fourth to one third the thickness of the glass blank. Besides, the provision of the V-shaped grooves gives the advantage that a precise processing step applied to the inner diameter side and outer diameter side of the glass blank and a polishing processing step applied to its end surfaces are eliminated. However, when the inventors of the present invention have intensively studies on this technology, the inventors have found that the thickness of the glass blank manufactured tends to be thinner in the inner diameter side rather than the outer diameter side, and hence the thickness deviation cannot be significantly improved compared with the case of using vertical direct press. In addition, the inventors have also found that the glass blank manufactured is liable to have cracks and the yield is liable to lower. Note that the cracks in the glass blank have occurred in V-shaped groove portions, and hence the crack defect is estimated to be attributed to stress concentration in the V-shaped groove portions.

By the way, examination has been made in recent years on using magnetic materials having high magnetic anisotropy energy (high Ku magnetic materials), such as an Fe—Pt-based material and a Co—Pt-based material, for the purpose of attaining higher density recording in a magnetic recording media. A magnetic particle having a smaller diameter is necessary for attaining high density recording. Meanwhile, the magnetic particle having a smaller diameter involves a problem with the deterioration of magnetic characteristics attributed to thermal fluctuation. As the high Ku magnetic materials resist the influence of thermal fluctuation, the high Ku magnetic materials are expected to contribute to attaining high density recording.

However, the above-mentioned high Ku magnetic materials need to have a particular crystal orientation state in order to realize high Ku. For that purpose, the high Ku magnetic materials need to be formed into a film at high temperature or need to be subjected to heat treatment at high temperature after being formed into a film. Thus, in order to form a magnetic recording layer made of each of these high Ku magnetic materials, a magnetic recording medium substrate made of glass is required to have high heat-resistance necessary for being able to endure the above-mentioned high-temperature treatment, that is, a high glass transition temperature.

On the other hand, when a glass blank for a magnetic recording medium substrate is manufactured by vertical direct press, which has been conventionally used as a method of manufacturing a magnetic recording medium substrate by a press method, there is a problem in that, as a glass material to be used for manufacturing the glass blank has a higher glass transition temperature, the shape accuracy of the glass blank is more liable to lower. The reason for this is that in usual vertical direct press, molten glass is placed in a lower mold arranged on a rotating table, and the molten glass in the lower mold is then subjected to press molding with an upper mold and the lower mold. That is, during the period from the time at which the molten glass is placed in the lower mold until the time of the start of the press molding, the lower mold is heated by the molten glass having a high temperature. Moreover, in order to adjust the viscosity of a glass material having a high glass transition temperature to a viscosity range suitable for the press molding, it is necessary to set the temperature of a molten glass gob placed in the lower mold to a higher temperature. In addition, if the temperature of the molten glass gob is set to a higher one at the time of the press molding, heat becomes liable to be transferred to the rotating table via the lower mold, and as a result, the rotating table supporting the lower mold is eventually deformed by the heat. Thus, the shape accuracy of the glass blank such as thickness deviation and flatness consequently lowers. The above-mentioned explanation is the reason for the problem.

As the viscosity distribution (temperature distribution) of the molten glass gob becomes wider just before press molding in the vertical direct press, as described above, it is not possible to drastically suppress the increase of the thickness deviation of the glass blank and the reduction of the flatness thereof. Further, even if the horizontal direct press disclosed in Patent Literature 2 was adopted, the thickness deviation of the glass blank was not be able to be improved drastically, and moreover, a crack defect was easily caused. In addition, when a glass blank is manufactured by using a glass material having a higher glass transition temperature for the purpose of improving heat resistance, the shape accuracy of the glass blank inevitably lowers.

The present invention has been made in view of the above-mentioned circumstances, and an object of the present invention is to provide a method of manufacturing a glass blank for a magnetic recording medium glass substrate, the glass blank being able to be formed into a magnetic recording medium glass substrate having excellent heat resistance by carrying out post-processing, being excellent in thickness deviation and flatness, and having little crack defect, and a method of manufacturing a magnetic recording medium glass substrate and a method of manufacturing a magnetic recording medium each using the method of manufacturing a glass blank for a magnetic recording medium glass substrate.

The above-mentioned object is achieved by the present invention described below.

That is, a method of manufacturing a glass blank for a magnetic recording medium glass substrate according to the present invention includes: manufacturing a glass blank for a magnetic recording medium glass substrate by at least press molding a falling molten glass gob with a first press mold and a second press mold both so as to face each other in a direction perpendicular to a direction in which the molten glass gob falls, in which: the molten glass gob is formed of a glass material having a glass transition temperature of 600° C. or more; and when the press molding is carried out so that the molten glass gob is completely extended by pressure and molded into a flat glass between a press-molding surface of the first press mold and a press-molding surface of the second press mold, at least a region in contact with the flat glass in each of the press-molding surface of the first press mold and the press-molding surface of the second press mold forms a substantially flat surface.

In a method of manufacturing a glass blank for a magnetic recording medium glass substrate according to one embodiment of the present invention, it is preferred that the glass blank for a magnetic recording medium glass substrate have an average linear expansion coefficient at 100 to 300° C. of 70×10⁻⁷/° C. or more and a Young's modulus of 70 GPa or more.

In a method of manufacturing a glass blank for a magnetic recording medium glass substrate according to another embodiment of the present invention, it is preferred that the glass material include, as a glass composition expressed in mol %, 50 to 75% of SiO₂, 0 to 5% of Al₂O₃, 0 to 3% of Li₂O, 0 to 5% of ZnO, 3 to 15% in total of at least one kind of component selected from Na₂O and K₂O, 14 to 35% in total of at least one kind of component selected from MgO, CaO, SrO, and BaO, and 2 to 9% in total of at least one kind of component selected from ZrO₂, TiO₂, La₂O₃, Y₂O₃, Yb₂O₃, Ta₂O₅, Nb₂O₅, and HfO₂, and the molar ratio {(MgO+CaO)/(MgO+CaO+SrO+BaO)} be in the range of 0.8 to 1 and the molar ratio {Al₂O₃/(MgO+CaO)} be in the range of 0 to 0.30.

In a method of manufacturing a glass blank for a magnetic recording medium glass substrate according to another embodiment of the present invention, it is preferred that the method include: manufacturing molten glass by heating and melting a glass material prepared so as to have a predetermined glass composition; and forming the molten glass gob by causing the molten glass to fall from a glass outlet and cutting a forward end portion of a molten glass flow continuously flowing out downward in the vertical direction, in which the viscosity of the molten glass flow is kept at a constant value in a range of 500 to 1,050 dPa·s.

In a method of manufacturing a glass blank for a magnetic recording medium glass substrate according to another embodiment of the present invention, the method including: separating a molten glass gob from a molten glass flow flowing out from a glass outlet; and press molding the molten glass gob into a thin flat glass (flat glass) with a press mold, thereby manufacturing a glass blank for a magnetic recording medium glass substrate to be processed into a magnetic recording medium glass substrate, it is preferred that a flat glass be produced by preparing a glass material so that a glass including, as a glass composition expressed in mol %, 50 to 75% of SiO₂, 0 to 5% of Al₂O₂, 0 to 3% of Li₂O, 0 to 5% of ZnO, 3 to 15% in total of at least one kind of component selected from Na₂O and K₂O, 14 to 35% in total of at least one kind of component selected from MgO, CaO, SrO, and BaO, and 2 to 9% in total of at least one kind of component selected from ZrO₂, TiO₂, La₂O₃, Y₂O₃, Yb₂O₂, Ta₂O₅, Nb₂O₅, and HfO₂, in which the molar ratio {(MgO+CaO)/(MgO+CaO+SrO+BaO)} is in the range of 0.8 to 1 and the molar ratio {Al₂O₂/(MgO+CaO)} is in the range of 0 to 0.30 is obtained, heating and melting the glass raw material to produce a molten glass, causing the molten glass to flow out with a constant viscosity within the viscosity range of 500 to 1,050 dPa·s, separating a molten glass gob by cutting a molten glass flow in a state in which the molten glass flow is dropping from a glass outlet to cause the molten glass gob to fall, and press molding the falling molten glass gob.

A method of manufacturing a magnetic recording medium glass substrate according to the present invention includes: manufacturing a glass blank for a magnetic recording medium glass substrate by at least press molding a falling molten glass gob with a first press mold and a second press mold both so as to face each other in a direction perpendicular to a direction in which the molten glass gob falls; and manufacturing a magnetic recording medium glass substrate by at least polishing main surfaces of the glass blank, in which: the molten glass gob is formed of a glass material having a glass transition temperature of 600° C. or more; and when the press molding is carried out so that the molten glass gob is completely extended by pressure and molded into a flat glass between a press-molding surface of the first press mold and a press-molding surface of the second press mold, at least a region in contact with the flat glass in each of the press-molding surface of the first press mold and the press-molding surface of the second press mold forms a substantially flat surface.

A method of manufacturing a magnetic recording medium according to the present invention includes: manufacturing a glass blank by at least press molding a falling molten glass gob with a first press mold and a second press mold both so as to face each other in a direction perpendicular to a direction in which the molten glass gob falls; manufacturing a magnetic recording medium glass substrate by at least polishing main surfaces of the glass blank; and manufacturing a magnetic recording medium by at least forming a magnetic recording layer on the magnetic recording medium glass substrate, in which: the molten glass gob is formed of a glass material having a glass transition temperature of 600° C. or more; and when the press molding is carried out so that the molten glass gob is completely extended by pressure and molded into a flat glass between a press-molding surface of the first press mold and a press-molding surface of the second press mold, at least a region in contact with the flat glass in each of the press-molding surface of the first press mold and the press-molding surface of the second press mold forms a substantially flat surface.

According to the present invention, there can be provided the method of manufacturing a glass blank for a magnetic recording medium glass substrate, the glass blank being able to be formed into a magnetic recording medium glass substrate having excellent heat resistance by carrying out post-processing, being excellent in thickness deviation and flatness, and having little crack defect, and the method of manufacturing a magnetic recording medium glass substrate and the method of manufacturing a magnetic recording medium each using the method of manufacturing a glass blank for a magnetic recording medium glass substrate.

### BRIEF DESCRIPTION OF DRAWINGS

FIG. 1 is a schematic cross-sectional view illustrating a part of all steps in one example of a method of manufacturing a glass blank for a magnetic recording medium glass substrate according to an embodiment of the present invention.

FIG. 2 is a schematic cross-sectional view illustrating a state after having gone through the process illustrated in FIG. 1 in one example of a method of manufacturing a glass blank for a magnetic recording medium glass substrate according to an embodiment of the present invention.

FIG. 3 is a schematic cross-sectional view illustrating one example of a falling molten glass gob in a state after having gone through the process illustrated in FIG. 2.

FIG. 4 is a schematic cross-sectional view illustrating a state after having gone through the process illustrated in FIG. 3 in one example of a method of manufacturing a glass blank for a magnetic recording medium glass substrate according to an embodiment of the present invention.

FIG. 5 is a schematic cross-sectional view illustrating a state after having gone through the process illustrated in FIG. 4 in one example of a method of manufacturing a glass blank for a magnetic recording medium glass substrate according to an embodiment of the present invention.

FIG. 6 is a schematic cross-sectional view illustrating a state after having gone through the process illustrated in FIG. 5 in one example of a method of manufacturing a glass blank for a magnetic recording medium glass substrate according to an embodiment of the present invention.

FIG. 7 is a schematic cross-sectional view illustrating a state after having gone through the process illustrated in FIG. 6 in one example of a method of manufacturing a glass blank for a magnetic recording medium glass substrate according to an embodiment of the present invention.

FIG. 8 is a schematic cross-sectional view illustrating a state after having gone through the process illustrated in FIG. 7 in one example of a method of manufacturing a glass blank for a magnetic recording medium glass substrate according to an embodiment of the present invention.

FIG. 9 is a schematic cross-sectional view illustrating a state after having gone through the process illustrated in FIG. 8 in one example of a method of manufacturing a glass blank for a magnetic recording medium glass substrate according to an embodiment of the present invention.

### DETAILED DESCRIPTION

### [Method of Manufacturing Glass Blank]

A method of manufacturing a glass blank for a magnetic recording medium glass substrate (which may be hereinafter abbreviated as “glass blank”) according to an embodiment of the present invention includes manufacturing a glass blank by at least going through a press-molding step of press molding a falling molten glass gob with a first press mold and a second press mold both so as to face each other in the direction perpendicular to the direction in which the molten glass gob falls, and is characterized in that the molten glass gob is formed of a glass material having a glass transition temperature of 600° C. or more, and when the molten glass gob is completely extended by pressure between the press-molding surface of the first press mold and the press-molding surface of the second press mold by carrying out the press-molding step, thereby being formed into a flat glass, at least a region in each of the press-molding surface of the first press mold and the press-molding surface of the second press mold, the region being in contact with the flat glass, has a nearly flat surface.

In the method of manufacturing a glass blank for a magnetic recording medium glass substrate according to an embodiment of the present invention, the glass transition temperature of the glass material to be used for manufacturing a glass blank is 600° C. or more. Here, it is known that the heat resistance of glass has a strong correlation with its glass transition temperature. Further, the glass transition temperature of a magnetic recording medium substrate made of glass manufactured by any of a conventional press method and a conventional sheet-shaped glass-cutting method is far below 600° C., that is, about 450 to about 500° C. Thus, a magnetic recording medium glass substrate manufactured by using a glass blank manufactured by the method of manufacturing a glass blank according to an embodiment of the present invention has higher heat resistance than conventional magnetic recording medium substrates. Consequently, even if the magnetic recording medium glass substrate obtained according to an embodiment of the present invention is subjected to heat treatment at high temperature, the extremely high flatness that the magnetic recording medium glass substrate has is not impaired. Therefore, when a magnetic recording layer is formed on the magnetic recording medium glass substrate by using a high Ku magnetic material, for example, the high Ku magnetic material can be easily formed into a film at high temperature or can be easily subjected to heat treatment at high temperature after being formed into a magnetic recording layer. As a result, it becomes easy to attain high density recording in a magnetic recording medium. Moreover, in addition to the foregoing, when the magnetic recording medium glass substrate obtained from the glass blank manufactured by the method of manufacturing a glass blank according to an embodiment of the present invention is used to manufacture a magnetic recording medium, a higher-temperature film-forming process can be adopted, as compared with the case where conventional magnetic recording medium substrates are used. Thus, the degree of design freedom in designing a magnetic recording medium becomes higher. Note that the glass transition temperature of the glass material is preferably 610° C. or more, more preferably 620° C. or more, still more preferably 630° C. or more, still more preferably 640° C. or more, still more preferably 650° C. or more, still more preferably 655° C. or more, still more preferably 660° C. or more, particularly preferably 670° C. or more, most preferably 675° C. or more. On the other hand, the upper limit of the glass transition temperature is not particularly limited, but may be set to, for example, about 750° C.

Further, the method of manufacturing a glass blank according to an embodiment of the present invention adopts horizontal direct press in which a falling molten glass gob is press-molded with a first press mold and a second press mold both so as to face each other in the direction (horizontal direction) perpendicular to the direction in which the molten glass gob falls. In the horizontal direct press, the molten glass gob is neither temporarily brought into contact with nor temporarily held by a member having a temperature lower than the molten glass gob has, such as a lower mold, during the period until the molten glass gob is press-molded. Thus, at the time just prior to the start of the press molding, the viscosity distribution of the molten glass gob is kept uniform in the horizontal direct press, though the viscosity distribution of the molten glass gob becomes very large in vertical direct press. Hence, it is extremely easy to stretch the molten glass gob more uniformly and more thinly by press molding in the horizontal direct press as compared with the vertical direct press. Thus, as a result, in the case where a glass blank is manufactured by using the horizontal direct press, it is extremely easy to drastically suppress the increase of the thickness deviation and the reduction of the flatness, as compared with the case where a glass blank is manufactured by using the vertical direct press.

Note that a molten glass gob can be, in principle, stretched more uniformly and more thinly at the time of press molding by using the horizontal direct press rather than the vertical direct press, as described above, and hence the thickness deviation and flatness can be significantly improved. However, it is considered that even in the case of carrying out the vertical direct press in which a molten glass gob has a wide viscosity distribution just prior to the start of press molding, if the temperature of the whole molten glass gob is further increased at the time of the press molding and the viscosity of the whole molten glass gob is further lowered, the thickness deviation and the flatness can be significantly improved. However, although the method as described above can be applied to the case of using a glass material having a glass transition temperature of less than 600° C. (low Tg glass), it becomes more difficult to apply the method to the case of using a glass material having a glass transition temperature of 600° C. or more (high Tg glass), in proportion to the increase of the glass transition temperature.

The reason for that is as described below. First, in the vertical direct press, a lower mold is heated by a molten glass gob and is continuously exposed to thermal stress during the period from the time of supplying the molten glass gob into the lower mold until the start of press molding. Thus, in the case of using high TG glass in place of low Tg glass, the temperature of the molten glass gob needs to be increased in order to secure the viscosity of the molten glass gob suitable for press molding. However, if the temperature of the molten glass gob is increased, thermal stress to the lower mold becomes larger. As a result, the press-molding surface of the lower mold and molten glass are melt-bonded to each other and/or the press-molding surface of the lower mold remarkably deteriorates or deforms. Thus, when high Tg glass is used to make mass production of a glass blank by the vertical direct press, the accumulation of thermal stress to a lower mold increases as time passes, leading to the occurrence of the above-mentioned problems. Consequently, even if the vertical direct press is carried out by using the high Tg glass, it is difficult to make mass production of a glass blank whose thickness deviation and flatness are significantly improved.

However, even if the horizontal direct press is carried out by using high Tg glass having such a glass transition temperature that the mass production of a glass blank becomes difficult in the case of using the vertical direct press, it is extremely easy to make mass production of a glass blank whose thickness deviation and flatness are significantly improved. There is given first, as the reason for this, the fact that, when the horizontal direct press is carried out, the period during which the press-molding surfaces of press molds and a high-temperature molten glass gob keep contacting to each other is substantially only the time of press molding, and hence the time during which thermal stress is applied to the press molds is shorter as compared with the vertical direct press. In addition, there is given, as the second reason, the fact that, when press molding is carried out so that a molten glass gob can be stretched uniformly and thinly while using high Tg glass having the same glass transition temperature, the temperature of the whole molten glass gob can be set lower in the horizontal direct press rather than the vertical direct press. This is because the viscosity distribution of a molten glass gob just prior to the start of press molding is uniform in the horizontal direct press, and hence the molten glass gob is easily stretched thinly and uniformly, but the viscosity distribution of a molten glass gob just prior to the start of press molding is very wide in the vertical direct press, and hence the molten glass gob is not easily stretched thinly and uniformly.

Further, in the method of manufacturing a glass blank according to an embodiment of the present invention, when a molten glass gob is completely extended by pressure between the press-molding surface of the first press mold and the press-molding surface of the second press mold by carrying out the press-molding step, thereby being formed into a flat glass, at least a region in each of the press-molding surface of the first press mold and the press-molding surface of the second press mold, the region being in contact with the flat glass (hereinafter, sometimes referred to as “molten glass stretching region”), has a nearly flat surface. That is, no V-shaped groove is formed in the surface of the glass blank manufactured by the method of manufacturing a glass blank according to an embodiment of the present invention. That is, no V-shaped groove exists in the glass blank manufactured by the method of manufacturing a glass blank according to an embodiment of the present invention, though very large V-shaped grooves each having a depth one fourth to one third the thickness of a substrate exist on the surface of the glass blank manufactured by the production method described in Patent Literature 2, the production method including adopting the same horizontal direct press as in the method of manufacturing a glass blank according to an embodiment of the present invention. Thus, in the glass blank manufactured by the method of manufacturing a glass blank according to an embodiment of the present invention, no crack defect estimated to be attributed to stress concentration in V-shaped groove portions occurs.

Further, the glass blank manufactured by the method of manufacturing a glass blank according to an embodiment of the present invention is excellent in thickness deviation, as compared with the glass blank manufactured by the production method described in Patent Literature 2 including adopting the horizontal direct press. As described above, the horizontal direct press can significantly improve the thickness deviation as compared with the vertical direct press. Thus, it is expected that, if the method of manufacturing a glass blank according to an embodiment of the present invention and the production method described in Patent Literature 2 both including adopting the horizontal direct press are carried out, each resultant glass blank has similar thickness deviation. However, the method of manufacturing a glass blank according to an embodiment of the present invention can, in reality, make the thickness deviation smaller than the production method described in Patent Literature 2 can. Specific reasons for the occurrence of such difference are unknown, but it is estimated that the difference may be influenced by, at the time of press molding, for example, (1) a difference in flow resistance when a molten glass gob spreads in the direction parallel to press-molding surfaces between a pair of the press-molding surfaces facing each other, (2) a local difference in the cooling speed of a molten glass gob in the molten glass stretching region, the difference being caused by thermal exchange between each press-molding surface and a stretching molten glass gob, and the like.

That is, the production method described in Patent Literature 2 involves providing concentrically-shaped projected streaks for forming V-shaped grooves in press-molding surfaces. Thus, in the case where the production method described in Patent Literature 2 is used, flow resistance becomes larger, as compared with the case where the method of manufacturing a glass blank according to an embodiment of the present invention is used. The difference in flow resistance is estimated to make eventually a difference in the time from the start of the stretch of a molten glass gob until the completion of its spread, if each molten glass gob has the same viscosity. Moreover, when press molding is continuously carried out in the production method described in Patent Literature 2, as the projected streak portions provided in press-molding surfaces project relative to flat portions around the projected streaks, the projected streak portions are liable to be cooled in the intermission of press molding (period during which a molten glass gob is not in contact with press-molding surfaces). In addition, the height of each projected streak is approximately equal to from one fourth to one third the thickness of a glass blank, and hence the heat capacity of the projected streak portions is very large. Thus, it is conceivable that the cooling speed of the portions which come into contact with the projected streak portions provided in the inner peripheral side of the molten glass gob tends to be larger at the time of press molding than the cooling speed of other portions, if the accumulative time of the contact between the molten glass gob and each of the projected streak portions is also taken into consideration. It is therefore estimated, based on the reasons described above, that the method of manufacturing a glass blank according to an embodiment of the present invention can make the thickness deviation smaller than the method of manufacturing a glass blank described in Patent Literature 2 can, even though each of the methods adopts the same horizontal direct press.

Note that, in the method of manufacturing a glass blank according to an embodiment of the present invention, at least each molten glass stretching region in the press-molding surfaces needs to have a nearly flat surface, or each whole press-molding surface may have a nearly flat surface. Here, the term “nearly flat surface” also means, in addition to a usual flat surface whose curvature is substantially zero, a surface having such a very small curvature that a slightly convex surface or a slightly concave surface is formed. Further, it is naturally allowed for the “nearly flat surface” to have minute irregularities which are formed when usual flattening processing, usual mirror polishing processing, or the like is applied at the time of manufacturing press molds, and it is also acceptable for the “nearly flat surface” to have convex portions and/or concave portions larger than the minute irregularities, if necessary.

Here, it is allowed for the convex portion larger than the minute irregularity to include a substantially point-shaped convex portion and/or a substantially linear-shaped convex portion each having such a height of 20 μm or less that those portions have a slight chance of bringing about the deterioration of flow resistance and promoting the partial cooling of a molten glass gob. Note that the height is preferably 10 μm or less, more preferably 5 μm or less. Further, when the convex portion larger than the minute irregularity is a trapezoid-shaped convex portion having a minimum width in top surface of several millimeters or an order exceeding it, or a dome-shaped convex portion having nearly the same height and size as the trapezoid-shaped convex portion instead of the substantially point-shaped convex portion and substantially linear-shaped convex portion, the above-mentioned chance of bringing about the deterioration of flow resistance and promoting the partial cooling of a molten glass gob becomes smaller, and hence the convex portion is allowed to have a height of 50 μm or less. Note that the height is preferably 30 μm or less, more preferably 10 μm or less. Further, from the viewpoint of suppressing the occurrence of cracks due to stress concentration at the intersection part between the bottom surface and a side surface of the trapezoid-shaped convex portion, it is preferred that the side surface of the trapezoid-shaped convex portion be a flat surface having an angle of slope of 0.5° or less with respect to the top surface, or be a curved surface created by modifying the flat surface to a concave surface. Note that the angle is more preferably 0.1° or less.

Further, it is allowed for the concave portion larger than the minute irregularity to include a substantially point-shaped concave portion and/or a substantially linear-shaped concave portion each having a depth of 20 μm or less, in order that, for example, the deterioration of the flowability of molten glass flowing into the concave portion at the time of press molding is not brought about. Note that the depth is preferably 10 μm or less, more preferably 5 μm or less. Further, when the concave portion larger than the minute irregularity is an inverted trapezoid-shaped concave portion having a minimum width in top surface of several millimeters or an order exceeding it, or an inverted dome-shaped concave portion having nearly the same depth and size as the inverted trapezoid-shaped concave portion instead of the substantially point-shaped concave portion and substantially linear-shaped concave portion, the above-mentioned chance of bringing about the deterioration of the flowability becomes smaller, and hence the concave portion is allowed to have a depth of 50 μm or less. Note that the depth is preferably 30 μm or less, more preferably 10 μm or less. Further, from the viewpoint of suppressing the occurrence of cracks due to stress concentration at the intersection part between the bottom surface and a side surface of the trapezoid-shaped convex portion, it is preferred that the side surface of the trapezoid-shaped convex portion be a flat surface having an angle of slope of 0.5° or less with respect to the bottom surface, or be a curved surface created by modifying the flat surface to a concave surface. Note that the angle is more preferably 0.1° or less.

Hereinafter, the method of manufacturing a glass blank according to an embodiment of the present invention is described in more detail with reference to the drawings.

—Manufacturing Example of Glass Blank—

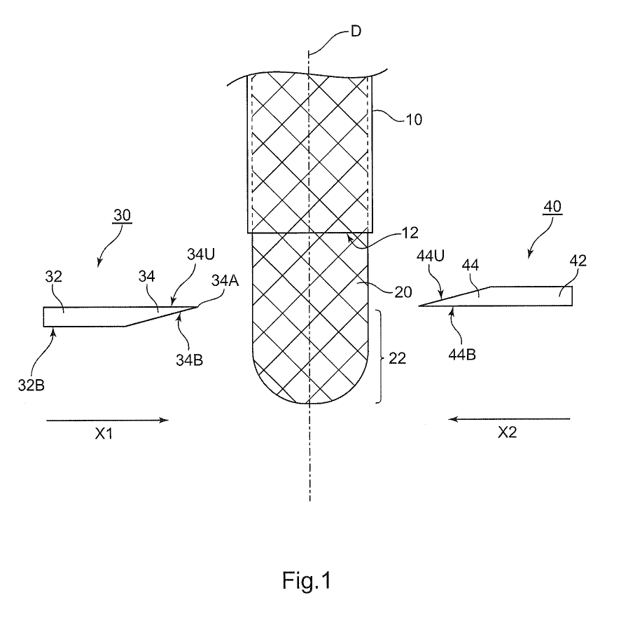

FIG. 1 to FIG. 9 each are a schematic cross-sectional view illustrating one example of the method of manufacturing a glass blank according to an embodiment of the present invention. Here, these figures illustrate, in numerical order, a series of processes at the time of manufacturing a glass blank in chronological order.

As illustrated in FIG. 1, a molten glass flow 20 is first caused to flow out continuously downward in the vertical direction from a glass outlet 12 provided at the lower end portion of a glass effluent pipe 10 whose upper end portion is connected to a molten glass supply source not shown. On the other hand, at a portion lower than the glass outlet 12, a first shear blade (lower side blade) 30 and a second shear blade (upper side blade) 40 are arranged at both sides of the molten glass flow 20, respectively, in the direction substantially perpendicular to a central axis D, which is the falling direction of the molten glass flow 20. Then, the lower side blade 30 and the upper side blade 40 move toward an arrow direction X1 and an arrow direction X2, respectively, thereby approaching to a forward end portion 22 side of the molten glass flow 20 from both sides of the molten glass flow 20. Note that the viscosity of the molten glass flow 20 is not particularly limited as long as the viscosity is suitable for separating the forward end portion 22 and press molding, and it is usually preferred that the viscosity be controlled to a constant value in the range of 500 dPa·s to 1,050 dPa·s. The viscosity of the molten glass flow 20 can be controlled by adjusting the temperatures of the glass effluent pipe 10 and the molten glass supply source located in the upstream of the glass effluent pipe 10.

Further, the lower side blade 30 and the upper side blade 40 have substantially plate-shaped body portions 32 and 42, respectively, and blade portions 34 and 44, respectively, which are respectively provided at an end portion side of the body portions 32 and 42, and cut the forward end portion 22 of the molten glass flow 20 continuously flowing out downward in the vertical direction in the direction substantially perpendicular to the direction to which the molten glass flow 20 falls down. Note that an upper surface 34U of the blade portion 34 and a lower surface 44B of the blade portion 44 each have a surface substantially corresponding to the horizontal plane, a lower surface 34B of the blade portion 34 and an upper surface 44U of the blade portion 44 each have a surface that is slanted so as to cross the horizontal plane. In addition, the lower side blade 30 and the upper side blade 40 are arranged so that the upper surface 34U of the blade portion 34 and the lower surface 44B of the blade portion 44 are positioned at substantially the same height in the vertical direction.

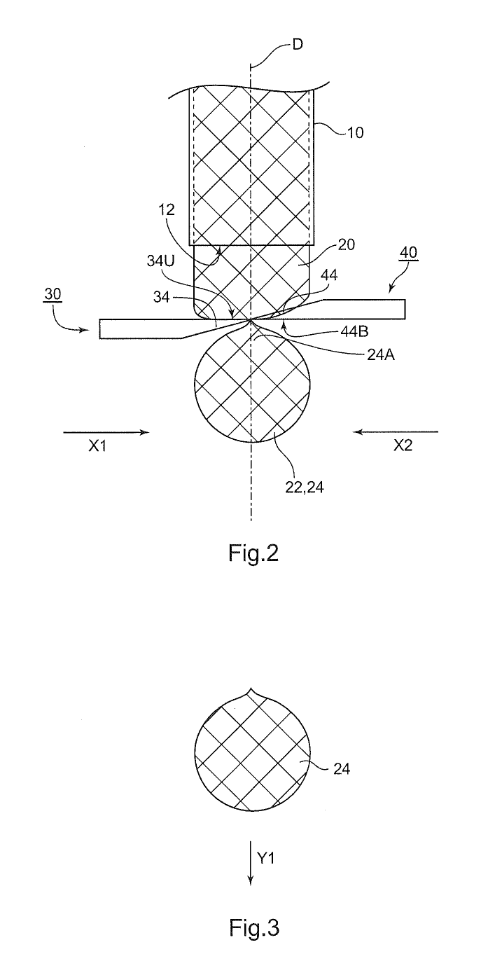

Next, as illustrated in FIG. 2, the lower side blade 30 and the upper side blade 40 are each moved in the horizontal direction so that the upper surface 34U of the blade portion 34 and the lower surface 44B of the blade portion 44 are partially overlapped substantially without any gap by further moving the lower side blade 30 and the upper side blade 40 toward the arrow direction X1 and the arrow direction X2, respectively. That is, the lower side blade 30 and the upper side blade 40 are caused to perpendicularly cross the central axis D. As a result, the lower side blade 30 and the upper side blade 40 penetrate into the molten glass flow 20 until reaching the vicinity of the central axis D thereof, and the forward end portion 22 is separated (cut) as a molten glass gob 24 having a substantially spherical shape. Note that FIG. 2 illustrates an aspect of the moment when the forward end portion 22 is separated from the body portion of the molten glass flow 20 as the molten glass gob 24.

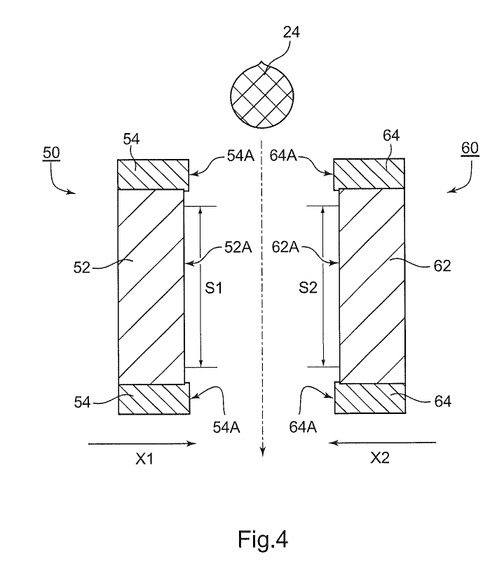

Next, as illustrated in FIG. 3, the molten glass gob 24 separated from the molten glass flow 20 further falls in the vertical direction in the downward Y1 side. Then, the molten glass gob 24 enters the space between the first press mold and the second press mold both so as to face each other in the direction perpendicular to the falling direction Y1 of the molten glass gob 24. Here, as illustrated in FIG. 4, a first press mold 50 and a second press mold 60 before carrying out press molding are arranged with a distance between them so as to have line symmetry with respect to the falling direction Y1. Then, in synchronization with the timing when the molten glass gob 24 reaches the vicinity of the central portion in the vertical direction of the first press mold 50 and the second press mold 60, the first press mold 50 moves in the arrow X1 direction and the second press mold 60 moves in the arrow X2 direction in order to press-mold the molten glass gob 24 by pressing it from both sides.

Here, the press molds 50 and 60 have press mold bodies 52 and 62 each having a disk-like shape, respectively, and guide members 54 and 64 arranged so as to surround the outer peripheral ends of each of the press mold bodies 52 and 62, respectively. Note that, because FIG. 4 is a cross-sectional view, the guide members 54 and 64 are drawn so as to be positioned on both sides of the press mold bodies 52 and 62, respectively, in FIG. 4. Here, one surface of each of the press mold bodies 52 and 62 serves as a press molding surfaces 52A and 62A, respectively. Further, in FIG. 4, the first press mold 50 and the second press mold 60 are arranged so that the two press molding surfaces 52A and 62A face each other. Further, the guide member 54 is provided with a guide surface 54A, which is positioned so as to project slightly based on the press molding surface 52A in the X1 direction, and the guide member 64 is provided with a guide surface 64A, which is positioned so as to project slightly based on the press molding surface 62A in the X2 direction. Then, the guide surface 54A and the guide surface 64A come into contact with each other at the time of press molding, and hence a gap is formed between the press molding surface 52A and the press molding surface 62A. Thus, the thickness of the gap corresponds to the thickness of the molten glass gob 24 molded so as to have a plate shape by being press-molded between the first press mold 50 and the second press mold 60, that is, the thickness of a glass blank. Further, the press molding surfaces 52A and 62A are formed so that, when the press molding step is carried out so that the molten glass gob 24 is completely extended by pressure in the vertical direction and is molded into a flat glass between the press molding surface 52A of the first press mold 50 and the press molding surface 62A of the second press mold 60, at least regions (molten glass stretching regions) S1 and S2 in contact with the above-mentioned flat glass in each of the press molding surfaces 52A and 62A form a substantially flat surface. Note that, in the example illustrated in FIG. 4, the whole part of the press-molding surface 52A including the molten glass stretching region S1 and the whole part of the press-molding surface 62A including the molten glass stretching region S2 each are a usual flat surface whose curvature is substantially zero. Further, the flat surface has only minute irregularities which are formed when usual flattening processing, usual mirror polishing processing, or the like is applied at the time of manufacturing press molds, but does not have convex portions and/or concave portions larger than the minute irregularities.

It is preferred to use a metal or an alloy as a material for forming each of the press molds 50 and 60 in view of heat resistance, workability, and durability. In this case, the heat resistant temperature of the metal or alloy for forming each of the press molds 50 and 60 is preferably 1,000° C. or more, more preferably 1,100° C. or more. Specific examples of the material for forming each of the press molds 50 and 60 preferably include ferrum casting ductile (FCD), alloy tool steel (such as SKD61), high-speed steel (SKH), cemented carbide, Colmonoy, and Stellite. Note that, it may be possible to control the press molding by cooling the press molds 50 and 60 by using a medium for cooling such as water or air so that the temperatures of the press molds 50 and 60 do not rise.

The glass blank is manufactured by press molding the molten glass gob 24 by pressure between the press molding surfaces 52A and 62A. Thus, the surface roughness of the press molding surfaces 52A and 62A and the surface roughness of the main surface of the glass blank become substantially the same. The surface roughness of the main surface of the glass blank is desirably controlled to the range of 0.01 to 10 μm in view of performing scribe processing and performing grinding processing using a diamond sheet, and these processings are carried out as the below-mentioned post-step. Hence the surface roughness Ra of the press molding surfaces is also preferably controlled to the range of 0.01 to 10 μm.

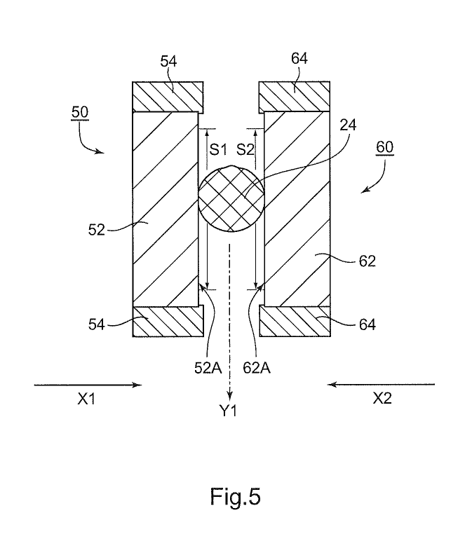

The molten glass gob 24 illustrated in FIG. 4 falls further downward and enters the space between the two press molding surfaces 52A and 62A. Then, as illustrated in FIG. 5, at the time when the molten glass gob 24 reaches the vicinity of the almost central portion in the vertical direction of the press molding surfaces 52A and 62A parallel to the falling direction Y1, both side surfaces of the molten glass gob 24 come into contact with the press molding surfaces 52A and 62A.

Here, in additional consideration of the viewpoint of preventing the situation that press molding becomes difficult to carry out because of the increase of the viscosity of a falling molten glass gob 24 or the situation that the position of press fluctuates because of an excessively high falling speed, the falling distance is preferably selected from the range of 1,000 mm or less, more preferably selected from the range of 500 mm or less, still more preferably selected from the range of 300 mm or less, most preferably selected from the range of 200 mm or less. Note that the lower limit of the falling distance is not particularly limited, but is preferably 100 mm or more for practical use. Note that the term “falling distance” means a distance from the position at the moment when the forward end portion 22 is separated as the molten glass gob 24 as illustrated in FIG. 2, that is, the position at which the lower side blade 30 and the upper side blade 40 are overlapped in the vertical direction, until the position at the time of the start of the press molding (the moment of the start of the press molding) as illustrated in FIG. 5, that is, the vicinity of the almost central portion in the diameter direction of the press-molding surfaces 52A and 62A parallel to the falling direction Y1.

Note that the temperatures of the first press mold 50 and second press mold 60 at the time of the start of the press molding are each preferably set to a temperature less than the glass transition temperature of a glass material forming the molten glass gob 24. With this, it is possible to prevent more reliably the phenomenon that, when the molten glass gob 24 is press-molded, the melt-bonding between the thinly stretched molten glass gob 24 and each of the press molding surfaces 52A and 62A occurs.

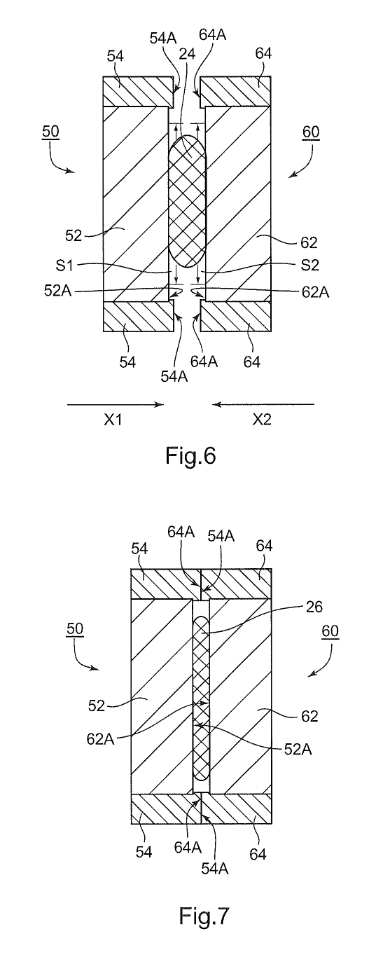

After the surface of the molten glass gob 24 comes into contact with each of the press molding surfaces 52A and 62A, the molten glass gob 24 is solidified so as to attach to the press molding surfaces 52A and 62A. Next, as illustrated in FIG. 6, when the molten glass gob 24 is continuously pressed from its both sides with the first press mold 50 and the second press mold 60, the molten glass gob 24 is extended by pressure so as to have a uniform thickness around the position at which the molten glass gob 24 and each of the press molding surfaces 52A and 62A first come into contact. Then, as illustrated in FIG. 7, the molten glass gob 24 is continuously pressed with the first press mold 50 and the second press mold 60 until the guide surface 54A and the guide surface 64A come into contact, thereby being formed into a disk-shaped or disk-like thin flat glass 26 between the press molding surfaces 52A and 62A.

Here, the thin flat glass 26 illustrated in FIG. 7 has substantially the same shape and thickness as the glass blank to be finally obtained. Further, the size and shape of both surfaces of the thin flat glass 26 are substantially the same size and shape of the molten glass stretching regions S1 and S2 (not shown in FIG. 7). Further, the time taken from the state at the time of the start of the press molding illustrated in FIG. 5 until a state in which the guide surface 54A and the guide surface 64A come into contact with each other as illustrated in FIG. 7 (hereinafter, referred to as “press molding time” in some cases) is preferably 0.1 second or less from the viewpoint of forming the molten glass gob 24 into a thin flat glass. Moreover, because a state in which the guide surface 54A and the guide surface 64A come into contact with each other is established at the time of the press molding, it becomes easy to maintain the parallel state between the press molding surface 52A and the press molding surface 62A. Note that the upper limit of the press molding time is not particularly limited, however, it is preferably 0.05 seconds or more for practical use.

Note that after the state illustrated in FIG. 7 is established, it is possible to continue applying a pressure sufficiently smaller than a press pressure applied to the first press mold 50 and the second press mold 60, so that a state in which the guide surface 54A and the guide surface 64A are in contact is maintained, thereby maintaining a state in which both surfaces of the thin flat glass 26 and each of the press molding surfaces 52A and 62A are closely attached. Then, while the state is continued for several seconds, the thin flat glass 26 is cooled. Here, cooling the thin flat glass 26 in a state in which the thin flat glass 26 is sandwiched between the first press mold 50 and the second press mold 60 is preferably carried out until the temperature of the thin flat glass 26 reaches a temperature equal to or less than the deformation point of a glass material forming the thin flat glass 26. Note that if the press pressure is increased in the above-mentioned state, the thin flat glass 26 breaks in some cases.

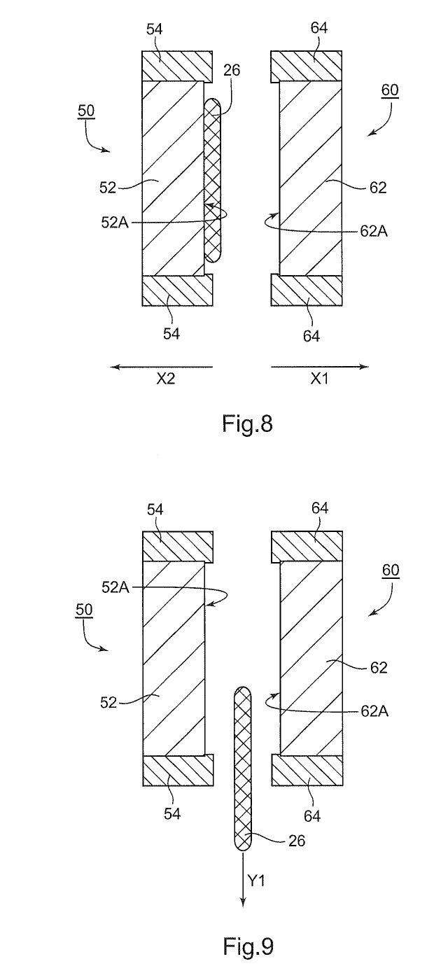

Next, as illustrated in FIG. 8, the first press mold 50 is moved in the X2 direction and the second press mold 60 is moved in the X1 direction so that the first press mold 50 and the second press mold 60 are separated from each other, thereby demolding the thin flat glass 26 from the press molding surface 62A. Subsequently, as illustrated in FIG. 9, the thin flat glass 26 is demolded from the press molding surface 52A, and the thin flat glass 26 is caused to fall in the downward Y1 side in the vertical direction so as to be taken out. Note that when the thin flat glass 26 is demolded from the press molding surface 52A, the thin flat glass 26 can be demolded by applying a force from an outer peripheral direction of the thin flat glass 26 so as to peel it. In this case, the thin flat glass 26 can be taken out without applying a large force to the thin flat glass 26. Note that, it may be possible to control the press molding by cooling the first press mold 50 and the second press mold 60 by using a medium for cooling such as water or air so that the temperatures of the press molding surfaces 52A and 62A do not excessively rise.

Finally, the thin flat glass 26 taken out is subjected to annealing to reduce or remove strain, thereby yielding a base material to be processed into a magnetic recording medium glass substrate, that is, a glass blank. As a result of press molding the falling molten glass gob 24 in accordance with the above-mentioned procedures exemplified in FIG. 1 to FIG. 9, the viscosity distribution of the molten glass gob 24 just prior to the start of press can be made uniform, and the molten glass gob 24 can be stretched thinly so as to have a uniform thickness.

Thus, a glass blank having a small thickness deviation and a small flatness can be easily obtained. Note that the thickness deviation of the glass blank that is manufactured is preferably 10 μm or less, and the flatness of the glass blank is preferably 10 μm or less, more preferably 8 μm or less, still more preferably 6 μm or less, particularly preferably 4 μm or less.

The method of manufacturing a glass blank according to an embodiment of the present invention is suitable for producing a glass blank having a ratio of diameter to thickness (diameter/thickness) of 50 to 150. Here, the diameter refers to an arithmetic average of the major axis and minor axis of the glass blank. The press molds 50 and 60 do not regulate the outer peripheral end surface of the glass blank, and hence the outer peripheral end surface is a free surface. Here, the circularity of the glass blank that is produced is not particularly limited, but is preferably controlled to within ±0.5 mm.

The diameter of the glass blank is not particularly limited. The diameter is preferably set, as a target value, to a value obtained by adding, to the diameter of the substrate, the amount of glass that is removed at the time of scribe processing and outer peripheral processing which are carried out when the glass blank is processed into a magnetic recording medium glass substrate, as described below.

The thickness of the glass blank falls preferably within the range of 0.75 to 1.1 mm, more preferably within the range of 0.75 to 1.0 mm, still more preferably within the range of 0.90 to 0.92 mm. It is recommended to measure the thickness, thickness deviation, flatness, diameter, and circularity of the glass blank by using a three-dimensional measuring machine and a micrometer.

—Physical Properties and Glass Composition of Glass Material, Physical Properties of Glass Blank, and the Like—

There is used, as described above, a glass material having a glass transition temperature of 600° C. or more as the glass material which is used in the method of manufacturing a glass blank according to an embodiment of the present invention. Therefore, a glass blank manufactured by the method of manufacturing a glass blank according to an embodiment of the present invention has high heat resistance.

On the other hand, a disk-shaped magnetic recording medium is a medium for writing and reading out data along its rotating direction while the magnetic recording medium is being rotated around the central axis at a high speed and a magnetic head is being moved in the radius direction. In recent years, the rotation number of the magnetic recording medium has been increasing, for example, from 5,400 rpm to 7,200 rpm, and further to 10,000 rpm, in order to increase the writing speed and the reading-out speed. However, in the disk-shaped magnetic recording medium, the positions for recording data are predetermined depending on the distance from the central axis. Hence, as its rotating speed increases, the disk-shaped magnetic recording medium deforms during its rotation and the magnetic head is then displaced, resulting in difficulty in reading data correctly. Thus, in order to deal with high-speed rotation, a magnetic recording medium glass substrate made of glass is required to have high rigidity (high Young's modulus) necessary for preventing significant deformation during high-speed rotation.

Further, a hard disk drive (HDD) in which a magnetic recording medium is incorporated adopts such a structure that the magnetic recording medium itself is rotated while the central portion of the magnetic recording medium is being held with a spindle of a spindle motor. Thus, if there is a large difference between the thermal expansion coefficient of a magnetic recording medium glass substrate and the thermal expansion coefficient of a spindle material forming a spindle portion, there occurs a difference between the thermal expansion and thermal contraction of the spindle and the thermal expansion and thermal contraction of the magnetic recording medium glass substrate in response to the change of temperature in a surrounding environment at the time of using the hard disk drive, resulting in the deformation of the magnetic recording medium. When such deformation occurs, it becomes impossible for a magnetic head to read out information written in the magnetic recording medium, leading to a cause for impairing the reliability on the reproduction of recorded information. Thus, in order to improve the reliability on a magnetic recording medium, a magnetic recording medium glass substrate made of glass is required to have as high a thermal expansion coefficient as a spindle material (such as stainless steel) has.

As described above, the magnetic recording medium glass substrate more preferably has, in addition to heat resistance necessary for enduring a high-temperature film-forming process from the viewpoint of attaining high density recording or the like, high rigidity and a high thermal expansion coefficient from the viewpoint of improving the reliability on a magnetic recording medium or the like. Thus, a glass blank manufactured by the method of manufacturing a glass blank according to an embodiment of the present invention preferably has an average linear expansion coefficient at 100 to 300° C. of 70×10⁻⁷/° C. or more and a Young's modulus of 70 GPa or more. Note that the average linear expansion coefficient at 100 to 300° C. is more preferably 75×10⁻⁷/° C. or more. On the other hand, the upper limit of the average linear expansion coefficient is not particularly limited, but is preferably 120×10⁻⁷/° C. or less for practical use. Further, the Young's modulus is more preferably 75 GPa or more, still more preferably 80 GPa or more. On the other hand, the upper limit of the Young's modulus is not particularly limited, but is preferably 100 GPa or less for practical use.

However, the three characteristics of high heat resistance, high rigidity, and a high thermal expansion coefficient, are in a trade-off relationship in a glass material. Further, when attempt is made on actually manufacturing a magnetic recording medium glass substrate made of glass which satisfies all the three characteristics, the resultant glass tends to have less thermal stability than conventional glass for a magnetic recording medium glass substrate. A glass material for a magnetic recording medium glass substrate is generally excellent in thermal stability, but when such glass having less thermal stability as described above is melt and molded, the outflow temperature of a molten glass flow 20 must be increased to prevent the devitrification of glass. As a result, the outflow viscosity of the molten glass flow 20 lowers, and hence it becomes difficult to separate a molten glass gob 24 by cutting a forward end portion 22 of the molten glass flow 20, cause the molten glass gob 24 to fall, and press-mold the molten glass gob 24.

Here, a glass composition capable of providing the magnetic recording medium glass substrate having the three characteristics of high heat resistance, high rigidity, and a high thermal expansion coefficient, is not particularly limited. However, from the viewpoint of easily striking a balance between the three characteristics, particularly preferred are glass materials formed of the two kinds of glass compositions described below. The two kinds of glass materials are hereinafter referred to as “Glass A” and “Glass B.”

Glass A and Glass B which are sequentially described in detail hereinafter are classified into oxide glass, and their glass compositions are expressed in terms of oxides. A glass composition in terms of oxides refers to a glass composition obtained by conversion to oxides based on the supposition that a glass material is completely decomposed at the time of melting and exists as oxides in glass. Note that Glass A and Glass B are noncrystalline (amorphous) glass, and hence each are formed of a homogeneous phase unlike crystallized glass. Thus, in a magnetic recording medium glass substrate manufactured by using any of Glass A and Glass B, excellent smoothness can be realized on the surface of the substrate. Hereinafter, in the order of Glass A and Glass B, the details of their glass materials are described.

First, Glass A is described. The glass composition of Glass A includes, as a glass composition expressed in mol %, 50 to 75% of SiO₂, 0 to 5% of Al₂O₂, 0 to 3% of Li₂O, 0 to 5% of ZnO, 3 to 15% in total of at least one kind of component selected from Na₂O and K₂O, 14 to 35% in total of at least one kind of component selected from MgO, CaO, SrO, and BaO, and 2 to 9% in total of at least one kind of component selected from ZrO₂, TiO₂, La₂O₃, Y₂O₃, Yb₂O₃, Ta₂O₅, Nb₂O₅, and HfO₂; and the molar ratio {(MgO+CaO)/(MgO+CaO+SrO+BaO)} is in the range of 0.8 to 1 and the molar ratio {Al₂O₃/(MgO+CaO)} is in the range of 0 to 0.30.

The content, total content, and ratio of each component are hereinafter expressed on a molar basis unless otherwise specified. Next, the details of each component forming Glass A are described.

SiO₂, which is a component for forming a glass network, has an effect of improving glass stability and chemical durability, and in particular, acid resistance. SiO₂ is also a component that contributes to reducing thermal diffusion in a magnetic recording medium glass substrate so as to enhance heating efficiency, when the step of forming a film such as a magnetic recording layer on the magnetic recording medium glass substrate is carried out, or when the magnetic recording medium glass substrate is heated by radiation in order to apply heat treatment to the film formed in the step. The content of SiO₂ in Glass A is in the range of 50 to 75%. When the content of SiO₂ is controlled to 50% or more, the above-mentioned functions can be sufficiently exerted. Moreover, when the content of SiO₂ is controlled to 75% or less, it is possible to surely suppress a phenomenon that SiO₂ is not completely dissolved in glass, producing undissolved substances and a phenomenon that bubble removal becomes insufficient because the viscosity of glass at the time of fining becomes too high. This is because, if a magnetic recording medium glass substrate is manufactured from glass containing undissolved substances, protrusions derived from the undissolved substances are produced on the surface of the magnetic recording medium glass substrate by polishing, and hence the resultant glass substrate sometimes cannot be used as a magnetic recording medium glass substrate which is required to have extremely high surface smoothness. Further, if a magnetic recording medium glass substrate is manufactured from glass containing bubbles, some of the bubbles appear on the surface of the magnetic recording medium glass substrate by polishing. In this case, portions at which some of the bubbles appear become as dents, impairing the smoothness of the main surface of the magnetic recording medium glass substrate, and hence the resultant glass substrate sometimes cannot be used as a magnetic recording medium glass substrate. Note that the content of SiO₂ in Glass A is preferably in the range of 57 to 70%, more preferably in the range of 57 to 68%, still more preferably in the range of 60 to 68%, still more preferably in the range of 63 to 68%.

Al₂O₃, which also contributes to forming a glass network, is a component that contributes to improving chemical durability and heat resistance. The content of Al₂O₃ in Glass A is in the range of 0 to 5%. When the content of Al₂O₃ is controlled to 5% or less, it is possible to prevent a phenomenon that the thermal expansion coefficient of a magnetic recording medium glass substrate becomes too small, thereby making a big difference in thermal expansion coefficient with respect to a spindle material forming a spindle portion of HDD, such as stainless steel. As a result, it is possible to surely prevent a phenomenon that there occurs a difference between the thermal expansion and thermal contraction of the spindle and the thermal expansion and thermal contraction of the magnetic recording medium glass substrate in response to the change of temperature in a surrounding environment, resulting in the deformation of a magnetic recording medium. Note that, when such deformation occurs, it becomes impossible for a magnetic head to read out information written in the magnetic recording medium, leading to a cause for impairing the reliability on the reproduction of recorded information. If Al₂O₃ is contained in a small amount, Al₂O₃ contributes to improving glass stability and lowering the liquidus temperature of glass, but as the content of Al₂O₃ is further increased, glass stability tends to lower and the liquidus temperature tends to rise. Thus, from the standpoint of further improving the glass stability in addition to providing a higher thermal expansion coefficient, the upper limit of the content of Al₂O₃ in Glass A is preferably 4% or less, more preferably 3% or less, still more preferably 2.5% or less, still more preferably 1% or less, still more preferably less than 1%. On the other hand, from the standpoint of improving the chemical durability, heat resistance, and glass stability, the lower limit of the content of Al₂O₃ is preferably 0.1% or more.

Li₂O contributes to improving the meltability and formability of glass and also contributes to increasing the thermal expansion coefficient of glass. On the other hand, if Li₂O is added in a small amount, the glass transition temperature of glass significantly lowers and the heat resistance of glass remarkably lowers. Thus, in consideration of these points, the content of Li₂O in Glass A is in the range of 0 to 3%. Note that, from the standpoint of further improving the heat resistance, the content of Li₂O is preferably in the range of 0 to 2%, more preferably in the range of 0 to 1%, still more preferably in the range of 0 to 0.8%, still more preferably in the range of 0 to 0.5%, still more preferably in the range of 0 to 0.1%, still more preferably in the range of 0 to 0.08%, and being substantially free of Li₂O is particularly preferred. Here, the phrase “substantially free” means that particular components are not intentionally added to a glass material, and does not exclude even the fact that some components are mixed as impurities.

ZnO contributes to improving the meltability and formability of glass and glass stability, to enhancing the rigidity, and to increasing the thermal expansion coefficient. However, if ZnO is excessively added, the glass transition temperature of glass significantly lowers, the heat resistance remarkably lowers, and the chemical durability lowers. Thus, the content of ZnO in Glass A is controlled in the range of 0 to 5%. From the standpoint of maintaining the heat resistance and the chemical durability in good conditions, the content of ZnO is preferably in the range of 0 to 4%, more preferably in the range of 0 to 3%, still more preferably in the range of 0 to 2%, still more preferably in the range of 0 to 1%, still more preferably in the range of 0 to 0.5%. Further, Glass A may be substantially free of ZnO.

Na₂O and K₂O mainly contribute to improving the meltability and formability of glass, to promoting bubble removal by reducing the viscosity of glass at the time of fining, and to increasing the thermal expansion coefficient, but, among alkali metal oxide components, Na₂O and K₂O have a smaller function that is to decrease the glass transition temperature as compared with Li₂O. Here, from the standpoint of imparting homogeneity (state in which neither undissolved substances nor remaining bubbles exist) and thermal expansion characteristics, which are required for a magnetic recording medium glass substrate, the lower limit of the total content of Na₂O and K₂O in Glass A is controlled to 3% or more. Moreover, the upper limit is controlled to 15% or less. As a result, it is possible to suppress the occurrence of problems, such as a problem that the glass transition temperature lowers, thereby impairing the heat resistance, a problem that the chemical durability, and in particular, the acid resistance lowers, and a problem that the elution of an alkali increases from the surface of a magnetic recording medium glass substrate and a precipitated alkali gives damage to, for example, a film formed on the magnetic recording medium glass substrate. The total content of Na₂O and K₂O is preferably in the range of 5 to 13%, more preferably in the range of 8 to 13%, still more preferably in the range of 8 to 11%.

Glass A may be used as a magnetic recording medium glass substrate without being subjected to ion exchange, or Glass A may be used as a magnetic recording medium glass substrate after being subjected to ion exchange. When ion exchange is conducted, Na₂O is a suitable component as a component involved in the ion exchange. Further, the coexistence of Na₂O and K₂O as glass components causes a mixed alkali effect, thereby providing the effect of suppressing alkali elution as well. However, if both components are excessively introduced, there is liable to occur the same problem as in the case where the total content of both components is excessive. From that standpoint, after the total content of Na₂O and K₂O is controlled in the above-mentioned ranges, the range of the content of Na₂O is controlled to preferably 0 to 5%, more preferably 0.1 to 5%, still more preferably 1 to 5%, still more preferably to 2 to 5%, and the range of the content of K₂O is controlled to preferably 1 to 10%, more preferably 1 to 9%, still more preferably 1 to 8%, still more preferably 3 to 8%, still more preferably 5 to 8%.

MgO, CaO, SrO, and BaO, which are alkaline-earth metal components, each contribute to improving the meltability and formability of glass and glass stability and to increasing the thermal expansion coefficient. Thus, in order to obtain these effects, the total content of MgO, CaO, SrO, and BaO in Glass A is controlled to 14% or more. On the other hand, the total content of MgO, CaO, SrO, and BaO is controlled to 35% or less. As a result, the lowering of the chemical durability can be surely suppressed. The total content of MgO, CaO, SrO, and BaO is preferably in the range of 14 to 32%, more preferably in the range of 14 to 26%, still more preferably in the range of 15 to 26%, still more preferably in the range of 17 to 25%.

By the way, it is required for a magnetic recording medium glass substrate for a magnetic recording medium to be used for mobile application to have high rigidity and high hardness necessary for enduring impacts while mobile devices are being carried and to have a light weight. Thus, glass for manufacturing such magnetic recording medium glass substrate desirably has a high Young's modulus, a high specific elastic modulus, and a low specific gravity. Further, as described previously, glass for a magnetic recording medium glass substrate is required to have high rigidity in order to endure high-speed rotation. Here, among the above-mentioned alkaline-earth metal components, MgO and CaO contribute to enhancing the rigidity and hardness and to suppressing the increase of the specific gravity. MgO and CaO therefore are very useful components in order to obtain glass having a high Young's modulus, a high specific elastic modulus, and a low specific gravity. In particular, MgO is effective for attaining the high Young's modulus of glass and the low specific gravity, and CaO is an effective component for attaining the high thermal expansion. Thus, from the standpoint of attaining the high Young's modulus, the high specific elastic modulus, and the low specific gravity of a magnetic recording medium glass substrate, the molar ratio of the total content of MgO and CaO to the total content of MgO, CaO, SrO, and BaO(MgO+CaO+SrO+BaO) (that is, (MgO+CaO)/(MgO+CaO+SrO+BaO)) in Glass A is controlled in the range of 0.8 to 1. The molar ratio of 0.8 or more can suppress the occurrence of problems, such as the reduction of the Young's modulus and specific elastic modulus and the increase of the specific gravity.

Note that the upper limit of the molar ratio, provided that SrO and BaO are excluded, is 1 as the maximum value. The molar ratio ((MgO+CaO)/(MgO+CaO+SrO+BaO)) is preferably in the range of 0.85 to 1, more preferably in the range of 0.88 to 1, still more preferably in the range of 0.89 to 1, still more preferably in the range of 0.9 to 1, still more preferably in the range of 0.92 to 1, still more preferably in the range of 0.94 to 1, still more preferably in the range of 0.96 to 1, still more preferably in the range of 0.98 to 1, particularly preferably in the range of 0.99 to 1, most preferably 1. From the viewpoints of attaining the high Young's modulus of glass, the high specific elastic modulus, and the low specific gravity, and of maintaining the chemical durability, the content of MgO is preferably in the range of 1 to 23%. Here, the lower limit of the content of MgO is preferably 2% or more, more preferably 5% or more, and the upper limit of the content of MgO is preferably 15% or less, more preferably 8% or less.

From the viewpoints of attaining the high Young's modulus of glass, the high specific elastic modulus, the low specific gravity, and the high thermal expansion, and of maintaining the chemical durability, the content of CaO is preferably in the range of 6 to 21%, more preferably in the range of 10 to 20%, still more preferably in the range of 10 to 18%, still more preferably in the range of 10 to 15%. Note that, from the above-mentioned viewpoints, the total content of MgO and CaO is controlled to preferably 15 to 35%, more preferably 15 to 32%, still more preferably 15 to 30%, still more preferably 15 to 25%, still more preferably 15 to 20%.

SrO has the above-mentioned effects, but if SrO is contained excessively, the specific gravity of glass increases. In addition, the material cost of SrO is higher as compared with MgO and CaO. Thus, the content of SrO is controlled preferably in the range of 0 to 5%, more preferably in the range of 0 to 2%, still more preferably in the range of 0 to 1%, still more preferably in the range of 0 to 0.5%. SrO may not be introduced as a glass component, that is, Glass A may be glass substantially free of SrO.

BaO also has the above-mentioned effects, but if BaO is contained excessively, there occur problems, such as a problem that the specific gravity of glass increases, a problem that the Young's modulus lowers, a problem that the chemical durability lowers, a problem that the specific gravity increases, and a problem that the material cost increases. Thus, the content of BaO is controlled to preferably 0 to 5%. The content of BaO is more preferably in the range of 0 to 3%, still more preferably in the range of 0 to 2%, still more preferably in the range of 0 to 1%, still more preferably in the range of 0 to 0.5%. BaO may not be introduced as a glass component, that is, Glass A may be glass substantially free of BaO.

From the above-mentioned viewpoints, the total content of SrO and BaO is controlled to preferably 0 to 5%, more preferably 0 to 3%, still more preferably 0 to 2%, still more preferably 0 to 1%, still more preferably 0 to 0.5%.

As described above, MgO and CaO have the effects of increasing the Young's modulus of glass and the thermal expansion coefficient. On the other hand, Al₂O₃ weakly contributes to increasing the Young's modulus and contributes to decreasing the thermal expansion coefficient. Then, from the standpoint of obtaining glass having a high Young's modulus and exhibiting high thermal expansion, in the glass which is used in the method of manufacturing a glass blank according to an embodiment of the present invention, the molar ratio of the content of Al₂O₃ to the total content of MgO and CaO (MgO+CaO) (that is, Al₂O₃/(MgO+CaO)) is controlled in the range of 0 to 0.30. Attaining the high heat resistance of glass, attaining the high Young's modulus of glass, and attaining the high thermal expansion of glass are in a trade-off relationship to each other. Thus, in order to satisfy these three requirements at the same time, it is insufficient to adjust a composition by setting solely each content of Al₂O₃, MgO, and CaO, and it is important to control the above-mentioned molar ratio in a required range. The molar ratio (Al₂O₃/(MgO+CaO)) is preferably in the range of 0 to 0.1, more preferably in the range of 0 to 0.05, still more preferably in the range of 0 to 0.03.

CaO is, out of MgO and CaO, a component that contributes more to attaining the high thermal expansion of glass, and when CaO is contained as an essential component, in order to attain the higher thermal expansion of glass, the molar ratio of the content of Al₂O₃ to the content of CaO (that is, Al₂O₃/CaO) is controlled preferably in the range of 0 to 0.4, more preferably in the range of 0 to 0.2, still more preferably in the range of 0 to 0.1.

ZrO₂, TiO₂, La₂O₃, Y₂O₃, Yb₂O₃, Ta₂O₅, Nb₂O₅, and HfO₂ contribute to improving the chemical durability of glass, and in particular, the alkali resistance, and also to ameliorating the heat resistance by increasing the glass transition temperature and enhancing the rigidity and fracture toughness. Thus, when the total content of ZrO₂, TiO₂, La₂O₃, Y₂O₃, Yb₂O₃, Ta₂O₅, Nb₂O₅, and HfO₂ in Glass A is controlled to 2% or more, the above-mentioned effects are liable to be provided reliably. Further, when the total content is controlled to 9% or less, it is possible to suppress more surely problems, such as a problem that a magnetic recording medium glass substrate excellent in smoothness is not obtained because the meltability of glass lowers and undissolved substances remain in the glass, and a problem that the specific gravity increases. Therefore, the total content of ZrO₂, TiO₂, La₂O₃, Y₂O₃, Yb₂O₃, Ta₂O₅, Nb₂O₅, and HfO₂ in Glass A is controlled to 2 to 9%. The total content of ZrO₂, TiO₂, La₂O₃, Y₂O₃, Yb₂O₃, Ta₂O₅, Nb₂O₅, and HfO₂ is preferably in the range of 2 to 8%, more preferably in the range of 2 to 7%, still more preferably in the range of 2 to 6%, still more preferably in the range of 2 to 5%, still more preferably in the range of 3 to 5%.

ZrO₂ significantly contributes to ameliorating the heat resistance of glass by increasing the glass transition temperature and to ameliorating the chemical durability, and in particular, the alkali resistance. In addition, ZrO₂ has the effect of attaining the high rigidity by increasing the Young's modulus. Thus, the molar ratio of the content of ZrO₂ to the total content of ZrO₂, TiO₂, La₂O₃, Y₂O₃, Yb₂O₃, Ta₂O₅, Nb₂O₅, and HfO₂ (ZrO₂+TiO₂+La₂O₃+Y₂O₃+Yb₂O₃+Ta₂O₅+Nb₂O₅+HfO₂) (that is, (ZrO₂/(ZrO₂+TiO₂+La₂O₃+Y₂O₃+Yb₂O₃+Ta₂O₅+Nb₂O₅+HfO₂)) in Glass A is controlled to preferably 0.3 to 1, more preferably 0.4 to 1, still more preferably 0.5 to 1, still more preferably 0.7 to 1, still more preferably 0.8 to 1, still more preferably 0.9 to 1, still more preferably 0.95 to 1, particular preferably 1. The content of ZrO₂ is preferably in the range of 2 to 9%, more preferably in the range of 2 to 8%, still more preferably in the range of 2 to 7%, still more preferably in the range of 2 to 6%, still more preferably in the range of 2 to 5%, still more preferably in the range of 3 to 5%.

TiO₂ is, out of the above-mentioned components, excellent in the function of suppressing the increase of the specific gravity of glass and has the function of increasing the Young's modulus and the specific elastic modulus. Note that, if TiO₂ is introduced excessively, when glass is immersed in water, water reaction products are liable to attach to the surface of the glass, leading to the reduction of the water resistance of glass, and hence the content of TiO₂ is controlled preferably in the range of 0 to 5%. From the standpoint of keeping the water resistance satisfactory, the content of TiO₂ is preferably in the range of 0 to 4%, more preferably in the range of 0 to 3%, still more preferably in the range of 0 to 2%, still more preferably in the range of 0 to 1%, still more preferably in the range of 0 to 0.5%. Note that Glass A is preferably substantially free of TiO₂ from the standpoint of further ameliorating the water resistance.

La₂O₃, Y₂O₃, Yb₂O₃, Ta₂O₅, Nb₂O₅, and HfO₂ each have a good ability to increase the specific gravity of glass, and hence, from the standpoint of suppressing the increase of the specific gravity, the content of each component is controlled preferably in the range of 0 to 4%, more preferably in the range of 0 to 3%, still more preferably in the range of 0 to 2%, still more preferably in the range of 0 to 1%, still more preferably in the range of 0 to 0.5%. La₂O₃, Y₂O₃, Yb₂O₃, Ta₂O₅, Nb₂O₅, and HfO₂ may not be introduced as glass components.

Examples of other glass components that may be introduced include B₂O₃ and P₂O₅. B₂O₃ contributes to reducing the fragility of glass and to improving the meltability. However, excessively introducing B₂O₃ reduces the chemical durability, and hence the content of B₂O₃ is preferably in the range of 0 to 3%, more preferably in the range of 0 to 1%, still more preferably in the range of 0 to 0.5%, and introducing no B₂O₃ is much more preferred.

P₂O₅ can be introduced in a small amount. Excessively introducing P₂O₅ reduces the chemical durability of glass, and hence the content of P₂O₅ is controlled to preferably 0 to 1%, more preferably 0 to 0.5%, still more preferably 0 to 0.3%, and introducing no P₂O₅ is much more preferred. From the standpoint of obtaining glass that satisfies the three characteristics of high heat resistance, a high Young's modulus, and a high thermal expansion coefficient at the same time, the total content of SiO₂, Al₂O₃, Na₂O, K₂O, MgO, CaO, ZrO₂, TiO₂, La₂O₃, Y₂O₃, Yb₂O₃, Ta₂O₅, Nb₂O₅, and HfO₂ is controlled to preferably 95% or more, more preferably 97% or more, still more preferably 98% or more, still more preferably 99% or more, and may be controlled to 100%.

Further, from the standpoint of suppressing the increase of the specific gravity of glass, the total content of SiO₂, Al₂O₃, Na₂O, K₂O, MgO, CaO, ZrO₂, and TiO₂ is controlled to preferably 95% or more, more preferably 97% or more, still more preferably 98% or more, still more preferably 99% or more, and may be controlled to 100%.

Further, from the standpoint of ameliorating the water resistance of glass, the total content of SiO₂, Al₂O₃, Na₂O, K₂O, MgO, CaO, and ZrO₂ is controlled to preferably 95% or more, more preferably 97% or more, still more preferably 98% or more, still more preferably 99% or more, and may be controlled to 100%.

From those viewpoints, Glass A includes preferably (1) 50 to 75% of SiO₂, 0 to 3% of B₂O₃, 0 to 5% of Al₂O₃, 0 to 3% of Li₂O, 0 to 5% of Na₂O, 1 to 10% of K₂O, 1 to 23% of MgO, 6 to 21% of CaO, 0 to 5% of BaO, 0 to 5% of ZnO, 0 to 5% of TiO₂, and 2 to 9% of ZrO₂, more preferably (2) 50 to 75% of SiO₂, 0 to 1% of B₂O₃, 0 to 5% of Al₂O₃, 0 to 3% of Li₂O, 0 to 5% of Na₂O, 1 to 9% of K₂O, 2 to 23% of MgO, 6 to 21% of CaO, 0 to 3% of BaO, 0 to 5% of ZnO, 0 to 3% of TiO₂, and 3 to 7% of ZrO₂.

Next, Glass B is described. Glass B includes, as a glass composition, 56 to 75% of SiO₂, 1 to 11% of Al₂O₃, more than 0% and 4% or less of Li₂O, 1% or more and less than 15% of Na₂O, and 0% or more and less than 3% of K₂O, and is substantially free of BaO, the total content of alkali metal oxides selected from the group consisting of Li₂O, Na₂O, and K₂O is in the range of 6 to 15%, the molar ratio of the content of Li₂O to the content of Na₂O (Li₂O/Na₂O) is less than 0.50, the molar ratio of the content of K₂O to the above-mentioned total content of the alkali metal oxides {K₂O/(Li₂O+Na₂O+K₂O)} is 0.13 or less, the total content of alkaline-earth metal oxides selected from the group consisting of MgO, CaO, and SrO is in the range of 10 to 30%, the total content of MgO and CaO is in the range of 10 to 30%, the molar ratio of the total content of MgO and CaO to the above-mentioned total content of the alkaline-earth metal oxides {(MgO+CaO)/(MgO+CaO+SrO)} is 0.86 or more, the total content of the above-mentioned alkali metal oxides and the above-mentioned alkaline-earth metal oxides is in the range of 20 to 40%, the molar ratio of the total content of MgO, CaO, and Li₂O to the total content of the above-mentioned alkali metal oxides and the above-mentioned alkaline-earth metal oxides {(MgO+CaO+Li₂O)/(Li₂O+Na₂O+K₂O+MgO+CaO+SrO)} is 0.50 or more, the total content of oxides selected from the group consisting of ZrO₂, TiO₂, Y₂O₃, La₂O₃, Gd₂O₃, Nb₂O₅, and Ta₂O₅ is more than 0% and 10% or less, and the molar ratio of the above-mentioned total content of the oxides to the content of Al₂O_{3 {(ZrO}₂+TiO₂+Y₂O₃+La₂O₃+Gd₂O₃+Nb₂O₅+Ta₂O₅)/Al₂O₃} is 0.40 or more.

Next, the details of each component forming Glass B are described.

SiO₂, which is a component for forming a glass network, has the effect of improving glass stability and chemical durability, and in particular, acid resistance. SiO₂ is also a component that contributes to reducing thermal diffusion in a substrate so as to enhance heating efficiency, when the step of forming a film such as a magnetic recording layer on the magnetic recording medium glass substrate is carried out, or when the substrate is heated by radiation in order to apply heat treatment to the film formed in the step. When the content of SiO₂ is less than 56%, the chemical durability of glass lowers, and when the content of SiO₂ is more than 75%, the rigidity lowers. In addition, when the content of SiO₂ is more than 75%, SiO₂ does not perfectly dissolve in glass, producing undissolved substances and bubble removal becomes insufficient because the viscosity of glass at the time of fining becomes too high. This is because, if a substrate is manufactured from glass containing undissolved substances, protrusions derived from the undissolved substances are produced on the surface of the substrate by polishing, and hence the resultant glass substrate cannot be used as a magnetic recording medium glass substrate which is required to have extremely high surface smoothness. Further, if a magnetic recording medium glass substrate is manufactured from glass containing bubbles, some of the bubbles appear on the surface of the substrate by polishing. In this case, the portions become dents, impairing the smoothness of the main surface of the magnetic recording medium glass substrate, and hence the resultant glass substrate cannot be used as a magnetic recording medium glass substrate. In view of the foregoing, the content of SiO₂ is controlled to 56 to 75%. The content of SiO₂ is preferably in the range of 58 to 70%, more preferably in the range of 60 to 70%.

Al₂O₃, which also contributes to forming a glass network, is a component that contributes to improving the rigidity and heat resistance. Note that, if the content of Al₂O₃ is more than 11%, the devitrification resistance (stability) of glass lowers, and hence the introduction amount of Al₂O₃ is controlled to 11% or less. On the other hand, if the content of Al₂O₃ is less than 1%, the stability, chemical durability, and heat resistance of glass lower, and hence the introduction amount of Al₂O₃ is controlled to 1% or more. Thus, the content of Al₂O₃ is in the range of 1 to 11%. From the viewpoints of the stability, chemical durability, and heat resistance of glass, the content of Al₂O₃ is preferably in the range of 1 to 10%, more preferably in the range of 2 to 9%, still more preferably in the range of 3 to 8%.

Li₂O is a component for enhancing the rigidity of glass. In addition, as the ease of movability in glass is in the order of Li>Na>K among alkali metals, introducing Li is advantageous from the viewpoint of the chemical strengthening ability as well. Note that, if Li₂O is introduced in an excessive amount, the reduction of the heat resistance is caused, and hence the introduction amount of Li₂O is controlled to 4% or less. That is, the content of Li₂O is more than 0% and 4% or less. From the viewpoints of the high rigidity, high heat resistance, and chemical strengthening ability, the content of Li₂O is preferably in the range of 0.1 to 3.5%, more preferably in the range of 0.5 to 3%, still more preferably in the range of more than 1% and 3% or less, still more preferably in the range of more than 1% and 2.5% or less.

Further, as described above, introducing Li₂O in an excessive amount causes the reduction of the heat resistance, and if Li₂O is introduced in an excessive amount with respect to Na₂O, the reduction of the heat resistance is also caused. Thus, the introduction amount of Li₂O is adjusted with respect to the introduction amount of Na₂O so that the molar ratio of the content of Li₂O to the content of Na₂O (that is, Li₂O/Na₂O) falls in the range of less than 0.50. From the viewpoint of suppressing the reduction of the heat resistance while providing the effects due to the introduction of Li₂O, the above-mentioned molar ratio (Li₂O/Na₂O) is controlled preferably in the range of 0.01 or more and less than 0.50, more preferably in the range of 0.02 to 0.40, still more preferably in the range of 0.03 to 0.40, still more preferably in the range of 0.04 to 0.30, still more preferably in the range of 0.05 to 0.30.

In addition, if the introduction amount of Li₂O is excessive with respect to the total content of the alkali metal oxides (Li₂O+Na₂O+N₂O), the reduction of the heat resistance of glass is also caused, and if the introduction amount of Li₂O is too small, the reduction of the chemical strengthening ability is caused. Thus, the introduction amount of Li₂O is preferably adjusted with respect to the total amount of the alkali metal oxides so that the molar ratio of the content of Li₂O to the total content of the alkali metal oxides {Li₂O/(Li₂O+Na₂O+K₂O)} falls in the range of less than ⅓. From the viewpoint of suppressing the reduction of the heat resistance while providing the effects due to the introduction of Li₂O, the upper limit of the molar ratio {Li₂O/(Li₂O+Na₂O+K₂O)} is preferably 0.28, more preferably 0.23. From the viewpoint of suppressing the reduction of the chemical strengthening ability, the lower limit of the molar ratio {Li₂O/(Li₂O+Na₂O+K₂O)} is preferably 0.01, more preferably 0.02, still more preferably 0.03, still more preferably 0.04, still more preferably 0.05.

As Na₂O is a component that is effective for ameliorating the thermal expansion characteristics of glass, Na₂O is introduced at 1% or more. In addition, as Na₂O is a component that contributes to also ameliorating the chemical strengthening ability, introducing Na₂O at 1% or more is advantageous from the viewpoint of the chemical strengthening ability. Note that, if the introduction amount of Na₂O is 15% or more, the reduction of the heat resistance is caused. Thus, the content of Na₂O is controlled to 1% or more and less than 15%. From the viewpoints of the thermal expansion characteristics, the heat resistance, and the chemical strengthening ability, the content of Na₂O is preferably in the range of 4 to 13%, more preferably in the range of 5 to 11%.

K₂O is a component that is effective for ameliorating the thermal expansion characteristics of glass. Introducing K₂O in an excessive amount causes the reduction of the heat resistance and the reduction of the thermal conductivity, and deteriorates the chemical strengthening ability. Thus, the introduction amount of K₂O is controlled to less than 3%. That is, the content of K₂O is 0% or more and less than 3%. From the viewpoint of ameliorating the thermal expansion characteristics while maintaining the heat resistance, the content of K₂O is preferably in the range of 0 to 2%, more preferably in the range of 0 to 1%, still more preferably in the range of 0 to 0.50, still more preferably in the range of 0 to 0.1%. From the viewpoint of the heat resistance and the chemical strengthening ability, K₂O is preferably not introduced substantially. Note that, the phrases “substantially free” and “not introduced substantially” mean that particular components are intentionally not added to a glass material, and does not exclude even the fact that some components are mixed as impurities. The same holds true for the description “0%” as for a glass composition.

Further, when the total content of alkali metal oxides selected from the group consisting of Li₂O, Na₂O, and K₂O is less than 6%, the meltability and thermal expansion characteristics of glass lower, and when the total content is more than 15%, the heat resistance lowers. Thus, from the viewpoints of the meltability, thermal expansion characteristics, and heat resistance of glass, the total content of the alkali metal oxides selected from the group consisting of Li₂O, Na₂O, and K₂O is controlled in the range of 6 to 15%, preferably 7 to 15%, more preferably 8 to 13%, still more preferably 8 to 12%.

Here, Glass B is substantially free of BaO. The reason for excluding the introduction of BaO is as mentioned below.

In order to enhance the recording density of a magnetic recording medium, the distance between a magnetic head and the surface of the magnetic recording medium needs to be made closer, thereby improving the writing and reading resolution. For that purpose, progress has been made in recent years on attaining the low spacing of a head (reduction of the space between a magnetic head and the surface of a magnetic recording medium), and hence even the existence of only protrusions with a little height has not been allowed on the surface of a magnetic recording medium. This is because, in a recording and reproducing system in which the low spacing of a head has been attained, even minute protrusions hits a head, resulting in a cause for damage of a head device or the like. On the other hand, BaO reacts with carbon dioxide in the air and produces BaCO₃, which serves as an excrescence on the surface of a magnetic recording medium glass substrate. Thus, from the viewpoint of reducing excrescences, BaO is not contained. Further, BaO is a component that causes the quality change of a glass surface (which is called weathering) and may form minute protrusions on the surface of the substrate, and hence BaO is excluded for the purpose of preventing weathering on the surface of a magnetic recording medium glass substrate. Note that attaining Ba-free is preferred from the standpoint of reducing environmental load as well.

In addition, the fact that a glass substrate is substantially free of BaO is desirable for the glass substrate to be used as a magnetic recording medium that is used in a heat-assisted recording method. The reasons are described below.

As a recording density is enhanced, a bit size becomes smaller. The target value of a bit size necessary for realizing high density recording at a density of, for example, more than 1 terabyte/inch² is several tens of nanometers in diameter. When recording is made with such minute bit size, a heated region needs to be made as small as the bit size in heat-assisted recording. Further, in order to make high-speed recording with a minute bit size, the time that can be spent for recording in one bit is an extremely short time. Thus, heat-assisted heating and cooling must be completed instantly. That is, it is required that the heating and cooling of a magnetic recording medium for heat-assisted recording be locally performed as quickly as possible.

Then, it is proposed that a heatsink layer (for example, a Cu film) made of a material having a high thermal conductivity is formed between a magnetic recording medium substrate for heat-assisted recording and a magnetic recording layer (for example, see JP 2008-52869 A). A heatsink layer is a layer that plays a roll of transferring heat given to a recording layer to the vertical direction (thickness direction) not to an in-plane direction by inhibiting heat from spreading in the in-plane direction and accelerating the flow of heat in the vertical direction (depth direction). As the heatsink layer is thicker, heating and cooling can be performed in a shorter time and more locally, but in order to make the heatsink layer thicker, a film formation time must be longer, resulting in decreased productivity. Moreover, as the thickness of the heatsink layer becomes larger, more heat is accumulated at the time of layer film formation. As a result, the crystallinity and crystal orientation property of a magnetic layer formed on the layer become irregular, and the amelioration of recording density sometimes becomes difficult. In addition, as the heatsink layer is thicker, corrosion occurs in the heatsink layer and the whole film swells. As a result, a convex defect is liable to occur, to thereby hinder the attaining of a low spacing. In particular, when iron materials are used in the heatsink layer, the above-mentioned phenomenon is highly liable to occur.

As described above, forming a heat sink layer having a large thickness is advantageous for performing heating and cooling in a short time and locally, but it is not desirable from the viewpoints of ameliorating productivity and recording density and attaining a low spacing. To cope with the problems, it is considered to enhance the thermal conductivity of a glass substrate for the purpose of compensating the roll that the heat sink layer plays.

Here, glass includes SiO₂, Al₂O₃, alkali metal oxides, alkaline-earth metal oxides, and the like as its constituent components. Of those, the alkali metal oxides and the alkaline-earth metal oxides have, as modifying components, functions to ameliorate the meltability of glass and increase the thermal expansion coefficient of glass. Thus, a given amount of the components must be introduced into glass. Of those, Ba, which has the largest atomic number, mainly contributes to reducing the thermal conductivity of glass. As BaO is not contained here, the reduction of the thermal conductivity caused by BaO does not occur. Thus, even if the heatsink layer is made thinner, heating and cooling can be performed in a short time and locally.

Note that BaO most contributes to keeping the glass transition temperature high among the alkaline-earth metal oxides. In order to prevent the reduction of the glass transition temperature caused by manufacturing glass free of BaO, the molar ratio of the total content of MgO and CaO to the total content of MgO, CaO, and SrO, which are alkaline-earth metal oxides, {(MgO+CaO)/(MgO+CaO+SrO)} is controlled to 0.86 or more. This is because, if the total content of the alkaline-earth metal oxides is set to a given content, the total content is intensively allocated to each content of one kind or two kinds of the alkaline-earth metal oxides rather than allocated to each content of various kinds of the alkaline-earth metal oxides, thereby being able to keep the glass transition temperature high. That is, the reduction of the glass transition temperature caused by manufacturing glass free of BaO is suppressed by controlling the above-mentioned molar ratio to 0.86 or more. Further, one of the characteristics that are required for a magnetic recording medium glass substrate is high rigidity (a high Young's modulus) as described above, and desirable characteristics that are required for the magnetic recording medium glass substrate include, as described later, a small specific gravity. For the purpose of attaining the high Young's modulus of glass and attaining the low specific gravity, it is advantageous to introduce preferentially MgO and CaO among the alkaline-earth metal oxides, and hence controlling the above-mentioned molar ratio to 0.86 or more is also effective to realize the attaining of the high Young's modulus of a glass substrate and the attaining of the low specific gravity of a glass substrate. From the viewpoints described above, the molar ratio is preferably 0.88 or more, more preferably 0.90 or more, still more preferably 0.93 or more, still more preferably 0.95 or more, still more preferably 0.97 or more, still more preferably 0.98 or more, particularly preferably 0.99 or more, most preferably 1.

If the total content of alkaline-earth metal oxides selected from the group consisting of MgO, CaO, and SrO is too small, the rigidity and thermal expansion characteristics of glass lower, and if the total content is excessive, the chemical durability lowers. In order to realize the high rigidity, high thermal expansion characteristics, and good chemical durability of glass, the above-mentioned total content of the alkaline-earth metal oxides is controlled in the range of 10 to 30%, preferably 10 to 25%, more preferably 11 to 22%, still more preferably 12 to 22%, still more preferably 13 to 21%, still more preferably 15 to 20%.

Further, MgO and CaO are components that are preferentially introduced as described above, and are introduced so as to be a content of 10 to 30% in total. This is because, when the total content of MgO and CaO is less than 10%, the rigidity and the thermal expansion characteristics lower, and when the total content is more than 30%, the chemical durability lowers. From the viewpoint of favorably exhibiting the effects by preferentially introducing MgO and CaO, the total content of MgO and CaO is preferably in the range of 10 to 25%, more preferably in the range of 10 to 22%, still more preferably in the range of 11 to 20%, still more preferably in the range of 12 to 20%.

Further, K₂O has the largest atomic number among the alkali metal oxides, mainly contributes to reducing the thermal conductivity of glass, and is disadvantageous in terms of the chemical strengthening ability, and hence the content of K₂O is limited with respect to the total content of the alkali metal oxides. The molar ratio of the content of K₂O to the total content of the alkali metal oxides (that is, {K₂O/(Li₂O+Na₂O+K₂O)}) is controlled to 0.13 or less. From the viewpoints of the chemical strengthening ability and the thermal conductivity, the above-mentioned molar ratio is controlled to preferably 0.10 or less, more preferably 0.08 or less, still more preferably 0.06 or less, still more preferably 0.05 or less, still more preferably 0.03 or less, still more preferably 0.02 or less, particularly preferably 0.01 or less, and glass substantially free of K₂O is most preferred, that is, introducing no K₂O is most preferred.

The total content of the above-mentioned alkali metal oxides and alkaline-earth metal oxides (Li₂O+Na₂O+K₂O+MgO+CaO+SrO) is 20 to 40%. This is because, when the total content is less than 20%, the meltability, thermal expansion coefficient, and rigidity of glass lower, and when the total content is more than 40%, the chemical durability and the heat resistance lower. From the viewpoint of maintaining the above-mentioned characteristics favorably, the total content of the above-mentioned alkali metal oxides and alkaline-earth metal oxides is preferably in the range of 20 to 35%, more preferably in the range of 21 to 33%, still more preferably in the range of 23 to 33%.

As described above, MgO, CaO, and Li₂O are components effective to realize enhancing the rigidity (attaining the high Young's modulus) of glass. When the total content of these three components becomes too small with respect to the total content of the above-mentioned alkali metal oxides and alkaline-earth metal oxides, it becomes difficult to enhance the Young's modulus. Then, the total introduction amount of MgO, CaO, and Li₂O is adjusted based on the total content of the above-mentioned alkali metal oxides and alkaline-earth metal oxides, so that the molar ratio of the total content of MgO, CaO, and Li₂O to the total content of the above-mentioned alkali metal oxides and alkaline-earth metal oxides {(MgO+CaO+Li₂O)/(Li₂O+Na₂O+K₂O+MgO+CaO+SrO)} becomes 0.50 or more. In order to further enhance the Young's modulus of the glass substrate, the above-mentioned molar ratio is controlled to preferably 0.51 or more, more preferably 0.52 or more. Moreover, from the viewpoint of the stability of glass, the above-mentioned molar ratio is controlled to preferably 0.80 or less, more preferably 0.75 or less, still more preferably 0.70 or less.

Further, the introduction amount of each alkaline-earth metal oxide is as described above, and BaO is not introduced into Glass B substantially.

From the viewpoints of improving the Young's modulus of glass, attaining the low specific gravity, and further, improving the specific elastic modulus thereby, the content of MgO is preferably in the range of 0 to 14%, more preferably 0 to 10%, still more preferably 0 to 8%, still more preferably 0 to 6%, still more preferably 1 to 6%. Note that the specific elastic modulus is described later.

From the viewpoints of improving the thermal expansion characteristics and Young's modulus of glass and attaining the low specific gravity, the introduction amount of CaO is preferably in the range of 3 to 20%, more preferably 4 to 20%, still more preferably 10 to 20%.

SrO is a component that improves the thermal expansion characteristics of glass, but is a component that more increases the specific gravity as compared with MgO and CaO. Thus, the introduction amount of SrO is controlled to preferably 4% or less, more preferably 3% or less, still more preferably 2.5% or less, still more preferably 2% or less, still more preferably 1% or less, and SrO may not be introduced substantially.

The content and ratio of SiO₂, Al₂O₃, alkali metal oxides, and alkaline-earth metal oxides are as described above, and the glass exemplified herein includes the oxide components described below. Their details are hereinafter described.

Oxides selected from the group consisting of ZrO₂, TiO₂, Y₂O₃, La₂O₃, Gd₂O₃, Nb₂O₅, and Ta₂O₅ are components that enhance the rigidity and heat resistance of glass, and hence at least one kind thereby is introduced. However, if those oxides are introduced excessively, the meltability and thermal expansion characteristics of glass lower. Thus, the total content of the above-mentioned oxides is controlled in the range of more than 0% and 10% or less, preferably 1 to 10%, more preferably 2 to 10%, still more preferably 2 to 9%, still more preferably 2 to 7%, still more preferably 2 to 6%.

Further, Al₂O₃ is also a component that enhances the rigidity and heat resistance of glass as described above, but the above-mentioned oxides contribute more highly to enhancing the Young's modulus than Al₂O₃. When the above-mentioned oxides are introduced at a molar ratio of 0.4 or more with respect to Al₂O₃, that is, when the molar ratio of the total content of the above-mentioned oxides to the content of Al₂O₃ {(ZrO₂+TiO₂+Y₂O₃+La₂O₃+Gd₂O₃+Nb₂O₅+Ta₂O₅)/Al₂O₃} is controlled to 0.40 or more, the improvement of the rigidity and heat resistance can be realized. From the viewpoint of further improving the rigidity and heat resistance, the above-mentioned molar ratio is controlled to preferably 0.50 or more, more preferably 0.60 or more, still more preferably 0.70 or more. Moreover, from the viewpoint of the stability of glass, the above-mentioned molar ratio is controlled to preferably 4.00 or less, more preferably 3.00 or less, still more preferably 2.00 or less, still more preferably 1.00 or less, still more preferably 0.90 or less, still more preferably 0.85 or less.

Further, B₂O₃ is a component that ameliorates the fragility of the glass substrate and improves the meltability of glass. However, if B₂O₃ is introduced excessively, the heat resistance lowers. Thus, the introduction amount of B₂O₃ is controlled to preferably 0 to 3%, more preferably 0 to 2%, still more preferably 0% or more and less than 1%, still more preferably 0 to 0.5%, and B₂O₃ may not be introduced substantially.

Cs₂O is a component that can be introduced in a small amount as long as the desired characteristics and properties of glass are not impaired. However, Cs₂O is a component that more increases the specific gravity as compared with other alkali metal oxides, and hence Cs₂O may not be introduced substantially.

ZnO is a component that ameliorates the meltability, formability, and stability of glass, enhances the rigidity, and improves the thermal expansion characteristics. However, if ZnO is introduced excessively, the heat resistance and chemical durability lower. Thus, the introduction amount of ZnO is controlled to preferably 0 to 3%, more preferably 0 to 2%, still more preferably 0 to 1%, and ZnO may not be introduced substantially.

ZrO₂ is a component that enhances the rigidity and heat resistance of glass as described above, and is also a component that enhances the chemical durability. However, if ZrO₂ is introduced excessively, the meltability of glass lowers. Thus, the introduction amount of ZrO₂ is controlled to preferably 1 to 8%, more preferably 1 to 6%, still more preferably 2 to 6%.

TiO₂ is a component that has functions of suppressing the increase of the specific gravity of glass and improving the rigidity, thereby increasing the specific elastic modulus. Note that, if TiO₂ is introduced excessively, when a glass substrate comes into contact with water, water reaction products occur on the surface of the substrate, leading to a cause for the occurrence of excrescences in some cases. Thus, the introduction amount of TiO₂ is controlled to preferably 0 to 6%, more preferably 0 to 5%, still more preferably 0 to 3%, still more preferably 0 to 2%, still more preferably 0% or more and less than 1%, and TiO₂ may not be introduced substantially.

Y₂O₃, Yb₂O₃, La₂O₃, Gd₂O₃, Nb₂O₅, and Ta₂O₅ are components that are advantageous in terms of improving the chemical durability and heat resistance of glass and improving the rigidity and the fracture toughness. However, if these components are introduced excessively, the meltability deteriorates and the specific gravity increases. Moreover, as expensive materials are used, the content of these components is preferably smaller. Thus, the total introduction amount of the above-mentioned components is controlled to preferably 0 to 3%, more preferably 0 to 2%, still more preferably 0 to 1%, still more preferably 0 to 0.5%, still more preferably 0 to 0.1%, and those components are preferably not introduced substantially when importance is given to improving the meltability, attaining the low specific gravity, and reducing the cost of glass.

HfO₂ is also a component that is advantageous in terms of improving the chemical durability and heat resistance of glass and improving the rigidity and the fracture toughness. However, if HfO₂ is introduced excessively, the meltability deteriorates and the specific gravity increases. Moreover, as an expensive material is used, the content of HfO₂ is preferably smaller, and HfO₂ is preferably not introduced substantially. Pb, As, Cd, Te, Cr, Tl, U, and Th are preferably not introduced substantially in consideration of their influence on the environment.

Further, the molar ratio of the total content of SiO₂, Al₂O₃, ZrO₂, TiO₂, Y₂O₃, La₂O₃, Gd₂O₃, Nb₂O₅, and Ta₂O₅ to the total content of the alkali metal oxides (Li₂O, Na₂O, and K₂O) {(SiO₂+Al₂O₃+ZrO₂+TiO₂+Y₂O₃+La₂O₃+Gd₂O₃+Nb₂O₅+Ta₂O₅)/(Li₂O+Na₂O+K₂O)} is, from the viewpoints of enhancing the heat resistance of glass and enhancing the meltability, preferably in the range of 3 to 15, more preferably 3 to 12, still more preferably 4 to 12, still more preferably 5 to 12, still more preferably 5 to 11, still more preferably 5 to 10.

Next, described below are other components that can be added in common to Glass A and Glass B. First, described are Sn oxides and Ce oxides, which are arbitrary components. The Sn oxides and the Ce oxides are components that can function as a fining agent. The Sn oxides are excellent in promoting fining, because the oxides release oxygen gases at high temperature at the time of melting glass, and capture minute bubbles contained in the glass, forming big bubbles so that the big bubbles easily emerge on the surface of the glass. On the other hand, the Ce oxides are excellent in contributing to removing bubbles by capturing, as a glass component, oxygen existing as a gas in glass at low temperature. The Sn oxides significantly contribute to removing both relatively big bubbles and very small bubbles, with the size of bubbles (size of bubbles (voids) remaining in solidified glass) in the range of 0.3 mm or less. When the Ce oxides are added with the Sn oxides, the density of big bubbles each having a diameter of about 50 μm to about 0.3 mm radically decreases to about one several tenths. As described above, the coexistence of the Sn oxides and the Ce oxides can enhance the effect of fining glass in a broad temperature range from a high temperature region to a low temperature region. Thus, it is preferred that both the Sn oxides and Ce oxides be added.

When the total addition amount of the Sn oxides and the Ce oxides in terms of outer percentage is 0.02 mass % or more, a sufficient fining effect can be expected. When a magnetic recording medium glass substrate is manufactured by using glass containing undissolved substances, even if their sizes are minute and their amount is small, some of the undissolved substances appear on the surface of the magnetic recording medium glass substrate by polishing. As a result, protrusions occur on the surface of the magnetic recording medium glass substrate, or portions at which some of the undissolved substances were removed become dents, impairing the smoothness of the surface of the magnetic recording medium glass substrate, and hence the resultant glass substrate cannot be used as a magnetic recording medium glass substrate. On the other hand, when the total addition amount of the Sn oxides and the Ce oxides in terms of outer percentage is 3.5 mass % or less, the Sn oxides and the Ce oxides can dissolve sufficiently in glass, and hence the contamination of undissolved substances can be prevented.

Further, when crystallized glass is manufactured, Sn and Ce contribute to forming crystal nuclei. Glass A and Glass B are amorphous glass, and hence it is desirable that heating does not cause the precipitation of crystals. When the content of Sn and Ce is excessive, such precipitation of crystals tends to occur easily. Thus, an excessive addition of the Sn oxides and the Ce oxides is required to be avoided. In view of the foregoing, it is preferred that the total addition amount of the Sn oxides and the Ce oxides in terms of outer percentage be controlled to 0.02 to 3.5 mass %. The total addition amount of the Sn oxides and the Ce oxides in terms of outer percentage is preferably in the range of 0.1 to 2.5 mass %, more preferably in the range of 0.1 to 1.5 mass %, still more preferably in the range of 0.5 to 1.5 mass %. It is preferred to use SnO₂ as an Sn oxide from the standpoint that SnO₂ releases oxygen gases effectively at high temperature while glass is melted.

Note that sulfates may be added as a fining agent at a content in the range of 0 to 1 mass % in terms of outer percentage, but a molten substance may boil over while glass is melted, and the amount of foreign matter in glass sharply increases, and hence it is preferred not to introduce the sulfates. Moreover, as Pb, Cd, As, and the like are substances that adversely affect the environment, their introduction is also preferably avoided.

Glass A and Glass B can be manufactured by taking the following steps. That is, glass materials such as oxides, carbonates, nitrates, sulfates, and hydroxides are weighed, blended, and mixed enough, so that a predetermined glass composition is obtained, the resultant mixture is heated, melted, fined, and stirred in a melting vessel at a temperature in the range of, for example, 1,400 to 1,600° C., thereby yielding homogenized molten glass in which bubble removal has been sufficiently performed, and the molten glass is molded into glass. Note that the fining agent described above may be added to the glass materials, if necessary.

Glass A and Glass B are capable of realizing high heat resistance, high rigidity, and a high thermal expansion coefficient at the same time. Hereinafter, favorable physical properties that Glass A and Glass B have are sequentially described.

1. Thermal Expansion Coefficient

As described above, when there is a big difference in thermal expansion coefficient between glass forming a magnetic recording medium glass substrate and a spindle material (such as stainless steel) of HDD, the change of temperature while HDD is in motion causes the deformation of a magnetic recording medium, and, for example, recording and reproducing problems occur, resulting in the reduction of reliability. In particular, a magnetic recording medium having a magnetic recording layer made of a high Ku magnetic material has an extremely high recording density, and hence even slight deformation of the magnetic recording medium is liable to cause the problems. In general, a spindle material of HDD has an average linear expansion coefficient (thermal expansion coefficient) of 70×10⁻⁷/° C. or more in the temperature range of 100 to 300° C. However, when a glass blank is manufactured by the method of manufacturing a glass blank according to an embodiment of the present invention by using Glass A or Glass B, and when a magnetic recording medium glass substrate is manufactured by using the glass blank, it is possible to control their average linear expansion coefficients in the temperature range of 100 to 300° C. to 70×10⁻⁷/° C. or more. Thus, the above-mentioned reliability can be improved, and it is possible to provide a magnetic recording medium glass substrate suitable for a magnetic recording medium having a magnetic recording layer made of a high Ku magnetic material. Note that the average linear expansion coefficient of glass is preferably in the range of 72×10⁻⁷/° C. or more, more preferably in the range of 74×10⁻⁷/° C. or more, still more preferably in the range of 75×10⁻⁷/° C. or more, still more preferably in the range of 77×10⁻⁷/° C. or more, still more preferably in the range of 78×10⁻⁷/° C. or more, still more preferably in the range of 79×10⁻⁷/° C. or more. The upper limit of the average linear expansion coefficient of glass is, in consideration of the thermal expansion characteristics of a spindle material, for example, preferably about 100×10⁻⁷/° C., more preferably about 90×10⁻⁷/° C., still more preferably about 88×10⁻⁷/° C.

2. Glass Transition Temperature

When attempts are made to attain a high recording density in a magnetic recording medium by, for example, introducing a high Ku magnetic material as described previously, a magnetic recording medium glass substrate is exposed to high temperature in, for example, high-temperature treatment of a magnetic material. In this case, a glass material used for the magnetic recording medium glass substrate is required to have excellent heat resistance so that the extremely high flatness of the magnetic recording medium glass substrate is not impaired. Here, when a glass blank is manufactured by the method of manufacturing a glass blank according to an embodiment of the present invention by using Glass A or Glass B, and when a magnetic recording medium glass substrate is manufactured by using the glass blank, it is possible to control the glass transition temperature to 600° C. or more. Thus, even after the above-mentioned magnetic recording medium glass substrate is subjected to heat treatment at high temperature, its excellent flatness can be maintained. Therefore, there can be provided a magnetic recording medium glass substrate suitable for manufacturing a magnetic recording medium including a high Ku magnetic material.

Note that the glass transition temperature of each of Glass A and Glass B is preferably in the range of 610° C. or more, more preferably in the range of 620° C. or more, still more preferably in the range of 630° C. or more, still more preferably in the range of 640° C. or more, still more preferably in the range of 650° C. or more, still more preferably in the range of 655° C. or more, still more preferably in the range of 660° C. or more, still more preferably in the range of 670° C. or more, particularly preferably in the range of 675° C. or more, most preferably in the range of 680° C. or more. The upper limit of the glass transition temperature is, for example, about 750° C., but is not particularly limited.

3. Young's Modulus

Deformation of a magnetic recording medium includes, in addition to deformation caused by the change of temperature in HDD, deformation caused by high-speed rotation. From the standpoint of suppressing the deformation at the time of high-speed rotation, it is desired that the Young's modulus of glass for a magnetic recording medium glass substrate be increased. When Glass A and Glass B are used as that glass, the Young's modulus of that glass can be controlled to 80 GPa or more, deformation of a substrate at the time of high-speed rotation can be suppressed, and data can be read and written correctly in a magnetic recording medium which includes a high Ku magnetic material and in which a high recording density has been attained. The Young's modulus is preferably in the range of 81 GPa or more, more preferably in the range of 82 GPa or more. The upper limit of the Young's modulus is, for example, about 95 GPa, but is not particularly limited.

The above-mentioned thermal expansion coefficient, glass transition temperature, and Young's modulus of glass for a magnetic recording medium glass substrate are all important characteristics that are required for a glass substrate for a magnetic recording medium which includes a high Ku magnetic material and in which high recording density has been attained. Thus, in order to provide a substrate suitable for the above-mentioned magnetic recording medium, it is particularly preferred that glass integrally have all the characteristics of an average linear expansion coefficients of 70×10⁻⁷/° C. or more at 100 to 300° C., a glass transition temperature of 600° C. or more, and a Young's modulus of 80 GPa or more. When Glass A and Glass B are used, there can be provided glass for a magnetic recording medium glass substrate, the glass integrally having all the above-mentioned characteristics.

4. Specific Elastic Modulus and Specific Gravity

In order to provide a substrate which resists deformation when a magnetic recording medium is rotated at a high speed, it is preferred that the specific elastic modulus of glass for a magnetic recording medium glass substrate be controlled to 30 MNm/kg or more. The upper limit of the specific elastic modulus is, for example, about 35 MNm/kg, but is not particularly limited. The specific elastic modulus is a value obtained by dividing the Young's modulus of glass by the density of the glass. Here, the density may be considered to be a value expressed by the specific gravity of glass with units of g/cm³. By attaining the low specific gravity of glass, the specific elastic modulus can be increased, and moreover, the weight of a magnetic recording medium glass substrate can be reduced. The reduction of the weight of the magnetic recording medium glass substrate leads to the reduction of the weight of a magnetic recording medium. As a result, the amount of electricity necessary for rotating the magnetic recording medium decreases, and the power consumption of HDD can be suppressed. The specific gravity of glass for a magnetic recording medium glass substrate is preferably in the range of less than 3.0, more preferably in the range of 2.9 or less, still more preferably in the range of 2.85 or less.

5. Liquidus Temperature

When glass is melted and the resultant molten glass is molded, if the molding temperature of glass is lower than the liquidus temperature, glass is crystallized and homogeneous glass cannot be manufactured. Thus, the molding temperature of glass needs to be controlled to a temperature equal to or more than the liquidus temperature. However, if the molding temperature is more than 1,300° C., for example, the press molds 50 and 60 that are used at the time of press molding the molten glass gob 24 react with the high-temperature molten glass gob 24, and hence the press molds 50 and 60 become liable to be damaged. Further, a fining effect promoted by Sn oxides and Ce oxides is sometimes decreased by the elevation of a fining temperature caused by the elevation of a molding temperature. In consideration of the foregoing, the liquidus temperature is preferably controlled to 1,300° C. or less. The liquidus temperature is more preferably in the range of 1,250° C. or less, still more preferably in the range of 1,200° C. or less. When Glass A and Glass B are used, the liquidus temperatures in the above-mentioned preferred ranges can be realized. The lower limit of the liquidus temperature is not particularly limited, but a standard lower limit may be considered to be 800° C. or more.

6. Spectral Transmittance

A magnetic recording medium is manufactured by going through the step of forming a multi-layer film including a magnetic recording layer on a magnetic recording medium glass substrate. When the multi-layer film is formed on the magnetic recording medium glass substrate by using a single wafer film-forming system, which is a main stream now, for example, the magnetic recording medium glass substrate is first introduced into a substrate-heating area in a film-forming apparatus, and is heated up to a temperature at which film formation can be performed by sputtering or the like. After the temperature of the magnetic recording medium glass substrate is elevated sufficiently, the magnetic recording medium glass substrate is transferred to a first film-forming area, and a film corresponding to the lowermost layer of the multi-layer film is formed on the magnetic recording medium glass substrate. Next, the magnetic recording medium glass substrate is transferred to a second film-forming area, another film is formed on the lowermost layer. In the same manner as described above, the magnetic recording medium glass substrate is sequentially transferred to film-forming areas in the latter stage, and films are formed sequentially, thereby forming the multi-layer film. The above-mentioned heating and film formation are carried out under a reduced pressure atmosphere formed by exhausting air with a vacuum pump or the like, and hence there is no other way but to adopt a noncontact method in order to heat the magnetic recording medium glass substrate. Thus, heating by radiation is suitable for heating the magnetic recording medium glass substrate. The film formation must be performed before the temperature of the magnetic recording medium glass substrate does not drop below the temperature suitable for the film formation. If the time required for forming each layer is too long, the temperature of the heated magnetic recording medium glass substrate lowers, and as a result, there occurs the problem that sufficiently high substrate temperature cannot be maintained in the film-forming areas in the latter stage. In order to maintain the temperature of the magnetic recording medium glass substrate for a long time at a temperature at which film formation can be performed, it may be a good idea to heat the magnetic recording medium glass substrate to a higher temperature. However, if the speed at which the magnetic recording medium glass substrate is heated is small, the heating time must be longer, and the time during which the substrate resides in the heating area also must be longer. Thus, the resident time of the magnetic recording medium glass substrate in each film-forming area also becomes longer, and sufficiently high substrate temperature cannot be maintained in the film-forming areas in the latter stage. Moreover, it becomes difficult to improve throughput. In particular, when a magnetic recording medium including a magnetic recording layer formed of a high Ku magnetic material is manufactured, the magnetic recording medium glass substrate is heated to high temperature in a predetermined time, and hence efficiency of heating by irradiation of the magnetic recording medium glass substrate should be further enhanced.

Glass including SiO₂ and Al₂O₃ has its absorption peak in the region including the wavelengths of from 2,750 to 3,700 nm. Further, when the infrared ray absorber described below is added or is introduced as a glass component, the absorption of radiation having shorter wavelengths can be further enhanced, and hence the glass can absorb light in the wavelength region of from 700 nm to 3,700 nm. In order to heat efficiently the magnetic recording medium glass substrate by radiation, that is, by infrared ray irradiation, it is desired to use infrared rays having the maximum value of its spectrum in the above-mentioned wavelength region. In order to increase the heating speed, it is conceivable that the maximum wavelength of an infrared ray spectrum and the absorption peak wavelength of a substrate are matched and the power of the infrared rays is increased. Taking a carbon heater in a high-temperature state for example as an infrared ray source, it is recommended to increase the input of the carbon heater in order to increase the power of infrared rays. However, if the radiation from the carbon heater is black-body radiation, the increase of the input causes the elevation of the temperature of the heater, and hence the maximum wavelength of an infrared ray spectrum shifts to the short-wavelength side, and eventually exists out of the above-mentioned absorption wavelength region of the glass. Thus, in order to increase the speed at which the magnetic recording medium glass substrate is heated, the power consumption of the heater must be raised to an excessive level, and as a result, there occurs a problem such as a shorter lifetime of the heater.

In consideration of the foregoing, it is desirable that the absorption, by glass, of light in the above-mentioned wavelength region (wavelengths of from 700 to 3,700 nm) be improved, to thereby create a state in which the maximum wavelength of an infrared ray spectrum and the absorption peak wavelength of a substrate are closer, and infrared rays be applied under the state while excessive heater input is avoided. Then, in order to enhance the efficiency of heating by infrared ray radiation, preferred as glass for a magnetic recording medium glass substrate is glass which has such transmittance characteristic that a region in which the spectral transmittance of glass in terms of a thickness of 2 mm is 50% or less exists in the wavelength region of from 700 to 3,700 nm, or glass which has the transmittance characteristic that the spectral transmittance in terms of a thickness of 2 mm is 70% or less throughout the wavelength region. For example, an oxide of at least one kind of metal selected from iron, copper, cobalt, ytterbium, manganese, neodymium, praseodymium, niobium, cerium, vanadium, chromium, nickel, molybdenum, holmium, and erbium can act as an infrared ray absorber. In addition, water or an OH group included in water exhibits strong absorption in a 3 μm band, and hence water can also act as an infrared ray absorber. The above-mentioned preferred absorption characteristics can be imparted to Glass A and Glass B by introducing a proper amount of the above-mentioned component that can act as an infrared ray absorber to Glass A and Glass B. The addition amount of the above-mentioned oxide that can act as one of infrared ray absorbers is, based on mass of oxides, preferably in the range of 500 ppm to 5%, more preferably 2,000 ppm to 5%, still more preferably 2,000 ppm to 2%, still more preferably 4,000 ppm to 2%. Further, the content of water is, in terms of H₂O based on weight, preferably more than 200 ppm, more preferably 220 ppm or more.

Note that, when Yb₂O₂ and Nb₂O₅ are introduced as glass components or when Ce oxides are added as a fining agent, absorption of infrared rays carried out by these components can be taken advantage of for improving the efficiency of heating a substrate.

[Method of Manufacturing Magnetic Recording Medium Glass Substrate]

The method of manufacturing a magnetic recording medium glass substrate according to an embodiment of the present invention is characterized in that a magnetic recording medium glass substrate is manufactured by at least going through a polishing step of polishing the main surface of a glass blank manufactured by the method of manufacturing a glass blank for a magnetic recording medium glass substrate according to the present invention.

Note that the phrase “magnetic recording medium glass substrate” herein preferably means a substrate made of noncrystalline glass, that is, a substrate made of amorphous glass. Glass-based substrates are roughly classified into a noncrystalline glass substrate and a crystallized glass substrate manufactured by crystallizing noncrystalline glass with heat treatment. Heat treatment for crystallization is, in general, carried out at a temperature higher than the glass transition temperature, and hence, even if a glass blank having a good flatness or having a small thickness deviation is used, glass is deformed by heat treatment for crystallization and the significance of using a glass blank diminishes or is lost. If a noncrystalline glass substrate is manufactured, a glass blank is not required to be treated at high temperature. Therefore, it can be concluded that it is significant to use the glass blank having a good flatness or having a small thickness deviation at the time of manufacturing a magnetic recording medium glass substrate.

When the magnetic recording medium glass substrate is produced, first, scribing is performed on a glass blank obtained by carrying out the press molding. The scribing refers to providing cutting lines (line-like flaws) like two concentric circles (an inner concentric circle and an outer concentric circle) with a scriber made of cemented carbide or formed of diamond particles on a surface of a molded glass blank, in order to process the molded glass blank into a ring shape having a predetermined size. Note that a shear mark remaining in the glass blank is localized inside the inner concentric circle. The glass blank having scribed thereon the two concentric circles is partially heated, and the outside portion of the outer concentric circle and the inside portion of the inner concentric circle are removed by virtue of the difference in thermal expansion of glass, thereby yielding a disk-shaped glass having a perfect circle shape.

When scribe processing is carried out, if the roughness of the main surface of the glass blank is 1 μm or less, cutting lines can be suitably provided by using a scriber. Note that, in the case where the roughness of the main surface of the glass blank exceeds 1 μm, a scriber does not follow the irregularities of the surface and it may become difficult to provide cutting lines uniformly. In this case, after the main surface of the glass blank is made smooth, scribing is performed.

Next, the scribed glass undergoes shape processing. The shape processing includes chamfering (chamfering of an outer peripheral end portion and an inner peripheral end portion). In the chamfering, the outer peripheral end portion and inner peripheral end portion of the ring-shaped glass are chamfered with a diamond grinding stone.

Next, the disk-shaped glass undergoes end surface polishing. In the end surface polishing, the inner peripheral side end surface and outer peripheral side end surface of the glass undergo mirror finish by brush polishing. In this case, there is used a slurry including fine particles of cerium oxide or the like as free abrasive grains. The end surface polishing removes contamination caused by attachment of dust or the like and impair such as damage or flaws on or in the end surfaces of the glass. As a result, precipitation of ions of sodium, potassium, and the like causing corrosion can be prevented from occurring.

Next, first polishing is carried out on the main surfaces of the disk-shaped glass. The purpose of the first polishing is to remove flaws and strain remaining in the main surfaces. A machining allowance removed by the first polishing is, for example, several μm to about 10 μm. As a grinding step involving a large amount of a machining allowance is not required to be performed, flaws, strain, and the like, which are caused by the grinding step, are not generated in the glass. Thus, the first polishing step involves a small amount of a machining allowance.

In the first polishing step and the second polishing step described below, a double-side polishing apparatus is used. The double-side polishing apparatus is an apparatus for carrying out polishing with polishing pads by relatively moving a disk-shaped glass and the polishing pads. The double-side polishing apparatus includes a polishing carrier fitting portion having an internal gear and a sun gear which are each rotationally driven at a predetermined rotation rate and also includes an upper surface plate and a lower surface plate which are rotationally driven in opposite directions to each other with the polishing carrier fitting portion being sandwiched by both the plates. On each surface facing a disk-shaped glass of the upper surface plate and lower surface plate, the polishing pads described below are attached. Each polishing carrier fitted so as to be engaged with each of the internal gear and the sun gear performs a planetary gear motion, that is, revolves around the sun gear while spinning.

The each polishing carrier holds a plurality of disk-shaped glasses. The upper surface plate is movable in the vertical direction and presses each polishing pad onto the front and back main surfaces of each disk-shaped glass. Then, while a slurry (polishing liquid) containing polishing abrasive grains (polishing material) is being supplied, the disk-shaped glass and the polishing pad move relatively owning to the planetary gear motion of the polishing carrier and the phenomenon that the upper surface plate and the lower surface plate rotate in opposite directions to each other. As a result, the front and back main surfaces of each disk-shaped glass is polished. Note that, in the first polishing step, a hard resin polisher, for example, is used as the polishing pad and cerium oxide abrasive grains, for example, are used as the polishing material.

Next, the disk-shaped glass after the first polishing is subjected to chemical strengthening. It is possible to use a molten salt of potassium nitrate or the like as a chemical strengthening solution. In the chemical strengthening, the chemical strengthening solution is heated to, for example, 300° C. to 400° C., and a cleaned glass is pre-heated to, for example, 200° C. to 300° C. and then immersed in the chemical strengthening solution for, for example, 3 hours to 4 hours. The immersion is preferably performed under a state in which a plurality of glasses are contained in a holder so as to be held by their end surfaces so that both main surfaces of each of the glasses entirely undergo chemical strengthening.

Each glass is immersed in the chemical strengthening solution, as described above, and as a result, sodium ions in the surface layers of the glass are substituted by potassium ions each having a relatively large ion radius in the chemical strengthening solution, respectively, forming a compressive stress layer with a thickness of about 50 to 200 μm. Thus, the glass is strengthened and is provided with good impact resistance. Note that the glass having undergone chemical strengthening treatment is cleaned. For example, the glass is cleaned with sulfuric acid and then cleaned with pure water, isopropyl alcohol (IPA), or the like.

Next, the glass which has undergone chemical strengthening and has been cleaned sufficiently is subjected to second polishing. A machining allowance removed by the second polishing is, for example, about 1 μm.

The purpose of the second polishing is to finish the main surfaces like mirror surfaces. In the second polishing step, the disk-shaped glass is polished by using a double-side polishing apparatus as in the first polishing step, but the composition of polishing abrasive grains contained in a polishing liquid (slurry) to be used and the composition of a polishing pad are different from those in the first one. In the second polishing step, there are used polishing abrasive grains each having a smaller diameter and a softer polishing pad compared with those in the first polishing step. For example, in the second polishing step, a soft foamed resin polisher, for example, is used as the polishing pad, and finer cerium oxide abrasive grains than the cerium oxide abrasive grains used in the first polishing step are, for example, used as the polishing material.

The disk-shaped glass polished in the second polishing step is again cleaned. In the cleaning, a neutral detergent, pure water, or IPA is used. The second polishing yields a glass substrate for a magnetic disk having a flatness in main surface of 4 lam or less and a roughness in main surface of 0.2 nm or less. After that, various layers such as a magnetic layer are formed on the glass substrate for a magnetic disk, and a magnetic disk is manufactured.

Note that the chemical strengthening step is carried out between the first polishing step and the second polishing step, and the order of these steps is not limited to this order. As long as the second polishing step is carried out after the first polishing step, the chemical strengthening step can be arbitrarily arranged. For example, the order of the first polishing step, the second polishing step, and the chemical strengthening step (hereinafter, referred to as “routing 1” may be adopted. Note that if the routing 1 is adopted, surface irregularities that may be produced by the chemical strengthening step are not removed, and hence more preferred is the routing of the first polishing step, the chemical strengthening step, and the second polishing step.

[Method of Manufacturing Magnetic Recording Medium]

A method of manufacturing a magnetic recording medium according to an embodiment of the present invention is characterized in that a magnetic recording medium is produced by at least going through a magnetic recording layer-forming step of forming a magnetic recording layer on a magnetic recording medium glass substrate manufactured by the method of manufacturing a magnetic recording medium glass substrate according to the present invention.

A magnetic recording medium is also called, for example, a magnetic disk or a hard disk, and is suitable for internal storages (such as fixed disks) for desk top computers, server computers, notebook computers, mobile computers, and the like, internal storages for portable recording and reproducing devices used for recording and reproducing images and/or sounds, recording and reproducing devices for in-car audio systems, and the like.

The magnetic recording medium has, for example, a configuration in which at least an adherent layer, an undercoat layer, a magnetic layer (magnetic recording layer), a protective layer, and a lubricant layer are laminated on the main surface of a substrate sequentially, starting from the layer close the main surface. For example, a magnetic recording medium glass substrate is introduced into a film-forming apparatus in which pressure is reduced, and each layer from the adherent layer to the magnetic layer is sequentially formed on the main surface of the magnetic recording medium glass substrate in an Ar atmosphere by using a DC magnetron sputtering method. There can be used, for example, CrTi as the adherent layer, and, for example, CrRu as the undercoat layer. After the above-mentioned film formation, the protective layer is formed with C₂H₄ by using, for example, a CVD method, and then, nitriding treatment including introducing nitrogen into the surface is carried out in the same chamber, thereby being able to form the magnetic recording medium. After that, for example, polyfluoropolyether (PFPE) is applied on the protective layer by a dip coating method, thereby being able to form the lubricant layer.

As described previously, it is preferred to form a magnetic recording layer from a high Ku magnetic material for the purpose of attaining higher density recording in a magnetic recording media. Exemplified as a preferred magnetic material in view of the foregoing are an Fe—Pt-based magnetic material and a Co—Pt-based magnetic material. Note that the term “-based” herein means “including.” That is, the magnetic recording medium obtained by the method of manufacturing a magnetic recording medium according to an embodiment of the present invention preferably has a magnetic recording layer including Fe and Pt, or Co and Pt, as a magnetic recording layer. Although the film-forming temperature of a magnetic material which has been widely used conventionally, such as a Co—Cr-based magnetic material, is about 250 to 300° C., the film-forming temperature of each of the Fe—Pt-based magnetic material and the Co—Pt-based magnetic material is generally as high a temperature as more than 500° C. Further, those magnetic materials are generally subjected to high-temperature heat treatment (annealing) at a temperature exceeding each of their film-forming temperatures after film formation so that the magnetic materials have crystal orientation property. Thus, when a magnetic recording layer is formed by using the Fe—Pt-based magnetic material or the Co—Pt-based magnetic material, a magnetic recording medium glass substrate is exposed to the above-mentioned high temperature. In this case, if glass forming the magnetic recording medium glass substrate has poor heat resistance, the glass substrate deforms and its flatness is impaired. In contrast, the magnetic recording medium glass substrate forming the magnetic recording medium obtained by the method of manufacturing a magnetic recording medium according to an embodiment of the present invention has excellent heat resistance. Thus, the magnetic recording medium glass substrate can maintain its high flatness even after the magnetic recording layer is formed by using the Fe—Pt-based magnetic material or the Co—Pt-based magnetic material. The above-mentioned magnetic recording layer can be formed by, for example, forming the Fe—Pt-based magnetic material or the Co—Pt-based magnetic material into a film in an Ar atmosphere by using a DC magnetron sputtering method, and then performing heat treatment at a higher temperature in a heating furnace.

By the way, a magnetocrystalline anisotropy energy constant (Ku) is in proportion to a magnetic coercive force Hc. The magnetic coercive force He represents the strength of a magnetic field causing magnetization reversal. As described previously, because a high Ku magnetic material has resistance to thermal fluctuation, the degradation of a magnetized region caused by thermal fluctuation is unlikely to occur even if its magnetic particles are microparticulated, and hence the high Ku magnetic material is known as a material suitable for attaining high density recording. However, Ku and Hc have a proportional relationship to each other as described above, and hence, as Ku increases, Hc also increases, that is, magnetization reversal caused by a magnetic head is unlikely to occur and writing information becomes difficult. Accordingly, attention has been paid in recent years to a recording method in which, when information is written by a recording magnetic head, the magnetic head instantly applies energy to a data-writing area to decrease a magnetic coercive force, thereby assisting the magnetization reversal of a high Ku magnetic material. Such recording method is called an energy-assisted recording method. In particular, a recording method in which magnetization reversal is assisted by irradiation of laser light is called a heat-assisted recording method, and a recording method in which magnetization reversal is assisted by irradiation of a microwave is called a microwave-assisted recording method. As described previously, it becomes possible to form a magnetic recording layer by using a high Ku magnetic material according to the method of manufacturing a magnetic recording medium according to an embodiment of the present invention. Thus, by combining the high Ku magnetic material and the energy-assisted recording, it is possible to realize high density recording at, for example, a surface recording density of more than one terabyte/square inches. Note that the heat-assisted recording method is described in detail in, for example, IEEE TRANSACTIONS ON MAGNETICS, VOL. 44, No. 1, January 2008 119, and the microwave-assisted recording method is described in detail in, for example, IEEE TRANSACTIONS ON MAGNETICS, VOL. 44, No. 1, January 2008 125, respectively. The energy-assisted recording can be performed according to any of those methods described in the literature in the method of producing a magnetic recording medium according to an embodiment of the present invention as well.

The dimensions of the magnetic recording medium glass substrate (such as magnetic disk substrate) and the dimensions of the magnetic recording medium (such as magnetic disk) are not particularly limited. However, because high density recording can be attained, the medium and the substrate can be downsized. For example, the substrate and the medium are suitable as a magnetic disk substrate and a magnetic disk, respectively, each having a nominal diameter of 2.5 inches and moreover, are suitable as those each having a smaller diameter (such as 1 inch).

### EXAMPLES

Hereinafter, the present invention is described in more detail based on examples, but the present invention is not limited to the following examples.

<Glass Composition and Physical Properties>

Materials such as oxides, carbonates, nitrates, and hydroxides were weighed and mixed enough, yielding each blended material, so that glasses No. 1 to 13 listed in Tables 1 to 5 are obtained. Each blended material was fed into a melting tank in a glass melting furnace, was heated, and was melt. The resultant molten glass was transferred from the melting tank to a fining tank, and bubbles were removed in the fining tank. Further, the molten glass was transferred to an operation tank, was stirred and homogenized in the operation tank, and was caused to flow out from a glass effluent pipe provided in the bottom portion of the operation tank. The melting tank, the fining tank, the operation tank, and the glass effluent pipe were each under temperature control, and in each step, the temperature and viscosity of the glass were each kept in an optimal state. The molten glass flowing out from the glass effluent pipe was cast into a mold and molded into glass. The resultant glass was used as a sample to measure its characteristics described below. A method of measuring the respective characteristics mentioned below.

### (1) Glass Transition Temperature Tg, Thermal Expansion Coefficient

The glass transition temperature Tg and the average linear expansion coefficient α at 100 to 300° C. of each glass were measured by using a thermomechanical analyzer (TMA).

### (2) Young's Modulus

The Young's modulus of each glass was measured by an ultrasonic method.

### (3) Specific Gravity

The specific gravity of each glass was measured by an Archimedean method.

### (4) Specific Elastic Modulus

The specific elastic modulus of each glass was calculated based on the above-mentioned Young's modulus obtained in the item (2) and the above-mentioned specific gravity obtained in the item (3).

### (5) Liquidus Temperature

A glass sample was put in a platinum crucible and kept at a predetermined temperature for 2 hours. After being taken out from the furnace, the glass sample was cooled and the presence or absence of crystal precipitation was observed with a microscope. The lowest temperature at which crystals were not observed was defined as a liquidus temperature (L.T.).

Tables 1 to 7 show the composition and characteristics of each glass.

TABLE 1

| | | No. 1 | | No. 2 | | No. 3 | |
|---|---|---|---|---|---|---|---|
| | | mol % | mass % | mol % | mass % | mol % | mass % |
| Composition | SiO₂ | 66.2 | 62.4 | 62.0 | 59.8 | 65.4 | 61.2 |
| | Al₂O₃ | 0.5 | 0.8 | 0.4 | 0.7 | 0.4 | 0.6 |
| | B₂O₃ | 0.0 | 0.0 | 0.0 | 0.0 | 0.0 | 0.0 |
| | Li₂O | 0.0 | 0.0 | 0.0 | 0.0 | 0.0 | 0.0 |
| | Na₂O | 3.3 | 3.2 | 3.2 | 3.2 | 3.3 | 3.2 |
| | K₂O | 6.2 | 9.2 | 4.4 | 6.6 | 6.2 | 9.1 |
| | Cs₂O | 0.0 | 0.0 | 0.0 | 0.0 | 0.0 | 0.0 |
| | MgO | 6.5 | 4.1 | 9.6 | 6.2 | 6.5 | 4.1 |
| | CaO | 12.5 | 11.0 | 15.6 | 14.0 | 12.5 | 10.9 |
| | SrO | 0.0 | 0.0 | 0.0 | 0.0 | 0.0 | 0.0 |
| | BaO | 0.0 | 0.0 | 0.0 | 0.0 | 0.0 | 0.0 |
| | ZnO | 0.0 | 0.0 | 0.0 | 0.0 | 0.0 | 0.0 |
| | ZrO₂ | 4.8 | 9.3 | 4.8 | 9.5 | 5.7 | 10.9 |
| | TiO₂ | 0.0 | 0.0 | 0.0 | 0.0 | 0.0 | 0.0 |
| | La₂O₃ | 0.0 | 0.0 | 0.0 | 0.0 | 0.0 | 0.0 |
| | Y₂O₃ | 0.0 | 0.0 | 0.0 | 0.0 | 0.0 | 0.0 |
| | Yb₂O₃ | 0.0 | 0.0 | 0.0 | 0.0 | 0.0 | 0.0 |
| | Ta₂O₅ | 0.0 | 0.0 | 0.0 | 0.0 | 0.0 | 0.0 |
| | Nb₂O₅ | 0.0 | 0.0 | 0.0 | 0.0 | 0.0 | 0.0 |
| | HfO₂ | 0.0 | 0.0 | 0.0 | 0.0 | 0.0 | 0.0 |
| | Total | 100.0 | 100.0 | 100.0 | 100.0 | 100.0 | 100.0 |
| | SiO₂ + Al₂O₃ + B₂O₃ | 66.7 | 63.2 | 62.4 | 60.5 | 65.8 | 61.8 |
| | Li₂O + Na₂O + K₂O + Cs₂O | 9.5 | 12.4 | 7.6 | 9.8 | 9.5 | 12.3 |
| | Na₂O + K₂O | 9.5 | 12.4 | 7.6 | 9.8 | 9.5 | 12.3 |
| | (Na₂O + K₂O)/(Li₂O + Na₂O + | 1.0 | 1.0 | 1.0 | 1.0 | 1.0 | 1.0 |
| | K₂O + Cs₂O) | | | | | | |
| | MgO + CaO + SrO + BaO | 19.0 | 15.1 | 25.2 | 20.2 | 19.0 | 15.0 |
| | MgO + CaO | 19.0 | 15.1 | 25.2 | 20.2 | 19.0 | 15.0 |
| | SrO + BaO | 0.0 | 0.0 | 0.0 | 0.0 | 0.0 | 0.0 |
| | (MgO + CaO)/(MgO + CaO + | 1.0 | 1.0 | 1.0 | 1.0 | 1.0 | 1.0 |
| | SrO + BaO) | | | | | | |
| | Al₂O₃/(MgO + CaO) | 0.026 | 0.065 | 0.016 | 0.071 | 0.021 | 0.049 |
| | Al₂O₃/CaO | 0.040 | 0.073 | 0.026 | 0.050 | 0.032 | 0.055 |
| | AₘOₙ | 4.8 | 9.3 | 4.8 | 9.5 | 5.7 | 10.9 |
| | ZrO₂/AₘOₙ | 1.0 | 1.0 | 1.0 | 1.0 | 1.0 | 1.0 |

(Note)
AₘOₙ means the total content of ZrO₂, TiO₂, La₂O₃, Y₂O₃, Yb₂O₃, Ta₂O₅, Nb₂O₅, and HfO₂.

TABLE 2

| | | No. 4 | | No. 5 | | No. 6 | |
|---|---|---|---|---|---|---|---|
| | | mol % | mass % | mol % | mass % | mol % | mass % |
| Composition | SiO₂ | 60.2 | 59.4 | 64.8 | 60.8 | 63.6 | 59.5 |
| | Al₂O₃ | 0.4 | 0.7 | 0.4 | 0.7 | 0.4 | 0.7 |
| | B₂O₃ | 0.0 | 0.0 | 0.0 | 0.0 | 0.0 | 0.0 |
| | Li₂O | 0.0 | 0.0 | 0.0 | 0.0 | 0.0 | 0.0 |
| | Na₂O | 3.2 | 3.3 | 1.1 | 1.1 | 4.3 | 4.1 |
| | K₂O | 3.3 | 5.1 | 7.8 | 11.4 | 1.1 | 1.6 |
| | Cs₂O | 0.0 | 0.0 | 0.0 | 0.0 | 1.1 | 4.7 |
| | MgO | 11.7 | 7.8 | 7.5 | 4.8 | 5.2 | 3.3 |
| | CaO | 17.5 | 16.2 | 13.6 | 11.9 | 19.6 | 17.1 |
| | SrO | 0.0 | 0.0 | 0.0 | 0.0 | 0.0 | 0.0 |
| | BaO | 0.0 | 0.0 | 0.0 | 0.0 | 0.0 | 0.0 |
| | ZnO | 0.0 | 0.0 | 0.0 | 0.0 | 0.0 | 0.0 |
| | ZrO₂ | 3.7 | 7.5 | 4.8 | 9.3 | 4.7 | 9.0 |
| | TiO₂ | 0.0 | 0.0 | 0.0 | 0.0 | 0.0 | 0.0 |
| | La₂O₃ | 0.0 | 0.0 | 0.0 | 0.0 | 0.0 | 0.0 |
| | Y₂O₃ | 0.0 | 0.0 | 0.0 | 0.0 | 0.0 | 0.0 |
| | Yb₂O₃ | 0.0 | 0.0 | 0.0 | 0.0 | 0.0 | 0.0 |
| | Ta₂O₅ | 0.0 | 0.0 | 0.0 | 0.0 | 0.0 | 0.0 |
| | Nb₂O₅ | 0.0 | 0.0 | 0.0 | 0.0 | 0.0 | 0.0 |
| | HfO₂ | 0.0 | 0.0 | 0.0 | 0.0 | 0.0 | 0.0 |
| | Total | 100.0 | 100.0 | 100.0 | 100.0 | 100.0 | 100.0 |
| | SiO₂ + Al₂O₃ + B₂O₃ | 60.6 | 60.1 | 65.2 | 61.5 | 64.0 | 60.2 |
| | Li₂O + Na₂O + K₂O + Cs₂O | 6.5 | 8.4 | 8.9 | 12.5 | 6.5 | 10.4 |
| | Na₂O + K₂O | 6.5 | 8.4 | 8.9 | 12.5 | 5.4 | 5.7 |
| | (Na₂O + K₂O)/(Li₂O + Na₂O + | 1.0 | 1.0 | 1.0 | 1.0 | 0.8 | 0.5 |
| | K₂O + Cs₂O) | | | | | | |
| | MgO + CaO + SrO + BaO | 29.2 | 24.0 | 21.1 | 16.7 | 24.8 | 20.4 |
| | MgO + CaO | 29.2 | 24.0 | 21.1 | 16.7 | 24.8 | 20.4 |
| | SrO + BaO | 0.0 | 0.0 | 0.0 | 0.0 | 0.0 | 0.0 |
| | (MgO + CaO)/(MgO + CaO + | 1.0 | 1.0 | 1.0 | 1.0 | 1.0 | 1.0 |
| | SrO + BaO) | | | | | | |
| | Al₂O₃/(MgO + CaO) | 0.014 | 0.083 | 0.019 | 0.056 | 0.016 | 0.123 |
| | Al₂O₃/CaO | 0.023 | 0.043 | 0.029 | 0.059 | 0.020 | 0.041 |
| | AₘOₙ | 3.7 | 7.5 | 4.8 | 9.3 | 4.7 | 9.0 |
| | ZrO₂/AₘOₙ | 1.0 | 1.0 | 1.0 | 1.0 | 1.0 | 1.0 |

(Note)
AₘOₙ means the total content of ZrO₂, TiO₂, La₂O₃, Y₂O₃, Yb₂O₃, Ta₂O₅, Nb₂O₅, and HfO₂.

TABLE 3

| | | No. 7 | | No. 8 | | No. 9 | |
|---|---|---|---|---|---|---|---|
| | | mol % | mass % | mol % | mass % | mol % | mass % |
| Composition | SiO₂ | 57.6 | 55.9 | 65.5 | 61.8 | 65.9 | 62.0 |
| | Al₂O₃ | 2.1 | 3.5 | 0.4 | 0.6 | 0.9 | 1.4 |
| | B₂O₃ | 0.0 | 0.0 | 0.0 | 0.0 | 0.0 | 0.0 |
| | Li₂O | 0.0 | 0.0 | 0.0 | 0.0 | 0.0 | 0.0 |
| | Na₂O | 3.2 | 3.2 | 4.4 | 4.3 | 3.3 | 3.2 |
| | K₂O | 2.8 | 4.3 | 6.1 | 9.0 | 6.1 | 9.0 |
| | Cs₂O | 0.0 | 0.0 | 0.0 | 0.0 | 0.0 | 0.0 |
| | MgO | 11.8 | 7.7 | 6.4 | 4.1 | 6.5 | 4.1 |
| | CaO | 17.7 | 16.0 | 12.4 | 10.9 | 12.5 | 11.0 |
| | SrO | 0.0 | 0.0 | 0.0 | 0.0 | 0.0 | 0.0 |
| | BaO | 0.0 | 0.0 | 0.0 | 0.0 | 0.0 | 0.0 |
| | ZnO | 0.0 | 0.0 | 0.0 | 0.0 | 0.0 | 0.0 |
| | ZrO₂ | 4.8 | 9.5 | 4.8 | 9.3 | 4.8 | 9.3 |
| | TiO₂ | 0.0 | 0.0 | 0.0 | 0.0 | 0.0 | 0.0 |
| | La₂O₃ | 0.0 | 0.0 | 0.0 | 0.0 | 0.0 | 0.0 |
| | Y₂O₃ | 0.0 | 0.0 | 0.0 | 0.0 | 0.0 | 0.0 |
| | Yb₂O₃ | 0.0 | 0.0 | 0.0 | 0.0 | 0.0 | 0.0 |
| | Ta₂O₅ | 0.0 | 0.0 | 0.0 | 0.0 | 0.0 | 0.0 |
| | Nb₂O₅ | 0.0 | 0.0 | 0.0 | 0.0 | 0.0 | 0.0 |
| | HfO₂ | 0.0 | 0.0 | 0.0 | 0.0 | 0.0 | 0.0 |
| | Total | 100.0 | 100.1 | 100.0 | 100.0 | 100.0 | 100.0 |
| | SiO₂ + Al₂O₃ + B₂O₃ | 59.7 | 59.4 | 65.9 | 62.4 | 66.8 | 63.4 |
| | Li₂O + Na₂O + K₂O + Cs₂O | 6.0 | 7.5 | 10.5 | 13.3 | 9.4 | 12.2 |
| | Na₂O + K₂O | 6.0 | 7.5 | 10.5 | 13.3 | 9.4 | 12.2 |
| | (Na₂O + K₂O)/(Li₂O + Na₂O + | 1.0 | 1.0 | 1.0 | 1.0 | 1.0 | 1.0 |
| | K₂O + Cs₂O) | | | | | | |
| | MgO + CaO + SrO + BaO | 29.5 | 23.7 | 18.8 | 15.0 | 19.0 | 15.1 |
| | MgO + CaO | 29.5 | 23.7 | 18.8 | 15.0 | 19.0 | 15.1 |
| | SrO + BaO | 0.0 | 0.0 | 0.0 | 0.0 | 0.0 | 0.0 |
| | (MgO + CaO)/(MgO + CaO + | 1.0 | 1.0 | 1.0 | 1.0 | 1.0 | 1.0 |
| | SrO + BaO) | | | | | | |
| | Al₂O₃/(MgO + CaO) | 0.071 | 0.467 | 0.021 | 0.048 | 0.047 | 0.115 |
| | Al₂O₃/CaO | 0.119 | 0.219 | 0.032 | 0.059 | 0.072 | 0.127 |
| | AₘOₙ | 4.8 | 9.5 | 4.8 | 9.3 | 4.8 | 9.3 |
| | ZrO₂/AₘOₙ | 1.0 | 1.0 | 1.0 | 1.0 | 1.0 | 1.0 |

(Note)
AₘOₙ means the total content of ZrO₂, TiO₂, La₂O₃, Y₂O₃, Yb₂O₃, Ta₂O₅, Nb₂O₅, and HfO₂.

TABLE 4

| | | No. 10 | | No. 11 | |
|---|---|---|---|---|---|
| | | mol % | mass % | mol % | mass % |
| Composi- | SiO₂ | 64.0 | 57.7 | 63.0 | 54.8 |
| tion | Al₂O₃ | 4.0 | 6.1 | 4.0 | 5.9 |
| | B₂O₃ | 0.0 | 0.0 | 0.0 | 0.0 |
| | Li₂O | 1.0 | 0.4 | 0.0 | 0.0 |
| | Na₂O | 6.5 | 6.0 | 4.0 | 3.6 |
| | K₂O | 1.5 | 2.1 | 5.0 | 6.8 |
| | Cs₂O | 0.0 | 0.0 | 0.0 | 0.0 |
| | MgO | 0.0 | 0.0 | 0.0 | 0.0 |
| | CaO | 16.0 | 13.4 | 13.0 | 10.5 |
| | SrO | 0.0 | 0.0 | 0.0 | 0.0 |
| | BaO | 3.0 | 6.9 | 3.0 | 6.6 |
| | ZnO | 0.0 | 0.0 | 0.0 | 0.0 |
| | ZrO₂ | 4.0 | 7.4 | 4.0 | 7.2 |
| | TiO₂ | 0.0 | 0.0 | 4.0 | 4.6 |
| | La₂O₃ | 0.0 | 0.0 | 0.0 | 0.0 |
| | Y₂O₃ | 0.0 | 0.0 | 0.0 | 0.0 |
| | Yb₂O₃ | 0.0 | 0.0 | 0.0 | 0.0 |
| | Ta₂O₅ | 0.0 | 0.0 | 0.0 | 0.0 |
| | Nb₂O₅ | 0.0 | 0.0 | 0.0 | 0.0 |
| | HfO₂ | 0.0 | 0.0 | 0.0 | 0.0 |
| | Total | 100.0 | 100.0 | 100.0 | 100.0 |
| | SiO₂ + Al₂O₃ + B₂O₃ | 68.0 | 63.8 | 67.0 | 60.7 |
| | Li₂O + Na₂O + | 9.0 | 8.5 | 9.0 | 10.4 |
| | K₂O + Cs₂O | | | | |
| | Na₂O + K₂O | 8.0 | 8.1 | 9.0 | 10.4 |
| | (Na₂O + K₂O)/ | 0.9 | 1.0 | 1.0 | 1.0 |
| | (Li₂O + Na₂O + | | | | |
| | K₂O + Cs₂O) | | | | |
| | MgO + CaO + SrO + | 19.0 | 20.3 | 16.0 | 17.1 |
| | BaO | | | | |
| | MgO + CaO | 16.0 | 13.4 | 13.0 | 10.5 |
| | SrO + BaO | 3.0 | 6.9 | 3.0 | 6.6 |
| | (MgO + CaO)/(MgO + | 1.0 | 1.0 | 1.0 | 1.0 |
| | CaO + SrO + BaO) | | | | |
| | Al₂O₃/(MgO + CaO) | 0.250 | 0.753 | 0.308 | 0.567 |
| | Al₂O₃/CaO | 0.250 | 0.455 | 0.308 | 0.562 |
| | AₘOₙ | 4.0 | 7.4 | 8.0 | 11.8 |
| | ZrO₂/AₘOₙ | 1.0 | 1.0 | 0.5 | 0.6 |

(Note)
AₘOₙ means the total content of ZrO₂, TiO₂, La₂O₃, Y₂O₃, Yb₂O₃, Ta₂O₅, Nb₂O₅, and HfO₂.

TABLE 5

| | | No. 12 | | No. 13 | |
|---|---|---|---|---|---|
| | | mol % | mass % | mol % | mass % |
| Composi- | SiO₂ | 66.6 | 64.0 | 60.6 | 60.5 |
| tion | Al₂O₃ | 6.3 | 10.3 | 9.3 | 15.7 |
| | B₂O₃ | 0.0 | 0.0 | 1.0 | 1.2 |
| | Li₂O | 0.0 | 0.0 | 9.5 | 4.7 |
| | Na₂O | 14.4 | 14.3 | 1.7 | 1.7 |
| | K₂O | 0.0 | 0.0 | 1.1 | 1.7 |
| | Cs₂O | 0.0 | 0.0 | 0.0 | 0.0 |
| | MgO | 4.5 | 2.9 | 13.0 | 8.7 |
| | CaO | 7.2 | 6.5 | 0.0 | 0.0 |
| | SrO | 0.0 | 0.0 | 0.0 | 0.0 |
| | BaO | 0.0 | 0.0 | 0.0 | 0.0 |
| | ZnO | 0.0 | 0.0 | 0.0 | 0.0 |
| | ZrO₂ | 1.0 | 2.0 | 0.0 | 0.0 |
| | TiO₂ | 0.0 | 0.0 | 3.5 | 4.6 |
| | La₂O₃ | 0.0 | 0.0 | 0.0 | 0.0 |
| | Y₂O₃ | 0.0 | 0.0 | 0.0 | 0.0 |
| | Yb₂O₃ | 0.0 | 0.0 | 0.0 | 0.0 |
| | Ta₂O₅ | 0.0 | 0.0 | 0.0 | 0.0 |
| | Nb₂O₅ | 0.0 | 0.0 | 0.3 | 1.2 |
| | HfO₂ | 0.0 | 0.0 | 0.0 | 0.0 |
| | Total | 100.0 | 100.0 | 100.0 | 100.0 |
| | SiO₂ + Al₂O₃ + B₂O₃ | 72.9 | 74.3 | 70.9 | 77.4 |
| | Li₂O + Na₂O + | 14.4 | 14.3 | 12.3 | 8.1 |
| | K₂O + Cs₂O | | | | |
| | Na₂O + K₂O | 14.4 | 14.3 | 2.8 | 3.4 |
| | (Na₂O + K₂O)/ | 1.0 | 1.0 | 0.2 | 0.4 |
| | (Li₂O + Na₂O + | | | | |
| | K₂O + Cs₂O) | | | | |
| | MgO + CaO + SrO + | 11.7 | 9.4 | 13.0 | 8.7 |
| | BaO | | | | |
| | MgO + CaO | 11.7 | 9.4 | 13.0 | 8.7 |
| | SrO + BaO | 0.0 | 0.0 | 0.0 | 0.0 |
| | (MgO + CaO)/(MgO + | 1.0 | 1.0 | 1.0 | 1.0 |
| | CaO + SrO + BaO) | | | | |
| | Al₂O₃/(MgO + CaO) | 0.538 | 1.096 | 0.715 | 1.805 |
| | Al₂O₃/CaO | 0.875 | 1.585 | — | — |
| | AₘOₙ | 1.0 | 2.0 | 3.8 | 5.8 |
| | ZrO₂/AₘOₙ | 1.0 | 1.0 | 0.0 | 0.0 |

(Note)
AₘOₙ means the total content of ZrO₂, TiO₂, La₂O₃, Y₂O₃, Yb₂O₃, Ta₂O₅, Nb₂O₅, and HfO₂.

TABLE 6

| | | Glass Composition No. | | | | | | | | | | |
|---|---|---|---|---|---|---|---|---|---|---|---|---|
| | | No. 1 | No. 2 | No. 3 | No. 4 | No. 5 | No. 6 | No. 7 | No. 8 | No. 9 | No. 10 | No. 11 |
| Characteristics | Specific gravity | 2.7 | 2.8 | 2.7 | 2.8 | 2.7 | 2.8 | 2.8 | 2.7 | 2.7 | 2.79 | 2.79 |
| | Glass transition | 687 | 692 | 698 | 690 | 710 | 701 | 701 | 670 | 689 | 650 | 679 |
| | temperature Tg | | | | | | | | | | | |
| | [° C.] | | | | | | | | | | | |
| | Average linear | 79 | 80 | 79 | 80 | 75 | 75 | 79 | 83 | 78 | 80.9 | 83.3 |
| | expansion | | | | | | | | | | | |
| | coefficient | | | | | | | | | | | |
| | [×10⁻⁷/° C.] | | | | | | | | | | | |
| | Young's modulus | 82 | 88 | 85 | 90 | 84 | 90 | 93 | 83 | 84 | 86 | 82.7 |
| | [GPa] | | | | | | | | | | | |
| | Specific elastic | 30.4 | 31 | 31 | 32 | 31 | 32 | 33 | 31 | 31 | 30.8 | 29.6 |
| | modulus | | | | | | | | | | | |
| | [MNm/kg] | | | | | | | | | | | |
| | Liquidus | 1,180 | 1,220 | 1,200 | 1,300 | 1,250 | 1,290 | more | 1,220 | 1,220 | — | 1,050 or |
| | temperature | | | | | | | than | | | | less |
| | LT [° C.] | | | | | | | 1,300 | | | | |

TABLE 7

| Glass Composition No. | | No. 12 | No. 13 |
|---|---|---|---|
| Character- | Specific gravity | 2.53 | — |
| istics | Glass transition | 592 | 589 |
| | temperature Tg [° C.] | | |
| | Average linear | — | — |
| | expansion coefficient | | |
| | [×10⁻⁷/° C.] | | |
| | Young's modulus | 77 | — |
| | [GPa] | | |
| | Specific elastic | — | 35 |
| | modulus [MNm/kg] | | |
| | Liquidus temperature | — | — |
| | LT [° C.] | | |

### Examples A1 to A11 and Comparative Examples A1 to A13

Each type of glass listed in Table 1 to Table 5 was used to manufacture a glass blank by the horizontal direct press illustrated in FIG. 1 to FIG. 9 or conventional vertical direct press.

—Manufacture of Glass Blank by Horizontal Direct Press—

Here, when a glass blank was manufactured by the horizontal direct press illustrated in FIG. 1 to FIG. 9, the viscosity of the molten glass flow 20 was adjusted by controlling its temperature so as be constant in the range of 500 to 1,050 dPa·s. Further, the press mold bodies 52 and 62 and the guide members 54 and 64 were made of cast iron (FCD). Note that the press-molding surfaces 52A and 62A are smooth surfaces to which mirror finish has been applied and also flat surfaces each having a curvature of substantially zero. Further, the differences in height between the press-molding surfaces 52A and 62A and the guide surfaces 54A and 64A, respectively, were each set to 0.5 mm. Further, the arrangement positions of the press molds 50 and 60 with respect to the vertical direction were adjusted so that the falling distance was kept at a constant value in the range of 100 mm to 200 mm. In addition, the time (press-molding time) taken from the start of press as illustrated in FIG. 5 until the state of the completion of the contact between the guide surface 54A and the guide surface 64A as illustrated in FIG. 7 was set to a constant value in the range of 0.05 second to 0.1 second, and press pressure was set to about 6.7 MPa. Next, while the state illustrated in FIG. 7 was maintained, the press pressure was reduced, and while a state in which the press-molding surfaces 52A and 62A were in close contact with the thin flat glass 26 was kept for about several seconds, the thin flat glass 26 was cooled. Next, the press pressure was released and the first press mold 50 and the second press mold 60 were detached from each other as illustrated in FIG. 8 and FIG. 9, to thereby demold and take out the thin flat glass 26, that is, a glass blank.

—Manufacture of Glass Blank by Vertical Direct Press—

On the other hand, when a glass blank was manufactured by vertical direct press, there was used a press apparatus including a rotating table along the outer peripheral edge of which sixteen lower molds were arranged at regular intervals and which rotated table rotating in one direction while alternatively moving and stopping for each 22.5° at the time of press. Further, when the numbers, P1 to P16, were given to sixteen lower mold stop positions corresponding to the sixteen lower molds arranged on the outer peripheral edge of the rotating table along the rotating direction of the rotating table, the following respective members were arranged above the press surface of a lower mold or at a side of a lower mold at each of the following lower mold stop positions.
Lower mold stop position P1: molten glass supply apparatus
Lower mold stop position P2: Upper mold
Lower mold stop position P4: Upper mold for warpage-adjusting press
Lower mold stop position P12: taking-out means (vacuum adsorption apparatus)

In the press apparatus, a predetermined amount of molten glass is supplied onto a lower mold at the lower mold stop position P1, the molten glass is press-molded into a thin flat glass with the upper mold and the lower mold at the lower mold stop position P2, press is performed again to adjust the warpage of the thin flat glass and further improve the flatness of the thin flat glass at the lower mold stop position P4, and the resultant thin flat glass is taken out at the lower mold stop position P12. Further, a heat-equalizing and cooling step is carried out when the lower mold moves to the stop positions P2 to P12, and prewarming of the lower mold is carried out by using a heater when the lower mold moves to the stop positions P12 to P16.

Here, the pressing time (time during which pressure is applied to glass) and press pressure of the press molding carried out at the lower mold stop position P2 were set to nearly the same levels as those in the case of carrying out horizontal direct press. Besides, the material of the upper mold and lower mold, and the smoothness and flatness of the press-molding surfaces were also set to the same levels as those of the press molds 50 and 60 used in the horizontal direct press. Note that the viscosity of molten glass just before being supplied onto a lower mold positioned at the lower mold stop position P1 was adjusted by controlling its temperature so as to be constant in the range of 500 to 1,050 dPa·s.

—Evaluation—

After 1,000 sheets of glass blanks were continuously manufactured by press molding, 991st to 1,000th glass blanks were sampled, and were each measured for its diameter, circularity, average thickness, thickness deviation, and flatness by using a three-dimensional shape measuring machine and a micrometer to perform evaluation. Note that all samples were found to have a diameter of 75 mm, a circularity of within ±0.5 mm, and an average thickness of 0.90 mm. From the results, the diameter/thickness ratio was found to be 83.3. Further, Table 8 shows the heat resistance, thickness deviation, and flatness of glass, together with Glass No. used, various physical properties of glass, the press method, and the temperature of molten glass used for press. Note that, in Examples A1 to A11, glasses selected from Glass No. 1 to Glass No. 11 were used in the order of increasing Glass No., respectively. In addition, glass of No. 12 was used in Comparative Example A1, glass of No. 13 was used in Comparative Example A2, and, in Comparative Examples A3 to A13, glasses selected from Glass No. 1 to Glass No. 11 were used in the order of increasing Glass No., respectively. Further, in each of Comparative Examples A3 to A13, melt-bonding between the press-molding surface of a lower mold and molten glass occurred while the 1,000 sheets of glass blanks were being continuously manufactured by press molding, and hence ten glass blanks obtained before the occurrence of the melt-bonding were sampled.

TABLE 8

| | | | Comparative | Comparative |
|---|---|---|---|---|
| | | Examples A1 | Examples A1 | Examples A3 |
| | | to A11 | and A2 | to A13 |
| Glass No. used | | 1 to 11 | 12 and 13 | 1 to 11 |
| Press method | | Horizontal | Vertical | Vertical |
| | | direct press | direct press | direct press |
| Temperature of | | 1,250 | 1,250 | 1,250 |
| molten glass [° C.] | | | | |
| Evalua- | Heat | A | E | A |
| tion | resistance | | | |
| results | Flatness | A | C | C |
| | Thickness | A | B | B |
| | deviation | | | |

| | | | |
|---|---|---|---|
| Reference | — | — | Melt-bonding |
| | | | occurred |
| | | | while |
| | | | continuous |
| | | | press |
| | | | was being |
| | | | performed. |

Note)
The “temperature of molten glass” means the temperature of a molten glass flow in the case of horizontal direct press and means the temperature of molten glass just before being supplied to a lower mold in the case of vertical direct press.

Note that the evaluation criteria for heat resistance and the evaluation method and evaluation criteria for thickness deviation and flatness shown in Table 8 are as described below.

—Heat resistance—

The evaluation criteria for heat resistance are as described below.

A: The glass transition temperature is 650° C. or more.
B: The glass transition temperature is 630° C. or more and less than 650° C.
C: The glass transition temperature is 600° C. or more and less than 630° C.
D: The glass transition temperature is less than 600° C.

—Thickness Deviation—

Thicknesses of each glass blank was measured with a micrometer at four points of 0°, 90°, 180°, and 270° in the circumferential direction on two circles with a radius of 15 mm and a radius of 30 mm from the center of the glass blank, thereby determining the standard deviation of thicknesses at a total of eight measuring points. Then, based on the average value of the standard deviation values of 10 samples, evaluation was performed according to the following evaluation criteria.

A: The average value of standard deviation values is 10 μm or less.
B: The average value of standard deviation values is more than 10 μm.

—Flatness—

A three-dimensional shape measuring machine (manufactured by COMS Co., Ltd., high-precision three-dimensional shape measuring system, MAP-3D) was used to determine the flatness of each sample. Then, the average value of the flatness values of ten samples was evaluated on the basis of the following evaluation criteria.

A: The average value of flatness values is 4 μm or less.
B: The average value of flatness values is more than 4 μm and 10 μm or less.
C: The average value of flatness values is more than 10 μm.

### Example B1

Glass blanks were manufactured by changing the press-molding time to the three levels of 0.2 second, 0.5 second, and 1.0 second in Example A1.

### Comparative Example B1

Glass blanks were manufactured in the same manner as that in Example A1, except that the press-molding time was changed to the three levels of 0.2 second, 0.5 second, and 1.0 second and press molds in which two projected streaks were concentrically provided in the press-molding surfaces 52A and 62A were used as the press molds 50 and 60. Note that the projected streaks are a ring-shaped, convex portion with a diameter of 20 mm and a ring-shaped, convex portion with a diameter of 65 mm, each having a height of 0.3 mm. Besides, the cross section of each of the projected streaks has a reverse V-shape, and hence V-shaped grooves can be formed in the surface of the glass blank.

—Evaluation—

After 1,000 sheets of glass blanks were continuously manufactured by press molding, 3 sheets were arbitrarily sampled among 900th to 1,000th glass blanks. The samples were each measured for its thickness with a micrometer at the positions of 0°, 90°, 180°, and 270° in the circumferential direction on two circles with a radius of 25 mm and a radius of 60 mm. Then, there were determined, for each sample, the average value of the thickness values and the thickness deviation at the positions on the circle with a radius of 25 mm, and the average value of the thickness values and the thickness deviation at the positions on the circle with a radius of 60 mm. Further, there was counted the number of the glass blanks in which cracks occurred when the continuous press molding was carried out, and the rate of occurrence of the cracks was evaluated. Those results are shown in Table 9.

As shown in Table 9, it was found that the thickness at the inner circle was thinner than that at the outer circle and the thickness deviation became larger in Comparative Example B1 compared with Example B1. It was also found that as the press-molding time increased, more cracks were liable to occur. Note that those problems and problem of cracks do not occur when press molds in which press-molding surfaces 52A and 62A are each formed of a smooth surface are used.

TABLE 9

| | | | | | | Position at which thickness was measured | | | | | | |
|---|---|---|---|---|---|---|---|---|---|---|---|---|
| | | | | | | | | | | Both (radius | | |
| | | | | | | | | | | of 25 mm and | | |
| | | Glass | | | | Radius of 60 mm | | Radius of 25 mm | | radius of 60 mm) | | |
| | Glass | transition | | Press- | | Average | Standard | Average | Standard | Average | Standard | |
| | No. | temperature | Molding | molding | Sample | value | deviation | value | deviation | value | deviation | |
| | used | Tg (° C.) | surface | time (s) | No | (mm) | (mm) | (mm) | (mm) | (mm) | (mm) | Crack |
| Example B1 | No. 1 | 687 | Without | 0.2 | 1 | 0.913 | 0.00381 | 0.898 | 0.00148 | 0.906 | 0.00792 | A |
| | | | projected | | 2 | 0.913 | 0.00415 | 0.898 | 0.00403 | 0.905 | 0.00854 | |
| | | | streak | | 3 | 0.913 | 0.00453 | 0.900 | 0.00148 | 0.906 | 0.00743 | |
| | | | (flat | 0.5 | 1 | 0.899 | 0.00071 | 0.881 | 0.00218 | 0.890 | 0.00939 | A |
| | | | surface) | | 2 | 0.920 | 0.00295 | 0.907 | 0.00224 | 0.914 | 0.00712 | |
| | | | | | 3 | 0.902 | 0.00286 | 0.880 | 0.00083 | 0.891 | 0.01120 | |
| | | | | 1 | 1 | 0.907 | 0.00412 | 0.893 | 0.00166 | 0.900 | 0.00790 | A |
| | | | | | 2 | 0.907 | 0.00259 | 0.892 | 0.00083 | 0.899 | 0.00774 | |
| | | | | | 3 | 0.908 | 0.00083 | 0.890 | 0.00071 | 0.899 | 0.00916 | |
| Comparative | | | With | 0.2 | 1 | 0.909 | 0.0044 | 0.893 | 0.00171 | 0.901 | 0.00897 | A |
| Example B1 | | | projected | | 2 | 0.909 | 0.0048 | 0.893 | 0.00465 | 0.901 | 0.00961 | |
| | | | streaks | | 3 | 0.909 | 0.00523 | 0.895 | 0.00171 | 0.902 | 0.00843 | |
| | | | | 0.5 | 1 | 0.895 | 0.00082 | 0.876 | 0.00252 | 0.885 | 0.01057 | B |
| | | | | | 2 | 0.916 | 0.0034 | 0.902 | 0.00258 | 0.909 | 0.00811 | |
| | | | | | 3 | 0.898 | 0.0033 | 0.875 | 0.00096 | 0.887 | 0.0125 | |
| | | | | 1 | 1 | 0.903 | 0.00476 | 0.888 | 0.00191 | 0.895 | 0.00894 | C |
| | | | | | 2 | 0.903 | 0.00299 | 0.887 | 0.00096 | 0.895 | 0.0088 | |
| | | | | | 3 | 0.904 | 0.00096 | 0.885 | 0.00082 | 0.895 | 0.01032 | |

Note that the evaluation criteria for “crack” shown in Table 9 are as described below.

A: The rate of occurrence of cracks is 0%.
B: The rate of occurrence of cracks is more than 0% and 3% or less.
C: The rate of occurrence of cracks is more than 3%.

### Example C1

The glass blank manufactured in Example A1 was annealed to reduce or remove strain. Next, there was applied scribe processing on a portion that was to serve as the outer periphery of a magnetic recording medium glass substrate and a portion that was to serve as the inner periphery thereof. As a result of the processing, two grooves looking like concentric circles are formed outside and inside. Next, by partially heating the portions on which the scribe processing was applied, cracks are caused to occur along the grooves produced by the scribe processing, by virtue of the difference in thermal expansion of glass, and the outside portion of the concentric circle and the inside portion of the concentric circle are removed. As a result, a disk-shaped glass having a perfect circle shape is yielded.

Next, shape processing was applied to the disk-shaped glass by using chamfering or the like and its end surfaces were polished. Then, after a first polishing is carried out on the main surfaces of the disk-shaped glass, the glass is immersed in a chemical strengthening solution to perform chemical strengthening. After the chemical strengthening, the glass was sufficiently cleaned and then subjected to a second polishing. After the second polishing step, the disk-shaped glass was cleaned again and a glass substrate for a magnetic disk was manufactured. The substrate had an outer diameter of 65 mm, a central hole diameter of 20 mm, a thickness of 0.8 mm, a main surface flatness of 4 μm or less, and a main surface roughness of 0.2 nm or less. Thus, a magnetic recording medium glass substrate having a desired shape was able to be obtained without carrying out the lapping step.

### Example D1

The magnetic recording medium glass substrate manufactured in Example C1 was used to form an adherent layer, an undercoat layer, a magnetic layer, a protective layer, and a lubricant layer in the stated order on the main surface of the magnetic recording medium glass substrate, yielding a magnetic recording medium. First, a film-forming apparatus in which vacuuming had been performed was used to form sequentially the adherent layer, the undercoat layer, and the magnetic layer in an Ar atmosphere by using a DC magnetron sputtering method. At that time, the adherent layer was formed by using a CrTi target so that an amorphous CrTi layer having a thickness of 20 nm was formed. Subsequently, a single wafer/stationary opposed film-forming apparatus was used to form a layer having a thickness of 10 nm made of amorphous CrRu as the undercoat layer in an Ar atmosphere by using a DC magnetron sputtering method. Further, the magnetic layer was formed at a film-forming temperature of 400° C. by using an FePt target or a CoPt target so that an amorphous FePt layer or an amorphous CoPt layer each having a thickness of 200 nm was formed. After the film formation up to the magnetic layer finished, the magnetic recording medium was transferred from the film-forming apparatus to a heating furnace and annealed at a temperature of 650 to 700° C.

Next, a protective layer made of hydrogenated carbon was formed by a CVD method using ethylene as a material gas. After that, a lubricant layer made using perfluoropolyether (PFPE) was formed by a dip coating method. The thickness of the lubricant layer was 1 nm. The manufacturing steps described above provided a magnetic recording medium.

[Evaluation of Magnetic Recording Medium Glass Substrate (Surface Roughness and Surface Waviness)]

An atomic force microscope (AFM) was used to observe an rectangular region of 5 μm×5 μm of the main surface (surface on which a magnetic recording layer and the like are laminated later) of each substrate, and there were determined the arithmetic average of surface roughness Ra measured in the range of 1 μm×1 μm, the arithmetic average of surface roughness Ra measured in the range of 5 μm×5 μm, and the arithmetic average of surface waviness Wa in the wavelengths of 100 μm to 950 μm.

The results of each of the magnetic recording medium glass substrates showed that the arithmetic average of surface roughness Ra measured in the range of 1 μm×1 μm ranged from 0.15 to 0.25 nm, the arithmetic average of surface roughness Ra measured in the range of 5 cm×5 μm ranged from 0.12 to 0.15 nm, and the arithmetic average of surface waviness Wa in the wavelengths of 100 μm to 950 μm was 0.4 to 0.5 nm, and hence those values were in the range of perfectly acceptable values necessary for the magnetic recording medium glass substrate to be adopted as a substrate used for a magnetic recording medium.

[Evaluation of Magnetic Recording Medium]

### (1) Flatness

In general, if a magnetic recording medium has a flatness of 4 μm or less, the magnetic recording medium can perform highly reliable recording and reproducing. A flatness measuring apparatus was used to measure the flatness (distance (difference in height) in the vertical direction (direction perpendicular to the surface) between the highest portion and lowest portion of the surface of a disk) of the surface of each magnetic recording medium formed by the above-mentioned method. As a result, all the magnetic recording mediums were found to have a flatness of 4 μm or less. From the result, it can be confirmed that even high-temperature treatment at the time of forming the FePt layer or the CoPt layer did not cause any significant deformation. Note that the flatness measuring apparatus used is the same apparatus as that used for measuring the flatness in Example A1 and the like and the measurement conditions are also the same.

(2) Load/Unload Test

Each magnetic recording medium formed by the above-mentioned method was mounted on a 2.5-inch hard disk drive which rotated at a high speed of a rotation number of 5,400 rpm, and a load/unload (hereinafter, referred to as “LUL”) test was carried out. The spindle of a spindle motor in the above-mentioned hard disk drive was made of stainless steel. All the magnetic recording media had a durability of more than 600,000 load/unload cycles. Further, in general, if there occurs deformation due to the difference in thermal expansion coefficient from a spindle material or deflection due to high-speed rotation in an LUL test, a crash failure or a thermal asperity failure is caused in the test. However, those failures did not occur in any of the magnetic recording media in the test.

The results described above show that the magnetic recording media manufactured by the method of manufacturing a magnetic recording medium according to the present invention are capable of performing highly reliable recording and reproducing. The magnetic disks thus manufactured are suitable for a hard disk drive adopting a recording method (heat-assisted recording method) in which magnetization reversal is assisted by irradiation of laser light, and a hard disk drive adopting a recording method (microwave-assisted recording method) in which magnetization reversal is assisted by irradiation of a microwave.

[Other Glass Compositions]

Note that, when the horizontal direct press illustrated in FIG. 1 to FIG. 9 is carried out in the same manner as that shown in Examples A1 to A11 by using a glass (Glass No. 14 to No. 63) formed of any of the glass compositions exemplified in Table 10 to Table 23 described below, it is also possible to obtain a glass blank having nearly the same levels of heat resistance, flatness, and thickness deviation as the glass blanks in Examples A1 to A11.

TABLE 10

| | | No. 14 | | No. 15 | | No. 16 | |
|---|---|---|---|---|---|---|---|
| | | mol % | mass % | mol % | mass % | mol % | mass % |
| Composition | SiO₂ | 66.2 | 62.4 | 62.0 | 59.8 | 65.4 | 61.2 |
| | Al₂O₃ | 0.5 | 0.8 | 0.4 | 0.7 | 0.4 | 0.6 |
| | B₂O₃ | 0.0 | 0.0 | 0.0 | 0.0 | 0.0 | 0.0 |
| | Li₂O | 0.0 | 0.0 | 0.0 | 0.0 | 0.0 | 0.0 |
| | Na₂O | 3.3 | 3.2 | 3.2 | 3.2 | 3.3 | 3.2 |
| | K₂O | 6.2 | 9.2 | 4.4 | 6.6 | 6.2 | 9.1 |
| | Cs₂O | 0.0 | 0.0 | 0.0 | 0.0 | 0.0 | 0.0 |
| | MgO | 6.5 | 4.1 | 9.6 | 6.2 | 6.5 | 4.1 |
| | CaO | 12.5 | 11.0 | 15.6 | 14.0 | 12.5 | 10.9 |
| | SrO | 0.0 | 0.0 | 0.0 | 0.0 | 0.0 | 0.0 |
| | BaO | 0.0 | 0.0 | 0.0 | 0.0 | 0.0 | 0.0 |
| | ZnO | 0.0 | 0.0 | 0.0 | 0.0 | 0.0 | 0.0 |
| | ZrO₂ | 4.8 | 9.3 | 4.8 | 9.5 | 5.7 | 10.9 |
| | TiO₂ | 0.0 | 0.0 | 0.0 | 0.0 | 0.0 | 0.0 |
| | La₂O₃ | 0.0 | 0.0 | 0.0 | 0.0 | 0.0 | 0.0 |
| | Y₂O₃ | 0.0 | 0.0 | 0.0 | 0.0 | 0.0 | 0.0 |
| | Yb₂O₃ | 0.0 | 0.0 | 0.0 | 0.0 | 0.0 | 0.0 |
| | Ta₂O₅ | 0.0 | 0.0 | 0.0 | 0.0 | 0.0 | 0.0 |
| | Nb₂O₅ | 0.0 | 0.0 | 0.0 | 0.0 | 0.0 | 0.0 |
| | HfO₂ | 0.0 | 0.0 | 0.0 | 0.0 | 0.0 | 0.0 |
| | Total | 100.0 | 100.0 | 100.0 | 100.0 | 100.0 | 100.0 |
| | SiO₂ + Al₂O₃ + B₂O₃ | 66.7 | 63.2 | 62.4 | 60.5 | 65.8 | 61.8 |
| | Li₂O + Na₂O + K₂O + Cs₂O | 9.5 | 12.4 | 7.6 | 9.8 | 9.5 | 12.3 |
| | Na₂O + K₂O | 9.5 | 12.4 | 7.6 | 9.8 | 9.5 | 12.3 |
| | (Na₂O + K₂O)/(Li₂O + Na₂O + | 1.0 | 1.0 | 1.0 | 1.0 | 1.0 | 1.0 |
| | K₂O + Cs₂O) | | | | | | |
| | MgO + CaO + SrO + BaO | 19.0 | 15.1 | 25.2 | 20.2 | 19.0 | 15.0 |
| | MgO + CaO | 19.0 | 15.1 | 25.2 | 20.2 | 19.0 | 15.0 |
| | SrO + BaO | 0.0 | 0.0 | 0.0 | 0.0 | 0.0 | 0.0 |
| | (MgO + CaO)/(MgO + CaO + SrO + | 1.0 | 1.0 | 1.0 | 1.0 | 1.0 | 1.0 |
| | BaO) | | | | | | |
| | Al₂O₃/(MgO + CaO) | 0.026 | 0.065 | 0.016 | 0.071 | 0.021 | 0.049 |
| | Al₂O₃/CaO | 0.040 | 0.073 | 0.026 | 0.050 | 0.032 | 0.055 |
| | AₘOₙ | 4.8 | 9.3 | 4.8 | 9.5 | 5.7 | 10.9 |
| | ZrO₂/AₘOₙ | 1.0 | 1.0 | 1.0 | 1.0 | 1.0 | 1.0 |

| | | | | |
|---|---|---|---|---|
| Characteristics | Specific gravity | 2.7 | 2.8 | 2.7 |
| | Glass transition | 687 | 692 | 698 |
| | temperature Tg [° C.] | | | |
| | Average linear | 79 | 80 | 79 |
| | expansion coefficient | | | |
| | [×10⁻⁷/° C.] | | | |
| | Young's modulus [GPa] | 82 | 88 | 85 |
| | Specific elastic | 30 | 31 | 31 |
| | modulus [MNm/kg] | | | |
| | Liquidus temperature | 1,180 | 1,220 | 1,200 |
| | LT [° C.] | | | |

(Note)
AₘOₙ means the total content of ZrO₂, TiO₂, La₂O₃, Y₂O₃, Yb₂O₃, Ta₂O₅, Nb₂O₅, and HfO₂.

TABLE 11

| | | No. 17 | | No. 18 | | No. 19 | |
|---|---|---|---|---|---|---|---|
| | | mol % | mass % | mol % | mass % | mol % | mass % |
| Composition | SiO₂ | 60.2 | 59.4 | 64.8 | 60.9 | 63.6 | 59.5 |
| | Al₂O₃ | 0.4 | 0.7 | 0.4 | 0.6 | 0.4 | 0.6 |
| | B₂O₃ | 0.0 | 0.0 | 0.0 | 0.0 | 0.0 | 0.0 |
| | Li₂O | 0.0 | 0.0 | 0.0 | 0.0 | 0.0 | 0.0 |
| | Na₂O | 3.2 | 3.3 | 1.1 | 1.1 | 4.3 | 4.1 |
| | K₂O | 3.3 | 5.1 | 7.8 | 11.5 | 1.1 | 1.6 |
| | Cs₂O | 0.0 | 0.0 | 0.0 | 0.0 | 1.1 | 4.8 |
| | MgO | 11.7 | 7.8 | 7.5 | 4.7 | 5.2 | 3.3 |
| | CaO | 17.5 | 16.2 | 13.6 | 11.9 | 19.6 | 17.1 |
| | SrO | 0.0 | 0.0 | 0.0 | 0.0 | 0.0 | 0.0 |
| | BaO | 0.0 | 0.0 | 0.0 | 0.0 | 0.0 | 0.0 |
| | ZnO | 0.0 | 0.0 | 0.0 | 0.0 | 0.0 | 0.0 |
| | ZrO₂ | 3.7 | 7.5 | 4.8 | 9.3 | 4.7 | 9.0 |
| | TiO₂ | 0.0 | 0.0 | 0.0 | 0.0 | 0.0 | 0.0 |
| | La₂O₃ | 0.0 | 0.0 | 0.0 | 0.0 | 0.0 | 0.0 |
| | Y₂O₃ | 0.0 | 0.0 | 0.0 | 0.0 | 0.0 | 0.0 |
| | Yb₂O₃ | 0.0 | 0.0 | 0.0 | 0.0 | 0.0 | 0.0 |
| | Ta₂O₅ | 0.0 | 0.0 | 0.0 | 0.0 | 0.0 | 0.0 |
| | Nb₂O₅ | 0.0 | 0.0 | 0.0 | 0.0 | 0.0 | 0.0 |
| | HfO₂ | 0.0 | 0.0 | 0.0 | 0.0 | 0.0 | 0.0 |
| | Total | 100.0 | 100.0 | 100.0 | 100.0 | 100.0 | 100.0 |
| | SiO₂ + Al₂O₃ + B₂O₃ | 60.6 | 60.1 | 65.2 | 61.5 | 64.0 | 60.1 |
| | Li₂O + Na₂O + K₂O + Cs₂O | 6.5 | 8.4 | 8.9 | 12.6 | 6.5 | 10.5 |
| | Na₂O + K₂O | 6.5 | 8.4 | 8.9 | 12.6 | 5.4 | 5.7 |
| | (Na₂O + K₂O)/(Li₂O + Na₂O + | 1.0 | 1.0 | 1.0 | 1.0 | 0.8 | 0.5 |
| | K₂O + Cs₂O) | | | | | | |
| | MgO + CaO + SrO + BaO | 29.2 | 24.0 | 21.1 | 16.6 | 24.8 | 20.4 |
| | MgO + CaO | 29.2 | 24.0 | 21.1 | 16.6 | 24.8 | 20.4 |
| | SrO + BaO | 0.0 | 0.0 | 0.0 | 0.0 | 0.0 | 0.0 |
| | (MgO + CaO)/(MgO + CaO + SrO + | 1.0 | 1.0 | 1.0 | 1.0 | 1.0 | 1.0 |
| | BaO) | | | | | | |
| | Al₂O₃/(MgO + CaO) | 0.014 | 0.083 | 0.019 | 0.048 | 0.016 | 0.105 |
| | Al₂O₃/CaO | 0.023 | 0.043 | 0.029 | 0.050 | 0.020 | 0.035 |
| | AₘOₙ | 3.7 | 7.5 | 4.8 | 9.3 | 4.7 | 9.0 |
| | ZrO₂/AₘOₙ | 1.0 | 1.0 | 1.0 | 1.0 | 1.0 | 1.0 |

| | | | | |
|---|---|---|---|---|
| Characteristics | Specific gravity | 2.8 | 2.7 | 2.8 |
| | Glass transition | 690 | 710 | 701 |
| | temperature Tg [° C.] | | | |
| | Average linear | 80 | 75 | 75 |
| | expansion coefficient | | | |
| | [×10⁻⁷/° C.] | | | |
| | Young's modulus [GPa] | 90 | 84 | 90 |
| | Specific elastic | 32 | 31 | 32 |
| | modulus [MNm/kg] | | | |
| | Liquidus temperature | 1,300 | 1,250 | 1,290 |
| | LT [° C.] | | | |

(Note)
AₘOₙ means the total content of ZrO₂, TiO₂, La₂O₃, Y₂O₃, Yb₂O₃, Ta₂O₅, Nb₂O₅, and HfO₂.

TABLE 12

| | | No. 20 | | No. 21 | | No. 22 | |
|---|---|---|---|---|---|---|---|
| | | mol % | mass % | mol % | mass % | mol % | mass % |
| Composition | SiO₂ | 57.6 | 55.8 | 65.9 | 62.0 | 64.1 | 60.0 |
| | Al₂O₃ | 2.1 | 3.5 | 0.9 | 1.4 | 0.4 | 0.7 |
| | B₂O₃ | 0.0 | 0.0 | 0.0 | 0.0 | 0.0 | 0.0 |
| | Li₂O | 0.0 | 0.0 | 0.0 | 0.0 | 0.0 | 0.0 |
| | Na₂O | 3.2 | 3.2 | 3.3 | 3.2 | 3.3 | 3.2 |
| | K₂O | 2.8 | 4.3 | 6.1 | 9.0 | 6.2 | 9.0 |
| | Cs₂O | 0.0 | 0.0 | 0.0 | 0.0 | 0.0 | 0.0 |
| | MgO | 11.8 | 7.7 | 6.5 | 4.1 | 6.5 | 4.1 |
| | CaO | 17.7 | 16.0 | 12.5 | 11.0 | 12.5 | 11.0 |
| | SrO | 0.0 | 0.0 | 0.0 | 0.0 | 0.0 | 0.0 |
| | BaO | 0.0 | 0.0 | 0.0 | 0.0 | 0.0 | 0.0 |
| | ZnO | 0.0 | 0.0 | 0.0 | 0.0 | 0.0 | 0.0 |
| | ZrO₂ | 4.8 | 9.5 | 4.8 | 9.3 | 4.8 | 9.3 |
| | TiO₂ | 0.0 | 0.0 | 0.0 | 0.0 | 2.2 | 2.7 |
| | La₂O₃ | 0.0 | 0.0 | 0.0 | 0.0 | 0.0 | 0.0 |
| | Y₂O₃ | 0.0 | 0.0 | 0.0 | 0.0 | 0.0 | 0.0 |
| | Yb₂O₃ | 0.0 | 0.0 | 0.0 | 0.0 | 0.0 | 0.0 |
| | Ta₂O₅ | 0.0 | 0.0 | 0.0 | 0.0 | 0.0 | 0.0 |
| | Nb₂O₅ | 0.0 | 0.0 | 0.0 | 0.0 | 0.0 | 0.0 |
| | HfO₂ | 0.0 | 0.0 | 0.0 | 0.0 | 0.0 | 0.0 |
| | Total | 100.0 | 100.0 | 100.0 | 100.0 | 100.0 | 100.0 |
| | SiO₂ + Al₂O₃ + B₂O₃ | 59.7 | 59.3 | 66.8 | 63.4 | 64.5 | 60.7 |
| | Li₂O + Na₂O + K₂O + Cs₂O | 6.0 | 7.5 | 9.4 | 12.2 | 9.5 | 12.2 |
| | Na₂O + K₂O | 6.0 | 7.5 | 9.4 | 12.2 | 9.5 | 12.2 |
| | (Na₂O + K₂O)/(Li₂O + Na₂O + | 1.0 | 1.0 | 1.0 | 1.0 | 1.0 | 1.0 |
| | K₂O + Cs₂O) | | | | | | |
| | MgO + CaO + SrO + BaO | 29.5 | 23.7 | 19.0 | 15.1 | 19.0 | 15.1 |
| | MgO + CaO | 29.5 | 23.7 | 19.0 | 15.1 | 19.0 | 15.1 |
| | SrO + BaO | 0.0 | 0.0 | 0.0 | 0.0 | 0.0 | 0.0 |
| | (MgO + CaO)/(MgO + CaO + SrO + | 1.0 | 1.0 | 1.0 | 1.0 | 1.0 | 1.0 |
| | BaO) | | | | | | |
| | Al₂O₃/(MgO + CaO) | 0.071 | 0.467 | 0.047 | 0.115 | 0.021 | 0.057 |
| | Al₂O₃/CaO | 0.119 | 0.219 | 0.072 | 0.127 | 0.032 | 0.064 |
| | AₘOₙ | 4.8 | 9.5 | 4.8 | 9.3 | 7.0 | 12.0 |
| | ZrO₂/AₘOₙ | 1.0 | 1.0 | 1.0 | 1.0 | 0.7 | 0.8 |

| | | | | |
|---|---|---|---|---|
| Characteristics | Specific gravity | 2.8 | 2.7 | 2.7 |
| | Glass transition | 701 | 689 | 686 |
| | temperature Tg [° C.] | | | |
| | Average linear | 79 | 78 | 74.6 |
| | expansion coefficient | | | |
| | [×10⁻⁷/° C.] | | | |
| | Young's modulus [GPa] | 93 | 87 | 85 |
| | Specific elastic | 33 | 31 | 31 |
| | modulus [MNm/kg] | | | |
| | Liquidus temperature | less than 1,300 | 1,220 | 1,180 |
| | LT [° C.] | | | |

(Note)
AₘOₙ means the total content of ZrO₂, TiO₂, La₂O₃, Y₂O₃, Yb₂O₃, Ta₂O₅, Nb₂O₅, and HfO₂.

TABLE 13

| | | No. 23 | | No. 24 | | No. 25 | |
|---|---|---|---|---|---|---|---|
| | | mol % | mass % | mol % | mass % | mol % | mass % |
| Composition | SiO₂ | 67.7 | 59.4 | 67.7 | 58.8 | 59.7 | 58.7 |
| | Al₂O₃ | 0.5 | 0.7 | 0.5 | 0.7 | 0.0 | 0.0 |
| | B₂O₃ | 0.0 | 0.0 | 0.0 | 0.0 | 0.0 | 0.0 |
| | Li₂O | 0.0 | 0.0 | 0.0 | 0.0 | 0.0 | 0.0 |
| | Na₂O | 3.4 | 3.1 | 3.4 | 3.0 | 3.2 | 3.2 |
| | K₂O | 6.3 | 8.7 | 6.3 | 8.5 | 3.3 | 5.1 |
| | Cs₂O | 0.0 | 0.0 | 0.0 | 0.0 | 0.0 | 0.0 |
| | MgO | 2.1 | 1.3 | 2.1 | 1.2 | 11.6 | 7.6 |
| | CaO | 12.8 | 10.5 | 12.8 | 10.4 | 17.5 | 16.0 |
| | SrO | 0.0 | 0.0 | 0.0 | 0.0 | 0.0 | 0.0 |
| | BaO | 0.0 | 0.0 | 0.0 | 0.0 | 0.0 | 0.0 |
| | ZnO | 0.0 | 0.0 | 0.0 | 0.0 | 0.0 | 0.0 |
| | ZrO₂ | 4.9 | 8.9 | 4.9 | 8.8 | 4.7 | 9.4 |
| | TiO₂ | 0.0 | 0.0 | 0.0 | 0.0 | 0.0 | 0.0 |
| | La₂O₃ | 0.0 | 0.0 | 0.0 | 0.0 | 0.0 | 0.0 |
| | Y₂O₃ | 2.3 | 7.4 | 0.0 | 0.0 | 0.0 | 0.0 |
| | Yb₂O₃ | 0.0 | 0.0 | 0.0 | 0.0 | 0.0 | 0.0 |
| | Ta₂O₅ | 0.0 | 0.0 | 0.0 | 0.0 | 0.0 | 0.0 |
| | Nb₂O₅ | 0.0 | 0.0 | 2.3 | 8.6 | 0.0 | 0.0 |
| | HfO₂ | 0.0 | 0.0 | 0.0 | 0.0 | 0.0 | 0.0 |
| | Total | 100.0 | 100.0 | 100.0 | 100.0 | 100.0 | 100.0 |
| | SiO₂ + Al₂O₃ + B₂O₃ | 68.2 | 60.1 | 68.2 | 59.5 | 59.7 | 58.7 |
| | Li₂O + Na₂O + K₂O + Cs₂O | 9.7 | 11.8 | 9.7 | 11.5 | 6.5 | 8.3 |
| | Na₂O + K₂O | 9.7 | 11.8 | 9.7 | 11.5 | 6.5 | 8.3 |
| | (Na₂O + K₂O)/(Li₂O + Na₂O + | 1.0 | 1.0 | 1.0 | 1.0 | 1.0 | 1.0 |
| | K₂O + Cs₂O) | | | | | | |
| | MgO + CaO + SrO + BaO | 14.9 | 11.8 | 14.9 | 11.6 | 29.1 | 23.6 |
| | MgO + CaO | 14.9 | 11.8 | 14.9 | 11.6 | 29.1 | 23.6 |
| | SrO + BaO | 0.0 | 0.0 | 0.0 | 0.0 | 0.0 | 0.0 |
| | (MgO + CaO)/(MgO + CaO + SrO + | 1.0 | 1.0 | 1.0 | 1.0 | 1.0 | 1.0 |
| | BaO) | | | | | | |
| | Al₂O₃/(MgO + CaO) | 0.034 | 0.059 | 0.034 | 0.061 | 0.000 | 0.000 |
| | Al₂O₃/CaO | 0.039 | 0.067 | 0.039 | 0.067 | 0.000 | 0.000 |
| | AₘOₙ | 7.2 | 16.3 | 7.2 | 17.4 | 4.7 | 9.4 |
| | ZrO₂/AₘOₙ | 0.7 | 0.5 | 0.7 | 0.5 | 1.0 | 1.0 |

| | | | | |
|---|---|---|---|---|
| Characteristics | Specific gravity | 2.8 | 2.8 | 2.8 |
| | Glass transition | 716 | 710 | 696 |
| | temperature Tg [° C.] | | | |
| | Average linear | 77.1 | 75.7 | 76.6 |
| | expansion coefficient | | | |
| | [×10⁻⁷/° C.] | | | |
| | Young's modulus [GPa] | 86 | 85 | 88 |
| | Specific elastic | 31 | 30 | 31.6 |
| | modulus [MNm/kg] | | | |
| | Liquidus temperature | — | — | — |
| | LT [° C.] | | | |

(Note)
AₘOₙ means the total content of ZrO₂, TiO₂, La₂O₃, Y₂O₃, Yb₂O₃, Ta₂O₅, Nb₂O₅, and HfO₂.

TABLE 14

| | | No. 26 | | No. 27 | | No. 28 | |
|---|---|---|---|---|---|---|---|
| | | mol % | mass % | mol % | mass % | mol % | mass % |
| Composition | SiO₂ | 64.8 | 60.6 | 57.9 | 52.8 | 71.3 | 67.0 |
| | Al₂O₃ | 0.4 | 0.7 | 0.4 | 0.7 | 0.4 | 0.7 |
| | B₂O₃ | 0.0 | 0.0 | 0.0 | 0.0 | 0.0 | 0.0 |
| | Li₂O | 0.0 | 0.0 | 0.0 | 0.0 | 0.0 | 0.0 |
| | Na₂O | 0.0 | 0.0 | 3.1 | 3.0 | 3.3 | 3.2 |
| | K₂O | 8.9 | 13.0 | 3.3 | 4.7 | 6.2 | 9.1 |
| | Cs₂O | 0.0 | 0.0 | 0.0 | 0.0 | 0.0 | 0.0 |
| | MgO | 7.5 | 4.7 | 8.3 | 5.1 | 6.5 | 4.1 |
| | CaO | 13.6 | 11.8 | 16.1 | 13.7 | 7.5 | 6.6 |
| | SrO | 0.0 | 0.0 | 0.0 | 0.0 | 0.0 | 0.0 |
| | BaO | 0.0 | 0.0 | 2.1 | 4.9 | 0.0 | 0.0 |
| | ZnO | 0.0 | 0.0 | 0.0 | 0.0 | 0.0 | 0.0 |
| | ZrO₂ | 4.8 | 9.2 | 6.7 | 12.6 | 4.8 | 9.3 |
| | TiO₂ | 0.0 | 0.0 | 2.1 | 2.5 | 0.0 | 0.0 |
| | La₂O₃ | 0.0 | 0.0 | 0.0 | 0.0 | 0.0 | 0.0 |
| | Y₂O₃ | 0.0 | 0.0 | 0.0 | 0.0 | 0.0 | 0.0 |
| | Yb₂O₃ | 0.0 | 0.0 | 0.0 | 0.0 | 0.0 | 0.0 |
| | Ta₂O₅ | 0.0 | 0.0 | 0.0 | 0.0 | 0.0 | 0.0 |
| | Nb₂O₅ | 0.0 | 0.0 | 0.0 | 0.0 | 0.0 | 0.0 |
| | HfO₂ | 0.0 | 0.0 | 0.0 | 0.0 | 0.0 | 0.0 |
| | Total | 100.0 | 100.0 | 100.0 | 100.0 | 100.0 | 100.0 |
| | SiO₂ + Al₂O₃ + B₂O₃ | 65.2 | 61.3 | 58.3 | 53.5 | 71.7 | 67.7 |
| | Li₂O + Na₂O + K₂O + Cs₂O | 8.9 | 13.0 | 6.4 | 7.7 | 9.5 | 12.3 |
| | Na₂O + K₂O | 8.9 | 13.0 | 6.4 | 7.7 | 9.5 | 12.3 |
| | (Na₂O + K₂O)/(Li₂O + Na₂O + | 1.0 | 1.0 | 1.0 | 1.0 | 1.0 | 1.0 |
| | K₂O + Cs₂O) | | | | | | |
| | MgO + CaO + SrO + BaO | 21.1 | 16.5 | 26.5 | 23.7 | 14.0 | 10.7 |
| | MgO + CaO | 21.1 | 16.5 | 24.4 | 18.8 | 14.0 | 10.7 |
| | SrO + BaO | 0.0 | 0.0 | 2.1 | 4.9 | 0.0 | 0.0 |
| | (MgO + CaO)/(MgO + CaO + SrO + | 1.0 | 1.0 | 0.92 | 0.79 | 1.0 | 1.0 |
| | BaO) | | | | | | |
| | Al₂O₃/(MgO + CaO) | 0.019 | 0.054 | 0.016 | 0.091 | 0.029 | 0.057 |
| | Al₂O₃/CaO | 0.029 | 0.059 | 0.025 | 0.051 | 0.053 | 0.106 |
| | AₘOₙ | 4.8 | 9.2 | 8.8 | 15.1 | 4.8 | 9.3 |
| | ZrO₂/AₘOₙ | 1.0 | 1.0 | 0.8 | 0.8 | 1.0 | 1.0 |

| | | | | |
|---|---|---|---|---|
| Characteristics | Specific gravity | 2.7 | 2.95 | 2.6 |
| | Glass transition | 727 | 708 | 692 |
| | temperature Tg [° C.] | | | |
| | Average linear | 77.2 | 75.5 | 73.3 |
| | expansion coefficient | | | |
| | [×10⁻⁷/° C.] | | | |
| | Young's modulus [GPa] | 80 | 94 | 80 |
| | Specific elastic | 30 | 32 | 30 |
| | modulus [MNm/kg] | | | |
| | Liquidus temperature | 1,300 | — | — |
| | LT [° C.] | | | |

(Note)
AₘOₙ means the total content of ZrO₂, TiO₂, La₂O₃, Y₂O₃, Yb₂O₃, Ta₂O₅, Nb₂O₅, and HfO₂.

TABLE 15

| | | No. 29 | | No. 30 | | No. 31 | |
|---|---|---|---|---|---|---|---|
| | | mol % | mass % | mol % | mass % | mol % | mass % |
| Composition | SiO₂ | 51.7 | 48.4 | 65.3 | 61.4 | 59.2 | 56.6 |
| | Al₂O₃ | 3.9 | 6.2 | 0.4 | 0.7 | 0.4 | 0.7 |
| | B₂O₃ | 0.0 | 0.0 | 0.8 | 0.9 | 0.0 | 0.0 |
| | Li₂O | 0.0 | 0.0 | 0.0 | 0.0 | 0.0 | 0.0 |
| | Na₂O | 1.6 | 1.6 | 3.3 | 3.2 | 3.2 | 3.2 |
| | K₂O | 9.3 | 13.6 | 6.2 | 9.2 | 3.3 | 5.0 |
| | Cs₂O | 0.0 | 0.0 | 0.0 | 0.0 | 0.0 | 0.0 |
| | MgO | 14.4 | 9.0 | 6.5 | 4.1 | 9.5 | 6.1 |
| | CaO | 14.7 | 12.8 | 12.6 | 11.1 | 15.4 | 13.7 |
| | SrO | 0.0 | 0.0 | 0.0 | 0.0 | 0.0 | 0.0 |
| | BaO | 0.0 | 0.0 | 0.0 | 0.0 | 0.0 | 0.0 |
| | ZnO | 0.0 | 0.0 | 0.0 | 0.0 | 4.3 | 5.5 |
| | ZrO₂ | 4.4 | 8.4 | 4.9 | 9.4 | 4.7 | 9.2 |
| | TiO₂ | 0.0 | 0.0 | 0.0 | 0.0 | 0.0 | 0.0 |
| | La₂O₃ | 0.0 | 0.0 | 0.0 | 0.0 | 0.0 | 0.0 |
| | Y₂O₃ | 0.0 | 0.0 | 0.0 | 0.0 | 0.0 | 0.0 |
| | Yb₂O₃ | 0.0 | 0.0 | 0.0 | 0.0 | 0.0 | 0.0 |
| | Ta₂O₅ | 0.0 | 0.0 | 0.0 | 0.0 | 0.0 | 0.0 |
| | Nb₂O₅ | 0.0 | 0.0 | 0.0 | 0.0 | 0.0 | 0.0 |
| | HfO₂ | 0.0 | 0.0 | 0.0 | 0.0 | 0.0 | 0.0 |
| | Total | 100.0 | 100.0 | 100.0 | 100.0 | 100.0 | 100.0 |
| | SiO₂ + Al₂O₃ + B₂O₃ | 55.6 | 54.6 | 66.5 | 63.0 | 59.6 | 57.3 |
| | Li₂O + Na₂O + K₂O + Cs₂O | 10.9 | 15.2 | 9.5 | 12.4 | 6.5 | 8.2 |
| | Na₂O + K₂O | 10.9 | 15.2 | 9.5 | 12.4 | 6.5 | 8.2 |
| | (Na₂O + K₂O)/(Li₂O + Na₂O + | 1.0 | 1.0 | 1.0 | 1.0 | 1.0 | 1.0 |
| | K₂O + Cs₂O) | | | | | | |
| | MgO + CaO + SrO + BaO | 29.1 | 21.8 | 19.1 | 15.2 | 24.9 | 19.8 |
| | MgO + CaO | 29.1 | 21.8 | 19.1 | 15.2 | 24.9 | 19.8 |
| | SrO + BaO | 0.0 | 0.0 | 0.0 | 0.0 | 0.0 | 0.0 |
| | (MgO + CaO)/(MgO + CaO + SrO + | 1.0 | 1.0 | 1.0 | 1.0 | 1.0 | 1.0 |
| | BaO) | | | | | | |
| | Al₂O₃/(MgO + CaO) | 0.134 | 0.408 | 0.021 | 0.056 | 0.016 | 0.085 |
| | Al₂O₃/CaO | 0.265 | 0.484 | 0.032 | 0.063 | 0.026 | 0.051 |
| | AₘOₙ | 4.4 | 8.4 | 4.9 | 9.4 | 4.7 | 9.2 |
| | ZrO₂/AₘOₙ | 1.0 | 1.0 | 1.0 | 1.0 | 1.0 | 1.0 |

| | | | | |
|---|---|---|---|---|
| Characteristics | Specific gravity | 2.8 | 2.7 | 2.9 |
| | Glass transition | 692 | 675 | 678 |
| | temperature Tg [° C.] | | | |
| | Average linear | 89.5 | 77.8 | 74.7 |
| | expansion coefficient | | | |
| | [×10⁻⁷/° C.] | | | |
| | Young's modulus [GPa] | 86 | 83 | 91 |
| | Specific elastic | 31 | 31 | 32 |
| | modulus [MNm/kg] | | | |
| | Liquidus temperature | — | 1,180 | — |
| | LT [° C.] | | | |

(Note)
AₘOₙ means the total content of ZrO₂, TiO₂, La₂O₃, Y₂O₃, Yb₂O₃, Ta₂O₅, Nb₂O₅, and HfO₂.

TABLE 16

| | | No. 32 | No. 33 | No. 34 | No. 35 |
|---|---|---|---|---|---|
| | | mol % | mol % | mol % | mol % |
| Composi- | SiO₂ | 64.00 | 63.00 | 64.00 | 64.00 |
| tion | B₂O₃ | 0.00 | 0.00 | 0.00 | 0.00 |
| | Al₂O₃ | 5.00 | 6.00 | 5.00 | 5.00 |
| | Li₂O | 1.50 | 1.50 | 1.50 | 1.50 |
| | Na₂O | 8.50 | 8.50 | 8.50 | 8.50 |
| | K₂O | 0.00 | 0.00 | 0.00 | 0.00 |
| | MgO | 4.00 | 4.00 | 10.00 | 13.00 |
| | CaO | 13.00 | 13.00 | 7.00 | 4.00 |
| | SrO | 0.00 | 0.00 | 0.00 | 0.00 |
| | BaO | 0.00 | 0.00 | 0.00 | 0.00 |
| | ZnO | 0.00 | 0.00 | 0.00 | 0.00 |
| | ZrO₂ | 4.00 | 4.00 | 4.00 | 4.00 |
| | TiO₂ | 0.00 | 0.00 | 0.00 | 0.00 |
| | Y₂O₃ | 0.00 | 0.00 | 0.00 | 0.00 |
| | Yb₂O₃ | 0.00 | 0.00 | 0.00 | 0.00 |
| | La₂O₃ | 0.00 | 0.00 | 0.00 | 0.00 |
| | Gd₂O₃ | 0.00 | 0.00 | 0.00 | 0.00 |
| | Nb₂O₅ | 0.00 | 0.00 | 0.00 | 0.00 |
| | Ta₂O₅ | 0.00 | 0.00 | 0.00 | 0.00 |
| | Total | 100.00 | 100.00 | 100.00 | 100.00 |
| | Li₂O + Na₂O + K₂O | 10.00 | 10.00 | 10.00 | 10.00 |
| | Li₂O/Na₂O | 0.18 | 0.18 | 0.18 | 0.18 |
| | Li₂O/(Li₂O + Na₂O + K₂O) | 0.150 | 0.150 | 0.150 | 0.150 |
| | K₂O/(Li₂O + Na₂O + K₂O) | 0.000 | 0.000 | 0.000 | 0.000 |
| | MgO + CaO + SrO | 17.00 | 17.00 | 17.00 | 17.00 |
| | MgO + CaO | 17.00 | 17.00 | 17.00 | 17.00 |
| | Li₂O + Na₂O + K₂O + MgO + | 27.00 | 27.00 | 27.00 | 27.00 |
| | CaO + SrO | | | | |
| | (MgO + CaO + Li₂O)/(Li₂O + | 0.685 | 0.685 | 0.685 | 0.685 |
| | Na₂O + K₂O + MgO + CaO + SrO) | | | | |
| | ZrO₂ + TiO₂ + Y₂O₃ + La₂O₃ + | 4.00 | 4.00 | 4.00 | 4.00 |
| | Gd₂O₃ + Nb₂O₅ + Ta₂O₅ | | | | |
| | (SiO₂ + ZrO₂ + TiO₂ + Y₂O₃ + | 7.30 | 7.30 | 7.30 | 7.30 |
| | La₂O₃ + Gd₂O₃ + Nb₂O₅ + | | | | |
| | Ta₂O₅)/(Li₂O + Na₂O + K₂O) | | | | |
| | (ZrO₂ + TiO₂ + Y₂O₃ + La₂O₃ + | 0.800 | 0.667 | 0.800 | 0.800 |
| | Gd₂O₃ + Nb₂O₅ + Ta₂O₅)/Al₂O₃ | | | | |
| | (MgO + CaO)/(MgO + CaO + SrO) | 1.000 | 1.000 | 1.000 | 1.000 |
| Character- | Glass transition | 633 | ≧630 | 639 | 650 |
| istics | temperature Tg (° C.) | | | | |
| | Average linear expansion | 77 | ≧75 | 72 | 70 |
| | coefficient (×10⁻⁷/° C.) | | | | |
| | (100 to 300° C.) | | | | |
| | Young's modulus (GPa) | 87.5 | 87.8 | 87.9 | 88.3 |
| | Specific elastic modulus | 32.8 | 32.9 | 33.3 | 33.5 |
| | (MNm/kg) | | | | |
| | Specific gravity | 2.67 | 2.67 | 2.64 | 2.63 |

TABLE 17

| | | No. 36 | No. 37 | No. 38 | No. 39 |
|---|---|---|---|---|---|
| | | mol % | mol % | mol % | mol % |
| Composi- | SiO₂ | 60.00 | 64.00 | 65.00 | 65.00 |
| tion | B₂O₃ | 0.00 | 0.00 | 0.00 | 0.00 |
| | Al₂O₃ | 9.00 | 6.00 | 6.00 | 6.00 |
| | Li₂O | 1.50 | 1.50 | 1.50 | 1.50 |
| | Na₂O | 8.50 | 8.00 | 8.00 | 8.00 |
| | K₂O | 0.00 | 0.00 | 0.00 | 0.00 |
| | MgO | 2.00 | 3.00 | 2.00 | 1.00 |
| | CaO | 15.00 | 13.50 | 13.50 | 14.50 |
| | SrO | 0.00 | 0.00 | 0.00 | 0.00 |
| | BaO | 0.00 | 0.00 | 0.00 | 0.00 |
| | ZnO | 0.00 | 0.00 | 0.00 | 0.00 |
| | ZrO₂ | 4.00 | 4.00 | 4.00 | 4.00 |
| | TiO₂ | 0.00 | 0.00 | 0.00 | 0.00 |
| | Y₂O₃ | 0.00 | 0.00 | 0.00 | 0.00 |
| | Yb₂O₃ | 0.00 | 0.00 | 0.00 | 0.00 |
| | La₂O₃ | 0.00 | 0.00 | 0.00 | 0.00 |
| | Gd₂O₃ | 0.00 | 0.00 | 0.00 | 0.00 |
| | Nb₂O₅ | 0.00 | 0.00 | 0.00 | 0.00 |
| | Ta₂O₅ | 0.00 | 0.00 | 0.00 | 0.00 |
| | Total | 100.00 | 100.00 | 100.00 | 100.00 |
| | Li₂O + Na₂O + K₂O | 10.00 | 9.50 | 9.50 | 9.50 |
| | Li₂O/Na₂O | 0.18 | 0.19 | 0.19 | 0.19 |
| | Li₂O/(Li₂O + Na₂O + K₂O) | 0.150 | 0.158 | 0.158 | 0.158 |
| | K₂O/(Li₂O + Na₂O + K₂O) | 0.000 | 0.000 | 0.000 | 0.000 |
| | MgO + CaO + SrO | 17.00 | 16.50 | 15.50 | 15.50 |
| | MgO + CaO | 17.00 | 16.50 | 15.50 | 15.50 |
| | Li₂O + Na₂O + K₂O + MgO + | 27.00 | 26.00 | 25.00 | 25.00 |
| | CaO + SrO | | | | |
| | (MgO + CaO + Li₂O)/(Li₂O + | 0.685 | 0.692 | 0.680 | 0.680 |
| | Na₂O + K₂O + MgO + CaO + SrO) | | | | |
| | ZrO₂ + TiO₂ + Y₂O₃ + La₂O₃ + | 4.00 | 4.00 | 4.00 | 4.00 |
| | Gd₂O₃ + Nb₂O₅ + Ta₂O₅ | | | | |
| | (SiO₂ + ZrO₂ + TiO₂ + Y₂O₃ + | 7.30 | 7.79 | 7.89 | 7.89 |
| | La₂O₃ + Gd₂O₃ + Nb₂O₅ + | | | | |
| | Ta₂O₅)/(Li₂O + Na₂O + K₂O) | | | | |
| | (ZrO₂ + TiO₂ + Y₂O₃ + La₂O₃ + | 0.444 | 0.667 | 0.667 | 0.667 |
| | Gd₂O₃ + Nb₂O₅ + Ta₂O₅)/Al₂O₃ | | | | |
| | (MgO + CaO)/(MgO + CaO + SrO) | 1.000 | 1.000 | 1.000 | 1.000 |
| Character- | Glass transition | 658 | 646 | 646 | 651 |
| istics | temperature Tg (° C.) | | | | |
| | Average linear expansion | 74 | 75 | 74 | 74 |
| | coefficient (×10⁻⁷/° C.) | | | | |
| | (100 to 300° C.) | | | | |
| | Young's modulus (GPa) | 88.8 | 87.6 | 86.7 | 86.8 |
| | Specific elastic modulus | 33.0 | 32.8 | 32.6 | 32.6 |
| | (MNm/kg) | | | | |
| | Specific gravity | 2.69 | 2.67 | 2.66 | 2.66 |

TABLE 18

| | | No. 40 | No. 41 | No. 42 | No. 43 |
|---|---|---|---|---|---|
| | | mol % | mol % | mol % | mol % |
| Composi- | SiO₂ | 65.00 | 65.00 | 65.00 | 64.00 |
| tion | B₂O₃ | 0.00 | 0.00 | 0.00 | 0.00 |
| | Al₂O₃ | 6.00 | 6.00 | 6.00 | 5.00 |
| | Li₂O | 1.50 | 1.50 | 1.50 | 1.50 |
| | Na₂O | 8.00 | 8.00 | 8.00 | 8.50 |
| | K₂O | 0.00 | 0.00 | 0.00 | 0.00 |
| | MgO | 0.00 | 1.00 | 0.00 | 2.00 |
| | CaO | 15.50 | 13.50 | 13.50 | 13.00 |
| | SrO | 0.00 | 1.00 | 2.00 | 2.00 |
| | BaO | 0.00 | 0.00 | 0.00 | 0.00 |
| | ZnO | 0.00 | 0.00 | 0.00 | 0.00 |
| | ZrO₂ | 4.00 | 4.00 | 4.00 | 4.00 |
| | TiO₂ | 0.00 | 0.00 | 0.00 | 0.00 |
| | Y₂O₃ | 0.00 | 0.00 | 0.00 | 0.00 |
| | Yb₂O₃ | 0.00 | 0.00 | 0.00 | 0.00 |
| | La₂O₃ | 0.00 | 0.00 | 0.00 | 0.00 |
| | Gd₂O₃ | 0.00 | 0.00 | 0.00 | 0.00 |
| | Nb₂O₅ | 0.00 | 0.00 | 0.00 | 0.00 |
| | Ta₂O₅ | 0.00 | 0.00 | 0.00 | 0.00 |
| | Total | 100.00 | 100.00 | 100.00 | 100.00 |
| | Li₂O + Na₂O + K₂O | 9.50 | 9.50 | 9.50 | 10.00 |
| | Li₂O/Na₂O | 0.19 | 0.19 | 0.19 | 0.18 |
| | Li₂O/(Li₂O + Na₂O + K₂O) | 0.158 | 0.158 | 0.158 | 0.150 |
| | K₂O/(Li₂O + Na₂O + K₂O) | 0.000 | 0.000 | 0.000 | 0.000 |
| | MgO + CaO + SrO | 15.50 | 15.50 | 15.50 | 17.00 |
| | MgO + CaO | 15.50 | 14.50 | 13.50 | 15.00 |
| | Li₂O + Na₂O + K₂O + MgO + | 25.00 | 25.00 | 25.00 | 27.00 |
| | CaO + SrO | | | | |
| | (MgO + CaO + Li₂O)/(Li₂O + | 0.680 | 0.640 | 0.600 | 0.611 |
| | Na₂O + K₂O + MgO + CaO + SrO) | | | | |
| | ZrO₂ + TiO₂ + Y₂O₃ + La₂O₃ + | 4.00 | 4.00 | 4.00 | 4.00 |
| | Gd₂O₃ + Nb₂O₅ + Ta₂O₅ | | | | |
| | (SiO₂ + ZrO₂ + TiO₂ + Y₂O₃ + | 7.89 | 7.89 | 7.89 | 7.30 |
| | La₂O₃ + Gd₂O₃ + Nb₂O₅ + | | | | |
| | Ta₂O₅)/(Li₂O + Na₂O + K₂O) | | | | |
| | (ZrO₂ + TiO₂ + Y₂O₃ + La₂O₃ + | 0.667 | 0.667 | 0.667 | 0.800 |
| | Gd₂O₃ + Nb₂O₅ + Ta₂O₅)/Al₂O₃ | | | | |
| | (MgO + CaO)/(MgO + CaO + SrO) | 1.000 | 0.935 | 0.871 | 0.882 |
| Character- | Glass transition | 656 | 645 | ≧620 | 620 |
| istics | temperature Tg (° C.) | | | | |
| | Average linear expansion | 75 | 74 | >70 | 79 |
| | coefficient (×10⁻⁷/° C.) | | | | |
| | (100 to 300° C.) | | | | |
| | Young's modulus (GPa) | 86.4 | 87.0 | 86.7 | 87.5 |
| | Specific elastic modulus | 32.4 | 32.4 | 32.1 | 32.3 |
| | (MNm/kg) | | | | |
| | Specific gravity | 2.66 | 2.68 | 2.70 | 2.71 |

TABLE 19

| | | No. 44 | No. 45 | No. 46 | No. 47 |
|---|---|---|---|---|---|
| | | mol % | mol % | mol % | mol % |
| Composi- | SiO₂ | 64.00 | 64.00 | 63.00 | 65.00 |
| tion | B₂O₃ | 0.00 | 0.00 | 0.00 | 0.00 |
| | Al₂O₃ | 5.00 | 5.00 | 6.00 | 6.00 |
| | Li₂O | 1.50 | 1.50 | 1.00 | 2.00 |
| | Na₂O | 8.50 | 8.50 | 8.00 | 6.50 |
| | K₂O | 0.00 | 0.00 | 1.00 | 1.00 |
| | MgO | 4.00 | 4.00 | 4.00 | 1.50 |
| | CaO | 13.00 | 13.00 | 13.00 | 14.00 |
| | SrO | 0.00 | 0.00 | 0.00 | 0.00 |
| | BaO | 0.00 | 0.00 | 0.00 | 0.00 |
| | ZnO | 0.00 | 2.00 | 0.00 | 0.00 |
| | ZrO₂ | 2.00 | 2.00 | 4.00 | 4.00 |
| | TiO₂ | 2.00 | 0.00 | 0.00 | 0.00 |
| | Y₂O₃ | 0.00 | 0.00 | 0.00 | 0.00 |
| | Yb₂O₃ | 0.00 | 0.00 | 0.00 | 0.00 |
| | La₂O₃ | 0.00 | 0.00 | 0.00 | 0.00 |
| | Gd₂O₃ | 0.00 | 0.00 | 0.00 | 0.00 |
| | Nb₂O₅ | 0.00 | 0.00 | 0.00 | 0.00 |
| | Ta₂O₅ | 0.00 | 0.00 | 0.00 | 0.00 |
| | Total | 100.00 | 100.00 | 100.00 | 100.00 |
| | Li₂O + Na₂O + K₂O | 10.00 | 10.00 | 10.00 | 9.50 |
| | Li₂O/Na₂O | 0.18 | 0.18 | 0.13 | 0.31 |
| | Li₂O/(Li₂O + Na₂O + K₂O) | 0.150 | 0.150 | 0.100 | 0.211 |
| | K₂O/(Li₂O + Na₂O + K₂O) | 0.000 | 0.000 | 0.100 | 0.105 |
| | MgO + CaO + SrO | 17.00 | 17.00 | 17.00 | 15.50 |
| | MgO + CaO | 17.00 | 17.00 | 17.00 | 15.50 |
| | Li₂O + Na₂O + K₂O + MgO + | 27.00 | 27.00 | 27.00 | 25.00 |
| | CaO + SrO | | | | |
| | (MgO + CaO + Li₂O)/(Li₂O + | 0.685 | 0.685 | 0.667 | 0.700 |
| | Na₂O + K₂O + MgO + CaO + SrO) | | | | |
| | ZrO₂ + TiO₂ + Y₂O₃ + La₂O₃ + | 4.00 | 2.00 | 4.00 | 4.00 |
| | Gd₂O₃ + Nb₂O₅ + Ta₂O₅ | | | | |
| | (SiO₂ + ZrO₂ + TiO₂ + Y₂O₃ + | 7.30 | 7.10 | 7.30 | 7.89 |
| | La₂O₃ + Gd₂O₃ + Nb₂O₅ + | | | | |
| | Ta₂O₅)/(Li₂O + Na₂O + K₂O) | | | | |
| | (ZrO₂ + TiO₂ + Y₂O₃ + La₂O₃ + | 0.800 | 0.400 | 0.667 | 0.667 |
| | Gd₂O₃ + Nb₂O₅ + Ta₂O₅)/Al₂O₃ | | | | |
| | (MgO + CaO)/(MgO + CaO + SrO) | 1.000 | 1.000 | 1.000 | 1.000 |
| Character- | Glass transition | 620 | 605 | 650 | 640 |
| istics | temperature Tg (° C.) | | | | |
| | Average linear expansion | 80 | 75 | 81 | 77 |
| | coefficient (×10⁻⁷/° C.) | | | | |
| | (100 to 300° C.) | | | | |
| | Young's modulus (GPa) | 86.3 | 85.6 | 87.5 | 87.5 |
| | Specific elastic modulus | 32.8 | 32.3 | 32.8 | 33.0 |
| | (MNm/kg) | | | | |
| | Specific gravity | 2.63 | 2.65 | 2.66 | 2.65 |

TABLE 20

| | | No. 48 | No. 49 | No. 50 | No. 51 |
|---|---|---|---|---|---|
| | | mol % | mol % | mol % | mol % |
| Composi- | SiO₂ | 67.00 | 65.00 | 65.00 | 64.00 |
| tion | B₂O₃ | 0.00 | 0.00 | 0.00 | 0.00 |
| | Al₂O₃ | 2.00 | 3.00 | 2.00 | 5.00 |
| | Li₂O | 0.50 | 1.00 | 1.00 | 3.00 |
| | Na₂O | 9.50 | 9.00 | 9.00 | 7.00 |
| | K₂O | 0.00 | 1.00 | 1.00 | 0.00 |
| | MgO | 4.00 | 1.00 | 1.00 | 0.00 |
| | CaO | 13.00 | 15.00 | 15.00 | 17.00 |
| | SrO | 0.00 | 0.00 | 0.00 | 0.00 |
| | BaO | 0.00 | 0.00 | 0.00 | 0.00 |
| | ZnO | 0.00 | 0.00 | 0.00 | 0.00 |
| | ZrO₂ | 4.00 | 5.00 | 6.00 | 4.00 |
| | TiO₂ | 0.00 | 0.00 | 0.00 | 0.00 |
| | Y₂O₃ | 0.00 | 0.00 | 0.00 | 0.00 |
| | Yb₂O₃ | 0.00 | 0.00 | 0.00 | 0.00 |
| | La₂O₃ | 0.00 | 0.00 | 0.00 | 0.00 |
| | Gd₂O₃ | 0.00 | 0.00 | 0.00 | 0.00 |
| | Nb₂O₅ | 0.00 | 0.00 | 0.00 | 0.00 |
| | Ta₂O₅ | 0.00 | 0.00 | 0.00 | 0.00 |
| | Total | 100.00 | 100.00 | 100.00 | 100.00 |
| | Li₂O + Na₂O + K₂O | 10.00 | 11.00 | 11.00 | 10.00 |
| | Li₂O/Na₂O | 0.05 | 0.11 | 0.11 | 0.43 |
| | Li₂O/(Li₂O + Na₂O + K₂O) | 0.050 | 0.091 | 0.091 | 0.300 |
| | K₂O/(Li₂O + Na₂O + K₂O) | 0.000 | 0.091 | 0.091 | 0.000 |
| | MgO + CaO + SrO | 17.00 | 16.00 | 16.00 | 17.00 |
| | MgO + CaO | 17.00 | 16.00 | 16.00 | 17.00 |
| | Li₂O + Na₂O + K₂O + MgO + | 27.00 | 27.00 | 27.00 | 27.00 |
| | CaO + SrO | | | | |
| | (MgO + CaO + Li₂O)/(Li₂O + | 0.648 | 0.630 | 0.630 | 0.741 |
| | Na₂O + K₂O + MgO + CaO + SrO) | | | | |
| | ZrO₂ + TiO₂ + Y₂O₃ + La₂O₃ + | 4.00 | 5.00 | 6.00 | 4.00 |
| | Gd₂O₃ + Nb₂O₅ + Ta₂O₅ | | | | |
| | (SiO₂ + ZrO₂ + TiO₂ + Y₂O₃ + | 7.30 | 6.64 | 6.64 | 7.30 |
| | La₂O₃ + Gd₂O₃ + Nb₂O₅ + | | | | |
| | Ta₂O₅)/(Li₂O + Na₂O + K₂O) | | | | |
| | (ZrO₂ + TiO₂ + Y₂O₃ + La₂O₃ + | 2.000 | 1.667 | 3.000 | 0.800 |
| | Gd₂O₃ + Nb₂O₅ + Ta₂O₅)/Al₂O₃ | | | | |
| | (MgO + CaO)/(MgO + CaO + SrO) | 1.000 | 1.000 | 1.000 | 1.000 |
| Character- | Glass transition | 630 | 636 | 640 | 622 |
| istics | temperature Tg (° C.) | | | | |
| | Average linear expansion | 79 | 83 | 83 | 80 |
| | coefficient (×10⁻⁷/° C.) | | | | |
| | (100 to 300° C.) | | | | |
| | Young's modulus (GPa) | 85.0 | 86.6 | 87.8 | 89.0 |
| | Specific elastic modulus | 32.0 | 32.1 | 32.2 | 33.2 |
| | (MNm/kg) | | | | |
| | Specific gravity | 2.66 | 2.70 | 2.73 | 2.68 |

TABLE 21

| | | No. 52 | No. 53 | No. 54 | No. 55 |
|---|---|---|---|---|---|
| | | mol % | mol % | mol % | mol % |
| Composi- | SiO₂ | 64.00 | 63.00 | 64.00 | 64.00 |
| tion | B₂O₃ | 0.00 | 0.00 | 0.00 | 0.00 |
| | Al₂O₃ | 5.00 | 4.00 | 5.00 | 5.00 |
| | Li₂O | 1.50 | 1.00 | 1.50 | 1.50 |
| | Na₂O | 8.50 | 8.00 | 8.50 | 8.50 |
| | K₂O | 0.00 | 0.00 | 0.00 | 0.00 |
| | MgO | 0.00 | 2.00 | 4.00 | 4.00 |
| | CaO | 17.00 | 18.00 | 13.00 | 13.00 |
| | SrO | 0.00 | 0.00 | 0.00 | 0.00 |
| | BaO | 0.00 | 0.00 | 0.00 | 0.00 |
| | ZnO | 0.00 | 0.00 | 0.00 | 0.00 |
| | ZrO₂ | 4.00 | 4.00 | 2.00 | 2.00 |
| | TiO₂ | 0.00 | 0.00 | 0.00 | 0.00 |
| | Y₂O₃ | 0.00 | 0.00 | 0.00 | 2.00 |
| | Yb₂O₃ | 0.00 | 0.00 | 0.00 | 0.00 |
| | La₂O₃ | 0.00 | 0.00 | 0.00 | 0.00 |
| | Gd₂O₃ | 0.00 | 0.00 | 0.00 | 0.00 |
| | Nb₂O₅ | 0.00 | 0.00 | 2.00 | 0.00 |
| | Ta₂O₅ | 0.00 | 0.00 | 0.00 | 0.00 |
| | Total | 100.00 | 100.00 | 100.00 | 100.00 |
| | Li₂O + Na₂O + K₂O | 10.00 | 9.00 | 10.00 | 10.00 |
| | Li₂O/Na₂O | 0.18 | 0.13 | 0.18 | 0.18 |
| | Li₂O/(Li₂O + Na₂O + K₂O) | 0.150 | 0.111 | 0.150 | 0.150 |
| | K₂O/(Li₂O + Na₂O + K₂O) | 0.000 | 0.000 | 0.000 | 0.000 |
| | MgO + CaO + SrO | 17.00 | 20.00 | 17.00 | 17.00 |
| | MgO + CaO | 17.00 | 20.00 | 17.00 | 17.00 |
| | Li₂O + Na₂O + K₂O + MgO + | 27.00 | 29.00 | 27.00 | 27.00 |
| | CaO + SrO | | | | |
| | (MgO + CaO + Li₂O)/(Li₂O + | 0.685 | 0.724 | 0.685 | 0.685 |
| | Na₂O + K₂O + MgO + CaO + SrO) | | | | |
| | ZrO₂ + TiO₂ + Y₂O₃ + La₂O₃ + | 4.00 | 4.00 | 4.00 | 4.00 |
| | Gd₂O₃ + Nb₂O₅ + Ta₂O₅ | | | | |
| | (SiO₂ + ZrO₂ + TiO₂ + Y₂O₃ + | 7.30 | 7.89 | 7.30 | 7.30 |
| | La₂O₃ + Gd₂O₃ + Nb₂O₅ + | | | | |
| | Ta₂O₅)/(Li₂O + Na₂O + K₂O) | | | | |
| | (ZrO₂ + TiO₂ + Y₂O₃ + La₂O₃ + | 0.800 | 1.000 | 0.800 | 0.800 |
| | Gd₂O₃ + Nb₂O₅ + Ta₂O₅)/Al₂O₃ | | | | |
| | (MgO + CaO)/(MgO + CaO + SrO) | 1.000 | 1.000 | 1.000 | 1.000 |
| Character- | Glass transition | 645 | 646 | 632 | 639 |
| istics | temperature Tg (° C.) | | | | |
| | Average linear expansion | 85 | 77 | 78 | 76 |
| | coefficient (×10⁻⁷/° C.) | | | | |
| | (100 to 300° C.) | | | | |
| | Young's modulus (GPa) | 87.3 | 88.5 | 87.4 | 88.9 |
| | Specific elastic modulus | 32.5 | 32.7 | 32.2 | 32.6 |
| | (MNm/kg) | | | | |
| | Specific gravity | 2.68 | 2.71 | 2.71 | 2.73 |

TABLE 22

| | | No. 56 | No. 57 | No. 58 | No. 59 |
|---|---|---|---|---|---|
| | | mol % | mol % | mol % | mol % |
| Composi- | SiO₂ | 64.00 | 64.00 | 64.00 | 64.00 |
| tion | B₂O₃ | 0.00 | 0.00 | 0.00 | 0.00 |
| | Al₂O₃ | 5.00 | 5.00 | 5.00 | 5.00 |
| | Li₂O | 1.50 | 1.50 | 1.50 | 1.50 |
| | Na₂O | 8.50 | 8.50 | 8.50 | 8.50 |
| | K₂O | 0.00 | 0.00 | 0.00 | 0.00 |
| | MgO | 4.00 | 4.00 | 4.00 | 4.00 |
| | CaO | 13.00 | 13.00 | 13.00 | 13.00 |
| | SrO | 0.00 | 0.00 | 0.00 | 0.00 |
| | BaO | 0.00 | 0.00 | 0.00 | 0.00 |
| | ZnO | 0.00 | 0.00 | 0.00 | 0.00 |
| | ZrO₂ | 2.00 | 2.00 | 2.00 | 2.00 |
| | TiO₂ | 0.00 | 0.00 | 0.00 | 0.00 |
| | Y₂O₃ | 0.00 | 0.00 | 0.00 | 0.00 |
| | Yb₂O₃ | 0.00 | 0.00 | 2.00 | 0.00 |
| | La₂O₃ | 2.00 | 0.00 | 0.00 | 0.00 |
| | Gd₂O₃ | 0.00 | 2.00 | 0.00 | 0.00 |
| | Nb₂O₅ | 0.00 | 0.00 | 0.00 | 0.00 |
| | Ta₂O₅ | 0.00 | 0.00 | 0.00 | 2.00 |
| | Total | 100.00 | 100.00 | 100.00 | 100.00 |
| | Li₂O + Na₂O + K₂O | 10.00 | 10.00 | 10.00 | 10.00 |
| | Li₂O/Na₂O | 0.18 | 0.18 | 0.18 | 0.18 |
| | Li₂O/(Li₂O + Na₂O + K₂O) | 0.150 | 0.150 | 0.150 | 0.150 |
| | K₂O/(Li₂O + Na₂O + K₂O) | 0.000 | 0.000 | 0.000 | 0.000 |
| | MgO + CaO + SrO | 17.00 | 17.00 | 17.00 | 17.00 |
| | MgO + CaO | 17.00 | 17.00 | 17.00 | 17.00 |
| | Li₂O + Na₂O + K₂O + MgO + | 27.00 | 27.00 | 27.00 | 27.00 |
| | CaO + SrO | | | | |
| | (MgO + CaO + Li₂O)/(Li₂O + | 0.685 | 0.685 | 0.685 | 0.685 |
| | Na₂O + K₂O + MgO + CaO + SrO) | | | | |
| | ZrO₂ + TiO₂ + Y₂O₃ + La₂O₃ + | 4.00 | 4.00 | 4.00 | 4.00 |
| | Gd₂O₃ + Nb₂O₅ + Ta₂O₅ | | | | |
| | (SiO₂ + ZrO₂ + TiO₂ + Y₂O₃ + | 7.30 | 7.30 | 7.30 | 7.30 |
| | La₂O₃ + Gd₂O₃ + Nb₂O₅ + | | | | |
| | Ta₂O₅)/(Li₂O + Na₂O + K₂O) | | | | |
| | (ZrO₂ + TiO₂ + Y₂O₃ + La₂O₃ + | 0.800 | 0.800 | 0.800 | 0.800 |
| | Gd₂O₃ + Nb₂O₅ + Ta₂O₅)/Al₂O₃ | | | | |
| | (MgO + CaO)/(MgO + CaO + SrO) | 1.000 | 1.000 | 1.000 | 1.000 |
| Character- | Glass transition | 623 | 625 | 641 | 642 |
| istics | temperature Tg (° C.) | | | | |
| | Average linear expansion | 80 | 81 | 77 | 74 |
| | coefficient (×10⁻⁷/° C.) | | | | |
| | (100 to 300° C.) | | | | |
| | Young's modulus (GPa) | 87.7 | 88.4 | 89.0 | 89.2 |
| | Specific elastic modulus | 31.3 | 31.1 | 31.0 | 31.2 |
| | (MNm/kg) | | | | |
| | Specific gravity | 2.80 | 2.84 | 2.87 | 2.86 |

TABLE 23

| | | No. 60 | No. 61 | No. 62 | No. 63 |
|---|---|---|---|---|---|
| | | mol % | mol % | mol % | mol % |
| Composi- | SiO₂ | 62.00 | 64.00 | 64.00 | 64.00 |
| tion | B₂O₃ | 0.00 | 0.00 | 0.00 | 0.00 |
| | Al₂O₃ | 5.00 | 5.00 | 5.00 | 5.00 |
| | Li₂O | 0.50 | 0.50 | 2.50 | 1.00 |
| | Na₂O | 12.50 | 11.00 | 8.00 | 12.50 |
| | K₂O | 2.00 | 1.50 | 0.00 | 0.00 |
| | MgO | 0.00 | 1.50 | 2.00 | 1.50 |
| | CaO | 14.00 | 12.00 | 14.50 | 12.00 |
| | SrO | 0.00 | 0.00 | 0.00 | 0.00 |
| | BaO | 0.00 | 0.00 | 0.00 | 0.00 |
| | ZnO | 0.00 | 0.00 | 0.00 | 0.00 |
| | ZrO₂ | 4.00 | 4.50 | 4.00 | 4.00 |
| | TiO₂ | 0.00 | 0.00 | 0.00 | 0.00 |
| | Y₂O₃ | 0.00 | 0.00 | 0.00 | 0.00 |
| | Yb₂O₃ | 0.00 | 0.00 | 0.00 | 0.00 |
| | La₂O₃ | 0.00 | 0.00 | 0.00 | 0.00 |
| | Gd₂O₃ | 0.00 | 0.00 | 0.00 | 0.00 |
| | Nb₂O₅ | 0.00 | 0.00 | 0.00 | 0.00 |
| | Ta₂O₅ | 0.00 | 0.00 | 0.00 | 0.00 |
| | Total | 100.00 | 100.00 | 100.00 | 100.00 |
| | Li₂O + Na₂O + K₂O | 15.00 | 13.00 | 10.50 | 13.50 |
| | Li₂O/Na₂O | 0.04 | 0.05 | 0.31 | 0.08 |
| | Li₂O/(Li₂O + Na₂O + K₂O) | 0.033 | 0.038 | 0.238 | 0.074 |
| | K₂O/(Li₂O + Na₂O + K₂O) | 0.133 | 0.115 | 0.000 | 0.000 |
| | MgO + CaO + SrO | 14.00 | 13.50 | 16.50 | 13.50 |
| | MgO + CaO | 14.00 | 13.50 | 16.50 | 13.50 |
| | Li₂O + Na₂O + K₂O + MgO + | 29.00 | 26.50 | 27.00 | 27.00 |
| | CaO + SrO | | | | |
| | (MgO + CaO + Li₂O)/(Li₂O + | 0.500 | 0.528 | 0.704 | 0.537 |
| | Na₂O + K₂O + MgO + CaO + SrO) | | | | |
| | ZrO₂ + TiO₂ + Y₂O₃ + La₂O₃ + | 4.00 | 4.50 | 4.00 | 4.00 |
| | Gd₂O₃ + Nb₂O₅ + Ta₂O₅ | | | | |
| | (SiO₂ + ZrO₂ + TiO₂ + Y₂O₃ + | 4.73 | 5.65 | 6.95 | 5.41 |
| | La₂O₃ + Gd₂O₃ + Nb₂O₅ + | | | | |
| | Ta₂O₅)/(Li₂O + Na₂O + K₂O) | | | | |
| | (ZrO₂ + TiO₂ + Y₂O₃ + La₂O₃ + | 0.800 | 0.900 | 0.800 | 0.800 |
| | Gd₂O₃ + Nb₂O₅ + Ta₂O₅)/Al₂O₃ | | | | |
| | (MgO + CaO)/(MgO + CaO + SrO) | 1.000 | 1.000 | 1.000 | 1.000 |
| Character- | Glass transition | 616 | 623 | 617 | >600 |
| istics | temperature Tg (° C.) | | | | |
| | Average linear expansion | 98 | 89 | 79 | >75 |
| | coefficient (×10⁻⁷/° C.) | | | | |
| | (100 to 300° C.) | | | | |
| | Young's modulus (GPa) | 83.1 | 84.0 | 88.4 | 84.4 |
| | Specific elastic modulus | 31.1 | 31.5 | 33.1 | 31.8 |
| | (MNm/kg) | | | | |
| | Specific gravity | 2.67 | 2.66 | 2.67 | 2.65 |

1. A method of manufacturing a glass blank for a magnetic recording medium glass substrate, comprising:
manufacturing a glass blank for a magnetic recording medium glass substrate by at least press molding a falling molten glass gob with a first press mold and a second press mold arranged so as to face each other in a direction perpendicular to a direction in which the molten glass gob falls,
wherein:
the molten glass gob is formed of a glass material having a glass transition temperature of 600° C. or more; and
when the press molding is carried out so that the molten glass gob is completely extended by pressure and molded into a flat glass between a press-molding surface of the first press mold and a press-molding surface of the second press mold,
at least a region in contact with the flat glass in each of the press-molding surface of the first press mold and the press-molding surface of the second press mold forms a substantially flat surface.

2. A method of manufacturing a glass blank for a magnetic recording medium glass substrate according to claim 1, wherein the glass blank for a magnetic recording medium glass substrate has an average linear expansion coefficient at 100 to 300° C. of 70×10⁻⁷/° C. or more and a Young's modulus of 70 GPa or more.

3. A method of manufacturing a glass blank for a magnetic recording medium glass substrate according to claim 1, wherein:
the glass material comprises, as a glass composition expressed in mol %, 50 to 75% of SiO₂, 0 to 5% of Al₂O₃, 0 to 3% of Li₂O, 0 to 5% of ZnO, 3 to 15% in total of at least one kind of component selected from Na₂O and K₂O, 14 to 35% in total of at least one kind of component selected from MgO, CaO, SrO, and BaO, and 2 to 9% in total of at least one kind of component selected from ZrO₂, TiO₂, La₂O₃, Y₂O₃, Yb₂O₃, Ta₂O₅, Nb₂O₅, and HfO₂; and
a molar ratio {(MgO+CaO)/(MgO+CaO+SrO+BaO)} is in a range of 0.8 to 1 and a molar ratio {Al₂O₃/(MgO+CaO)} is in a range of 0 to 0.30.

4. A method of manufacturing a glass blank for a magnetic recording medium glass substrate according to claim 2, wherein:
the glass material comprises, as a glass composition expressed in mol %, 50 to 75% of SiO₂, 0 to 5% of Al₂O₃, 0 to 3% of Li₂O, 0 to 5% of ZnO, 3 to 15% in total of at least one kind of component selected from Na₂O and K₂O, 14 to 35% in total of at least one kind of component selected from MgO, CaO, SrO, and BaO, and 2 to 9% in total of at least one kind of component selected from ZrO₂, TiO₂, La₂O₃, Y₂O₃, Yb₂O₃, Ta₂O₅, Nb₂O₅, and HfO₂; and
a molar ratio {(MgO+CaO)/(MgO+CaO+SrO+BaO)} is in a range of 0.8 to 1 and a molar ratio {Al₂O₃/(MgO+CaO)} is in a range of 0 to 0.30.

5. A method of manufacturing a glass blank for a magnetic recording medium glass substrate according to claim 1, wherein:
the glass material comprises, as a glass composition expressed in mol %, 56 to 75% of SiO₂, 1 to 11% of Al₂O₃, more than 0% and 4% or less of Li₂O, 1% or more and less than 15% of Na₂O, and 0% or more and less than 3% of K₂O, and is substantially free of BaO;
a total content of alkali metal oxides selected from the group consisting of Li₂O, Na₂O, and K₂O is in a range of 6 to 15%;
a molar ratio of a content of Li₂O to a content of Na₂O (Li₂O/Na₂O) is less than 0.50;
a molar ratio of a content of K₂O to the total content of the alkali metal oxides {K₂O/(Li₂O+Na₂O+K₂O)} is 0.13 or less;
a total content of alkaline-earth metal oxides selected from the group consisting of MgO, CaO, and SrO is in a range of 10 to 30%;
a total content of MgO and CaO is in a range of 10 to 30%;
a molar ratio of the total content of MgO and CaO to the total content of the alkaline-earth metal oxides {(MgO+CaO)/(MgO+CaO+SrO)} is 0.86 or more;
a total content of the alkali metal oxides and the alkaline-earth metal oxides is in a range of 20 to 40%;
a molar ratio of a total content of MgO, CaO, and Li₂O to the total content of the alkali metal oxides and the alkaline-earth metal oxides {(MgO+CaO+Li₂O)/(Li₂O+Na₂O+K₂O+MgO+CaO+SrO)} is 0.50 or more;
a total content of oxides selected from the group consisting of ZrO₂, TiO₂, Y₂O₃, La₂O₃, Gd₂O₃, Nb₂O₅, and Ta₂O₅ is more than 0% and 10% or less; and
a molar ratio of the total content of the oxides to a content of Al₂O₃ {(ZrO₂+TiO₂+Y₂O₃+La₂O₃+Gd₂O₃+Nb₂O₅+Ta₂O₅)/Al₂O₃} is 0.40 or more.

6. A method of manufacturing a glass blank for a magnetic recording medium glass substrate according to claim 2, wherein:
the glass material comprises, as a glass composition expressed in mol %, 56 to 75% of SiO₂, 1 to 11% of Al₂O₃, more than 0% and 4% or less of Li₂O, 1% or more and less than 15% of Na₂O, and 0% or more and less than 3% of K₂O, and is substantially free of BaO;
a total content of alkali metal oxides selected from the group consisting of Li₂O, Na₂O, and K₂O is in a range of 6 to 15%;
a molar ratio of a content of Li₂O to a content of Na₂O (Li₂O/Na₂O) is less than 0.50;
a molar ratio of a content of K₂O to the total content of the alkali metal oxides {K₂O/(Li₂O+Na₂O+K₂O)} is 0.13 or less;
a total content of alkaline-earth metal oxides selected from the group consisting of MgO, CaO, and SrO is in a range of 10 to 30%;
a total content of MgO and CaO is in a range of 10 to 30%;
a molar ratio of the total content of MgO and CaO to the total content of the alkaline-earth metal oxides {(MgO+CaO)/(MgO+CaO+SrO)} is 0.86 or more;
a total content of the alkali metal oxides and the alkaline-earth metal oxides is in a range of 20 to 40%;
a molar ratio of a total content of MgO, CaO, and Li₂O to the total content of the alkali metal oxides and the alkaline-earth metal oxides {(MgO+CaO+Li₂O)/(Li₂O+Na₂O+K₂O+MgO+CaO+SrO)} is 0.50 or more;
a total content of oxides selected from the group consisting of ZrO₂, TiO₂, Y₂O₃, La₂O₃, Gd₂O₃, Nb₂O₅, and Ta₂O₅ is more than 0% and 10% or less; and
a molar ratio of the total content of the oxides to a content of Al₂O₃ {(ZrO₂+TiO₂+Y₂O₃+La₂O₃+Gd₂O₃+Nb₂O₅+Ta₂O₅)/Al₂O₃} is 0.40 or more.

7. A method of manufacturing a glass blank for a magnetic recording medium glass substrate according to claim 1, the method further comprising:
manufacturing molten glass by heating and melting a glass material prepared so as to have a predetermined glass composition; and
forming the molten glass gob by causing the molten glass to fall from a glass outlet and cutting a forward end portion of a molten glass flow continuously flowing out downward in a vertical direction,
wherein a viscosity of the molten glass flow is kept at a constant value in a range of 500 to 1,050 dPa·s.

8. A method of manufacturing a glass blank for a magnetic recording medium glass substrate according to claim 2, the method further comprising:
manufacturing molten glass by heating and melting a glass material prepared so as to have a predetermined glass composition; and
forming the molten glass gob by causing the molten glass to fall from a glass outlet and cutting a forward end portion of a molten glass flow continuously flowing out downward in a vertical direction,
wherein a viscosity of the molten glass flow is kept at a constant value in a range of 500 to 1,050 dPa·s.

9. A method of manufacturing a glass blank for a magnetic recording medium glass substrate according to claim 3, the method further comprising:
manufacturing molten glass by heating and melting a glass material prepared so as to have a predetermined glass composition; and
forming the molten glass gob by causing the molten glass to fall from a glass outlet and cutting a forward end portion of a molten glass flow continuously flowing out downward in a vertical direction,
wherein a viscosity of the molten glass flow is kept at a constant value in a range of 500 to 1,050 dPa·s.

10. A method of manufacturing a glass blank for a magnetic recording medium glass substrate according to claim 4, the method further comprising:
manufacturing molten glass by heating and melting a glass material prepared so as to have a predetermined glass composition; and
forming the molten glass gob by causing the molten glass to fall from a glass outlet and cutting a forward end portion of a molten glass flow continuously flowing out downward in a vertical direction,
wherein a viscosity of the molten glass flow is kept at a constant value in a range of 500 to 1,050 dPa·s.

11. A method of manufacturing a glass blank for a magnetic recording medium glass substrate according to claim 5, the method further comprising:
manufacturing molten glass by heating and melting a glass material prepared so as to have a predetermined glass composition; and
forming the molten glass gob by causing the molten glass to fall from a glass outlet and cutting a forward end portion of a molten glass flow continuously flowing out downward in a vertical direction,
wherein a viscosity of the molten glass flow is kept at a constant value in a range of 500 to 1,050 dPa·s.

12. A method of manufacturing a glass blank for a magnetic recording medium glass substrate according to claim 6, the method further comprising:
manufacturing molten glass by heating and melting a glass material prepared so as to have a predetermined glass composition; and
forming the molten glass gob by causing the molten glass to fall from a glass outlet and cutting a forward end portion of a molten glass flow continuously flowing out downward in a vertical direction,
wherein a viscosity of the molten glass flow is kept at a constant value in a range of 500 to 1,050 dPa·s.

13. A method of manufacturing a magnetic recording medium glass substrate, comprising:
manufacturing a glass blank for a magnetic recording medium glass substrate by at least press molding a falling molten glass gob with a first press mold and a second press mold both so as to face each other in a direction perpendicular to a direction in which the molten glass gob falls; and
manufacturing a magnetic recording medium glass substrate by at least polishing main surfaces of the glass blank for a magnetic recording medium glass substrate,
wherein:
the molten glass gob is formed of a glass material having a glass transition temperature of 600° C. or more; and
when the press molding is carried out so that the molten glass gob is completely extended by pressure and molded into a flat glass between a press-molding surface of the first press mold and a press-molding surface of the second press mold,
at least a region in contact with the flat glass in each of the press-molding surface of the first press mold and the press-molding surface of the second press mold forms a substantially flat surface.

14. A method of manufacturing a magnetic recording medium, comprising:
manufacturing a glass blank for a magnetic recording medium glass substrate by at least press molding a falling molten glass gob with a first press mold and a second press mold both so as to face each other in a direction perpendicular to a direction in which the molten glass gob falls;
manufacturing a magnetic recording medium glass substrate by at least polishing main surfaces of the glass blank for a magnetic recording medium glass substrate; and
manufacturing a magnetic recording medium by at least forming a magnetic recording layer on the magnetic recording medium glass substrate,
wherein:
the molten glass gob is formed of a glass material having a glass transition temperature of 600° C. or more; and
when the press molding is carried out so that the molten glass gob is completely extended by pressure and molded into a flat glass between a press-molding surface of the first press mold and a press-molding surface of the second press mold,
at least a region in contact with the flat glass in each of the press-molding surface of the first press mold and the press-molding surface of the second press mold forms a substantially flat surface.
